(19) United States
(12) Patent Application Publication
(10) Pub. No.: US 2025/0269307 A1
(43) Pub. Date: Aug. 28, 2025

(54) VOLUMETRIC MEDIA AND USES THEREOF

(71) Applicant: Donaldson Company, Inc., Bloomington, MN (US)

(72) Inventors: Shane Lawson, Waconia, MN (US); Christopher P. Conklin, Columbia, MD (US); Benjamin C. Druecke, Hudson, WI (US); Alexander E. Mottet, Minneapolis, MN (US); Kristof Decoster, Vilvoorde (BE); Yehya A. Elsayed, Bloomington, MN (US); Abhishek Maharia, Badnoli, Hapur (IN); Rohit Singh, Gurugram, Haryana (IN); Elena T. Ewaldz, Minneapolis, MN (US); Laurent Coustenoble, Bailleulval (FR)

(21) Appl. No.: 19/058,706

(22) Filed: Feb. 20, 2025

Related U.S. Application Data
(60) Provisional application No. 63/556,666, filed on Feb. 22, 2024.

(51) Int. Cl. B01D 35/00

(52) U.S. Cl. CPC B01D 35/00; B01D 2201/31; B01D 2253/00

(57) ABSTRACT

A volumetric media having an upstream end and a downstream end. The volumetric media includes one or more spacers and a packing material around the spacers. The packing material includes a foam. The packing material may include fine fibers disposed on at least a portion of the foam.

### CROSS-REFERENCE TO RELATED APPLICATION

This application claims the benefit of U.S. Provisional Application 63/556,666 filed on Feb. 22, 2024, the subject matter of which is incorporated by reference in its entirety.

### FIELD

The present disclosure relates to packed bed filters. The packed bed filters may be used, for example, in fuel cell systems. The present disclosure further relates to methods of making the packed bed filters.

### SUMMARY

The present disclosure describes a volumetric media having an upstream end and a downstream end. The volumetric media includes a spacer and a packing material around the spacer. In some embodiments, the packing material includes a reticulated foam. In some embodiments, the packing material includes a foam and fine fibers disposed on at least a portion of the foam. In some embodiments, the packing material includes active particles.

The present disclosure describes a filter. The present disclosure describes a reactor. The filter and the reactor each independently have an upstream end and a downstream end as well as a housing. The volumetric media is disposed within the housing.

The present disclosure further describes methods of using the volumetric media and filters/reactors containing the same. The methods include flowing a fluid from the upstream end to the downstream end of the volumetric media.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF FIGURES

FIG. 1A and FIG. 1B are diagrammatic cross-sectional side views of volumetric media disposed within a housing in accordance with certain embodiments.

FIG. 2 is a schematic side view diagram illustrating a spacer in accordance with certain embodiments.

FIG. 3 is a schematic top view diagram illustrating the spacer of FIG. 2.

FIG. 4 is a side view of a spacer in accordance with certain embodiments.

FIG. 5 is a top view of the spacer of FIG. 4.

FIG. 6 is a schematic side view diagram illustrating another spacer in accordance with certain embodiments.

FIG. 7 is a schematic top view diagram illustrating the spacer of FIG. 6.

FIG. 8 is a perspective view of a spacer grid, in accordance with certain embodiments.

FIG. 9 is a perspective view of a spacer array, in accordance with certain embodiments.

FIG. 10 is a side view of the spacer array of FIG. 9.

FIG. 11 is a cross-sectional view of the spacer array of FIG. 10.

FIG. 12 is a top view of the spacer array of FIG. 9.

FIG. 13 is an example method of making a spacer array in accordance with certain embodiments.

FIG. 14 is an example method of flowing fluid through a spacer array in accordance with certain embodiments.

FIG. 15A is a simulated diagrammatic perspective view of fluid flow through a spacer array in accordance with certain embodiments.

FIG. 15B is a simulated diagrammatic side view of the fluid flow through the spacer array of FIG. 15A.

FIG. 16A is a simulated graph comparison of various cross-sectional spacer shapes vs. restrictions.

FIG. 16B is a simulated graph comparison of the various cross-sectional spacer shapes vs. initial toluene removal.

FIG. 17A is a simulated flow profile of a spacer array, in accordance with certain embodiments.

FIG. 17B is a simulated flow profile of a spacer array, in accordance with certain embodiments.

FIG. 17C is a simulated flow profile of a spacer array, in accordance with certain embodiments.

FIG. 18 is a simulated contaminant profile of a spacer array, in accordance with certain embodiments.

FIG. 19 is a simulated graph comparison of pressure drop and adsorption efficiency vs. number of spacers.

FIG. 20A is a simulated contaminant profile using parallel spacers.

FIG. 20B is a simulated contaminant profile using offset spacers.

FIG. 21A is a simulated pressure profile using parallel spacers.

FIG. 21B is a simulated pressure profile using offset spacers.

FIG. 22 is a schematic of flow-around behavior of a packed bed filter that includes a foam packing material.

FIG. 23 is a plot showing the percent of sulfur dioxide breakthrough of various coated foams (amine-coated and carbon/K₂CO₃-coated foam) and an uncoated foam (bare foam).

FIG. 24 is a schematic depiction of concentrated contaminant loading onto a adsorbent media at 0%, 25%, 50%, and 75% material saturation, otherwise known as material life.

FIG. 25 is a schematic representation of z-flow through carbon-wrapped foam.

FIG. 26 is a plot showing a hydrogen sulfide breakthrough comparison of a coated foam (open foam) with a coated carbon-wrapped foam (z-configuration) during exposure to 50 ppm hydrogen sulfide at a flow rate of 300 mL/min and a temperature of 25° C.

FIG. 27 is a schematic of a packed bed having alternating foams layers and o-ring shaped spacers.

FIG. 28 is a plot showing the measured pressure drops (dP) for packed beds having o-ring spacers and either a 25 PPI foam or a 40 PPI foam at flow velocities of 8-20 m³/min.

FIG. 29 are velocity field predictions of a packed bed having 40 PPI foam and an o-ring spacer having a 40% opening size at a flow velocity of 11 m3/min (predicted dP=28 kPa).

FIG. 30 shows a predicted aerodynamic profile and predicted velocity field of a packed bed having a 25 PPI foam (bed height=10 cm, bed diameter=27.2 cm) and a double ellipsoid geometry spacer at a flow velocity of 11 m³/min (predicted dP=−0.5 kPa).

FIG. 31 shows computer fluid dynamic simulations of macroscopic and microscopic fluid velocity through miniaturized aerodynamic double ellipsoid geometries interspaced by 25 PPI foam with at a flow velocity of 11 m3/min (Bed diameter=27.2 cm), and packed bed height=5 cm; predicted dP ˜0.4 kPa for a 5 cm packed bed height and ˜3 kPa for 40 cm packed height).

FIG. 32 shows computer fluid dynamic simulation profiles of macroscopic and microscopic toluene concentration gradients through a packed bed having miniaturized aerodynamic double ellipsoid spacers interspaced by 25 PPI foam with at a flow velocity of 11 m3/min (ID=27.2 cm, packed bed height=5 cm, and 100 ppm toluene).

FIGS. 33A-33B are images of 25 PPI foams after an electrospinning mixture containing 1× polymer was electrospun onto the foam for either 1 minute (FIG. 33A) or 4 minutes (FIG. 33B).

FIGS. 34A-34B are images of 25 PPI foams after an electrospinning mixture containing 1.5× polymer was electrospun onto the foam for either 1 minute (FIG. 34A) or 4 minutes (FIG. 34B).

FIGS. 35A-35B are images of 25 PPI foams after an electrospinning mixture containing 2× polymer was electrospun onto the foam for either 1 minute (FIG. 35A) or 4 minutes (FIG. 35B).

FIGS. 36A-36B are images of 60 PPI foams after an electrospinning mixture containing 1× polymer was electrospun onto the foam for either 1 minute (FIG. 36A) or 4 minutes (FIG. 36B).

FIGS. 37A-37B are images of 60 PPI foams after an electrospinning mixture containing 1.5× polymer was electrospun onto the foam for either 1 minute (FIG. 37A) or 4 minutes (FIG. 37B).

FIGS. 38A-38B are images of 60 PPI foams after an electrospinning mixture containing 2× polymer was electrospun onto the foam for either 1 minute (FIG. 38A) or 4 minutes (FIG. 38B).

FIGS. 39A-39B are images of 80 PPI foams after an electrospinning mixture containing 1× polymer was electrospun onto the foam for either 1 minute (FIG. 39A) or 4 minutes (FIG. 39B).

FIGS. 40A-40B are images of 80 PPI foams after an electrospinning mixture containing 1.5× polymer was electrospun onto the foam for either 1 minute (FIG. 40A) or 4 minutes (FIG. 40B).

FIGS. 41A-41B are images of 80 PPI foams after an electrospinning mixture containing 2× polymer was electrospun onto the foam for either 1 minute (FIG. 41A) or 4 minutes (FIG. 41B).

FIGS. 42A-42B are plots showing the permeability of an 60 PPI foam (FIG. 42A) and a 60 PPI foam (FIG. 42B) after fine fibers were electrospun onto the foams from electrospinning mixtures having various of polymer concentrations (1×, 1.5×, and 2×).

FIGS. 43A-43B are plots showing the average fine fiber diameter of fibers on an 80 PPI foam (FIG. 43A) and on a 60 PPI foam (FIG. 43B) after the fine fibers were electrospun onto the foams from electrospinning mixtures having various polymer concentrations (1×, 1.5×, and 2×).

FIGS. 44A-44F are plots showing the distribution of measured pore widths of 80 PPI foams after fine fibers were electrospun onto the foams from electrospinning mixtures having a polymer concentration of 1× (FIG. 44A-44B), 1.5× (FIG. 44C-44D), or 2× (FIG. 44E-44F) for 1 minute (FIG. 44A, FIG. 44C, and FIG. 44E) or 4 minutes (FIG. 44B, FIG. 44D, and FIG. 44F).

FIGS. 45A-45F are plots showing the distribution of measured pore widths of 60 PPI foams after fine fibers were electrospun onto the foams from electrospinning mixtures having a polymer concentration of 1× (FIG. 45A-45B), 1.5× (FIG. 45C-45D), or 2× (FIG. 45E-45F) for 1 minute (FIG. 45A, FIG. 45C, and FIG. 45E) or 4 minutes (FIG. 45B, FIG. 45D, and FIG. 45F).

FIGS. 46A-46D are a first image (FIG. 46A), a second image (FIG. 46B), a third image (FIG. 46C), and a fourth image (FIG. 46D) of carbon particles suspended in a fine fiber web disposed on a 60 PPI foam.

FIGS. 47A-47C are images of a 40 PPI foam (FIG. 47A), a 60 PPI foam (FIG. 47B), and an 80 PPI foam (FIG. 47C) after an electrospinning mixture containing 10 wt-% polyvinylpyrrolidone was electrospun onto the foam for 4 minutes.

FIG. 48 shows two images at different magnifications of a 40 PPI foam after an electrospinning mixture containing mixture containing 10 wt-% polyvinylpyrrolidone and 25 wt-% carbon was electrospun onto the foam for 4 minutes.

FIG. 49 shows two images at different magnifications of a 60 PPI foam after an electrospinning mixture containing mixture containing 10 wt-% polyvinylpyrrolidone and 25 wt-% carbon was electrospun onto the foam for 4 minutes.

FIG. 50 shows two images at different magnifications of a 80 PPI foam after an electrospinning mixture containing mixture containing 10 wt-% polyvinylpyrrolidone and 25 wt-% carbon was electrospun onto the foam for 4 minutes.

FIGS. 51A-51B are images of a coated foam ligament surface before (FIG. 51A) and after (FIG. 51B) an electrospinning a mixture containing 10 wt-% polyvinylpyrrolidone was electrospun onto the foam for 4 minutes.

FIGS. 52A-52B are images of carbon particles shed from coated foam surface (FIG. 52A) and surface loaded carbon particles entrapped by electrospun nanofiber (FIG. 52B) on a coated 40 PPI reticulated foam with a fine fiber web.

FIG. 53 is an example plot showing percent contamination breakthrough as a function of time.

FIG. 54 is a schematic side view diagram illustrating a spacer in accordance with certain embodiments.

FIG. 55 is a schematic perspective view of the spacer of FIG. 54.

FIG. 56 is a schematic top view of the spacer of FIG. 54.

FIG. 57 is a schematic bottom view of the spacer of FIG. 54.

FIG. 58 is a schematic side view diagram illustrating a spacer in accordance with certain embodiments.

FIG. 59 is a schematic perspective view of the spacer of FIG. 58.

FIG. 60 is a schematic top view of the spacer of FIG. 58.

FIG. 61 is a schematic bottom view of the spacer of FIG. 58.

FIG. 62 is a plot of the carbon loading of foams coated using a coating mixture having varying amounts of carbon (wt-%) and nylon (wt-%).

FIG. 63 is a plot of the predicted surface area (SBET) of foams coated using a coating mixture having varying amounts of carbon (wt-%) and nylon (wt-%).

FIG. 64 is a plot of the predicted pore volume (Vp) of foams coated using a coating mixture having varying amounts of carbon (wt-%) and nylon (wt-%).

FIG. 65A-65C are images of coated foams coating using coating mixtures that include 75 wt-% carbon and 25 wt-% nylon (FIG. 65A), 85 wt-% carbon and 15 wt-% nylon (FIG. 65B), and 95 wt-% carbon and 5 wt-% nylon (FIG. 65C).

FIG. 66 is a plot of coating retention of foams coated using coating mixtures having various carbon to nylon weight ratios after subsector to 1000 pulses of 1.5 psi air.

FIG. 67A-67E are plots of carbon loading of foams coated using coating mixtures that had varying amounts of total solids and 70 wt-% carbon and 30 wt-% nylon (FIG. 67A), 75 wt-% carbon and 25 wt-% nylon (FIG. 67B), 80 wt-% carbon and 20 wt-% nylon (FIG. 67C), 85 wt-% carbon and 15 wt-% nylon (FIG. 67D), and 90 wt-% carbon and 10 wt-% nylon (FIG. 67E).

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

The term “polymer” and “polymeric material” include, but are not limited to homopolymers, copolymers, blends of two or more homopolymers, blends of two or more copolymers, blends of one or more homopolymers and one or more copolymers that have any geometric configuration such as a linear configuration, branched configuration, graft configuration, star configuration, isotactic symmetry, syndiotactic symmetry, atactic symmetry, or any combination thereof. Copolymers are polymers polymerized from two or more monomers and include block copolymers, alternating copolymers, periodic copolymers, statistical copolymers, stereoblock copolymers, gradient copolymers, and the like. Polymers are polymerized from one or more monomers. A polymer polymerized from a particular monomer may be described as “monomer name” polymer or poly (monomer name). For example, a polymer polymerized from n-butyl acrylate monomers, may be described as an n-butyl acrylate polymer or poly (n-butyl acrylate).

The term “longitudinal direction” is used herein to describe the direction along a longitudinal axis, x, as described further herein. The term “axial direction” is used herein to describe a direction perpendicular to the longitudinal axis x.

The terms “upstream” and “downstream” are used herein to describe respective positions within a fluid flow (e.g., an airflow). For example, if body A is upstream of body B, then the airflow will encounter A before B. In such an example, body B would be downstream of body A. Further, although the term “airflow” may be used throughout, it is understood that this disclosure applied not only to airflow, but also to fluid flow.

The term “substantially” as used here has the same meaning as “significantly,” and can be understood to modify the term that follows by at least about 90%, at least about 95%, or at least about 98%.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

In this description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

In several places throughout the following description, guidance is provided through lists of examples, which examples can be used in various combinations. In each instance, the recited list serves only as a representative group and should not be interpreted as an exclusive list.

### DETAILED DESCRIPTION

The present disclosure relates to volumetric media and methods of using volumetric media. Volumetric media includes one or more spacers and a packing material. The packing material may be designed for a specific application. Packing material may include a filtration material capable of removing one or more contaminants from a fluid flow. Packing material may include catalytic material. Volumetric media may be subjected to a continuous flow of a fluid (e.g., a gas, liquid, vapor, or any combination thereof). Volumetric media may be subjected to intermittent flow of a fluid. Volumetric media may be disposed within a housing.

Volumetric media may be used for gas filtration. As such, in some embodiments, a filter may include volumetric media disposed within a housing. For example, volumetric media may be used as a fuel cell air intake filter. Volumetric media may be used to catalyze a reaction. As such, in some embodiments, a reactor may include volumetric media disposed within a housing. In some cases, a filter that includes volumetric media may also be a reactor that includes volumetric media. For example, filter/reactor may be packed with volumetric material capable of transforming a contaminant compound from a fluid flow into another compound thereby removing the contaminant compound.

A fuel cell is an electrochemical cell that produces energy useful for powering various appliances, cars, tools, or other equipment. While batteries have a finite amount of reagents contained within the cell, at least some of the reagents that participate in the reactions of a fuel cell are supplied from a source external to the cell.

Reagents are commonly supplied to a fuel cell in the form of purified hydrogen (on the cathode side) and oxygen in the form of ambient air (on the anode side). The fuel cell may be exposed to contaminants in the feedstock. For example, ambient air may include various contaminants such as sulfur oxides (SOₓ), nitrogen oxides (NOₓ), siloxanes, ammonia, hydrogen sulfide, acidic compounds, siloxanes, and volatile organic compounds. These contaminants react with the metal catalyst sites in the fuel cell cathode which irreversibly diminishes its lifetime energetic output. For example, a fuel cell system exposed to 10 parts per billion (ppb) of airborne contaminants can have reduced energetic throughput by over 50% after only 4 hours.

In many cases, it may be desirable to provide media capable of filtering, removing, or at least partially removing, contaminants from a fluid (e.g., a gas). Filtration and/or removal of a contaminant from a gas may be accomplished through, for example, sorption (absorption and/or adsorption) of the contaminant to a sorbent material within the packed bed filter and/or the chemical transformation of a contaminant into a different compound.

It may be desirable to provide a media for filtering and/or removing contaminants from a gas, for example a fuel cell feedstock gas. Volumetric media and/or filters including volumetric media, may be used to filter fluid in fuel cell systems. In fuel cell systems, filtration efficiencies below 1 part per billion (ppb) may be desirable to prevent loss of performance of the fuel cell system. The higher flow of fuel cell air intake systems (ranging from around 3 to around 24 cubic meters per minute) can make it difficult to achieve such high filtration efficiencies.

In many instances, filter efficiency is increased by increasing fluid flow restriction, especially at high flow rates. However, increasing restriction results in higher pressure drops and/or slower filtration due to the more tortuous flow paths. In some cases, higher pressure drops can harm the filter itself. Packed bed filters may provide improved filtration performance (compared to, e.g., pleated filters) due to better flow uniformity and higher surface area, while also retaining a low fluid flow restriction. Lower restriction allows more air to be filtered over the same period of time as a filter with higher flow restriction. Packed bed filters may be described as having a volume of filtration material (e.g., a foam), which may be interspersed with spacers. Volumetric media may also be used to react incoming species into value added products.

### Volumetric Media

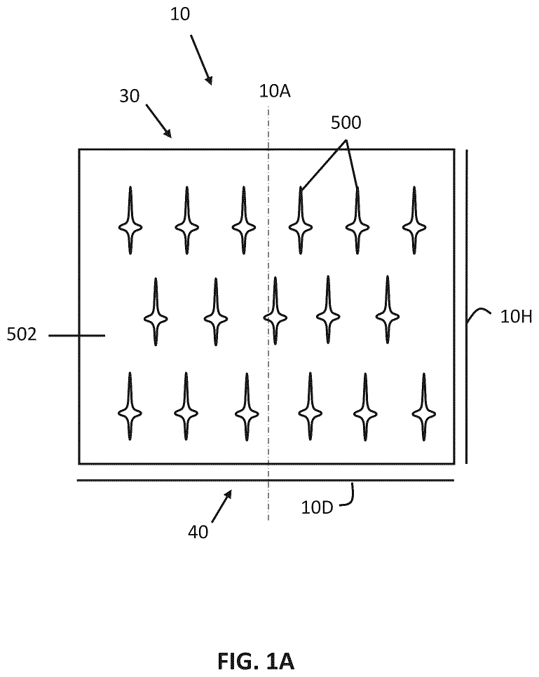

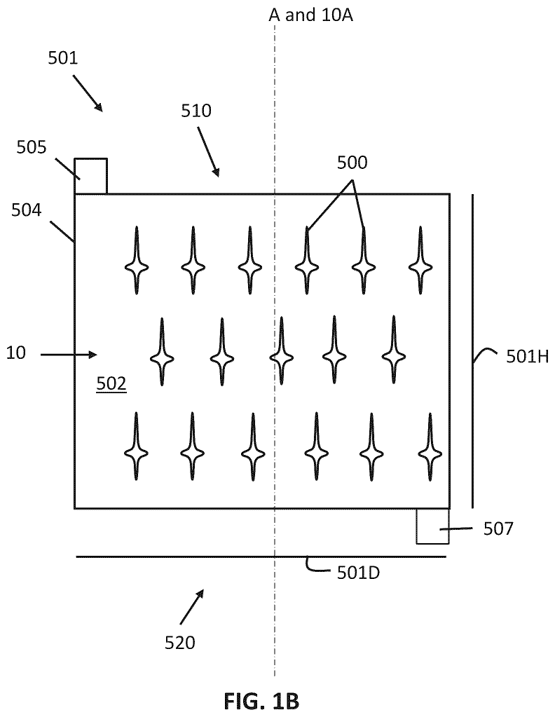

As diagrammatically illustrated in FIG. 1A, volumetric media 10 includes packing material 502 and one or more spacers 500. The packing material 502 is disposed between and/or around the at least one spacer 500. The packing material 502 may include a foam, active particles, polymers, fine fibers, or any combination thereof such as described herein. The volumetric media 10 may define a volumetric media axis 10A. The volumetric media 10 may define any shape or structure.

The volumetric media has an upstream end 30 and a downstream end 40. The upstream end is the region of the volumetric media that the fluid enters the volumetric media. The downstream end is the region of the volumetric media that the fluid exits the volumetric media. When in use, the fluid flows from the upstream end to the downstream end of the volumetric media.

The volumetric media may define a volumetric media height 10H. The volumetric media height 501H is the length of the packing material from the upstream end 30 of the volumetric media 10 to the downstream end 40 of the volumetric media 10. The volumetric media height may be defined by the volumetric media axis. The volumetric media height may vary. In some embodiments, the volumetric media height 10H is 1 cm or greater, 5 cm or greater, 10 cm or greater, 20 cm or greater, 30 cm or greater, 40 cm or greater, 50 cm or greater, or 75 cm or greater. In some embodiments, the volumetric media height 10H is 5 m or less, 4 m or less, 3 m or less, 2 m or less, 1 m or less, 75 cm or less, 50 cm or less, 40 cm or less, 30 cm or less, 20 cm or less, 10 cm or less, or 5 cm or less.

The volumetric media may define a volumetric media diameter 10D. The volumetric media diameter may be the width of the volumetric media measured on an axis perpendicular to the volumetric media height 501H. For example, the volumetric media diameter may be measured along an axis that is perpendicular to the volumetric media axis A. The volumetric media diameter 10D may be larger than the volumetric media height. The volumetric media diameter 10D may be smaller than the volumetric media height. The volumetric media diameter 10D may be the same as the volumetric media height.

The volumetric media may have a variety of filtration removal efficiencies for various contaminants. Filtration efficiency may be determined by breakthrough experiments. For example, a volumetric material may be disposed within a housing, heat treated to remove pre-adsorbed species, and exposed to a set flow and concentration of contaminant. The effluent profile of the contaminant is collected to determine the kinetic adsorption behavior of the adsorbent configuration.

In some embodiments, the volumetric media has an initial filtration efficiency of 80% or greater, 90% or greater, 95% or greater, 99% or greater, 99.9% or greater, or 100% of sulfur oxide compounds, nitrogen oxide compounds, ammonia, gaseous organic compounds, gaseous acid compounds, or any combination thereof. The filtration efficiency may be determined at a face velocity of 3 meters per second (m/s) and less than 1 kilopascal (kPa) restriction. The volumetric media may maintain its filtration efficiency for 1 hour or longer, 5 hours or longer, 10 hours or longer, 25 hours or longer, 50 hours or longer, 75 hours or longer, 100 hours or longer, 250 hours or longer, 500 hours or longer, 750 hours or longer, 1000 hours or longer, 2000 hours or longer, 3000 hours or longer, or at least 4000 hours.

### Packing Material

The volumetric media 10 includes a packing material 502. Within the volumetric media, the packing material may or may not physically contact one or more spacers. A volumetric media may include two or more layers, each layer including a packing material. The packing material of different layers may be the same or different.

The packing material may be any suitable packing material for a given application. The physical and/or chemical functionality of the packing material may vary based on the intended use of the spacer and/or packed bed containing the spacer. For example, in some embodiments, the packing material 502 may have one or more physical and/or one or more chemical properties useful for filtering, or removing, one or more contaminants from a fluid that comes into contact with the packing material. In some embodiments, the packing material may be capable of catalyzing a chemical transformation of one or more compounds in a fluid that comes into contact with the packing material. In some embodiments, the packing material is capable of filtering, removing, at least partially removing, or chemically transforming sulfur oxides (e.g., sulfur monoxide, sulfur dioxide, sulfur trioxide, and disulfur monoxide, collectively referred to as SOₓ), nitrogen oxides (e.g., nitric oxide and nitrogen dioxide, collectively referred to as NOₓ), siloxanes, ammonia, acidic compounds, basic compounds, organic compounds, and any combination thereof. In embodiments where the volumetric media may be included in a packed bed filter is used in conjunction with a fuel cell. In some such embodiment the filtering and/or removal of such compounds from gaseous feedstocks may increase the lifespan of the fuel cell.

The packing material may include and/or be made of an active material. An active material is a material that includes at least one component that is capable of participating in a chemical reaction and/or is capable of acting as a sorbent (absorbent and/or adsorbent). Examples of active materials include catalysts, adsorbents, absorbents, growth seeds, metal-organic frameworks, and any combination thereof.

In some embodiments, the packing material includes and/or is made of an adsorbent and/or absorbent capable of sequestering a contaminant from a fluid. In some embodiments, the packaging material includes or is made of a catalyst that is capable of transforming a compound from a fluid into a different compound. In some embodiments, the packing material includes or is made of a catalyst capable of transforming a contaminant into a second compound and includes or is made of an adsorbent capable of sequestering the contaminant from and/or the second compound.

In some embodiments, the packing material is made of and/or includes an adsorbent such as a physisorbent, a chemisorbent, a physisorbent-chemisorbent hybrid, or any combination thereof. An adsorbent is a material capable of adsorbing a compound; that is, the material is capable of isolating a compound from a fluid on at least a portion of its surface area. A physisorbent is an adsorbent that isolates a compound through the formation of weak interactions (e.g., van der Waals and/or electrostatic forces) between the physisorbent and the compound being adsorbed. A chemisorbent is an adsorbent that isolates a compound through the formation of an ionic or covalent bond between the chemisorbent and the compound being adsorbed.

Chemisorbent-physisorbent hybrids include grafted hybrids and impregnated hybrids. A grafted hybrid is a chemisorbent grafted onto a physisorbent or a physisorbent grafted onto a chemisorbent. An impregnated hybrid is a physisorbent impregnated with a chemisorbent or a chemisorbent impregnated with a physisorbent. Grafted hybrids are characterized as a chemisorbent being covalently linked to the physisorbent. Impregnated hybrids are characterized as the chemisorbent being located within the pores of a physisorbent. In impregnated hybrids, the chemisorbent is held in the pore via non-covalent interactions (e.g., van der Waals forces). In some embodiments, a grafted hybrid or an impregnated hybrid includes one or more of the following physisorbents, activated carbon, a zeolite, a silicate, a metal-organic framework (MOFs), or a mesoporous transition metal oxide. A zeolite is an aluminosilicate compound made of aluminum, oxygen, silicon, and one or more counterions. A silicate is a compound made up of oxygen and silicon atoms. A metal-organic framework is a compound made up of metal clusters connected through organic ligands.

Packing material may be made of and/or include an adsorbent capable of adsorbing a basic compound, an acidic compound, an organic compound, an inorganic compound, or any combination thereof. Such adsorbents may be a physisorbent, a chemisorbent, or a physisorbent-chemisorbent hybrid.

In some embodiments, the packing material may be made of and/or include an adsorbent that is capable of adsorbing an organic compound. An organic compound may be a compound that includes at least one carbon-hydrogen covalent bond and can be in the gas phase, vapor phase, liquid phase, or any combination thereof. Examples of organic compounds that adsorbents can adsorb include aromatic hydrocarbons such as toluene, benzene, xylene, and ethylbenzene; polycyclic aromatic hydrocarbons such as the 16 polycyclic aromatic hydrocarbons classified as priority pollutants by the United States Environmental Protection Agency in 2005 (i.e., naphthalene, acenaphthylene, acenaphthene, fluorene, phenanthrene, anthracene, fluoranthene, pyrene, benz(a)anthracene, chrysene, benzo(b)fluoranthene, benzo(k)fluoranthene, benzo(a)fluoranthene, dibenz(a,h)anthracene, benzo(ghi)perylene, and indeno(1,2,3-cd) pyrene); n-alkanes such as methane, ethane, n-propane, n-butane, n-pentane, and n-hexane; n-alkenes such as methylene, ethylene, propylene; various alcohols; aldehydes such as formaldehyde; siloxanes; n-alkynes such as methyne, ethyne, n-propyne, n-butyne, n-pentyne, and n-hexyne; ketones such as acetone; and any combination thereof. Examples of adsorbents capable of adsorbing a gaseous organic compound include activated carbon, graphite, zeolites (e.g., zeolite X, zeolite A, zeolite Y, zeolite B, and zeolite ZSM-S), silicates, metal-organic frameworks (MOFs), mesoporous transition metal oxides, porous organic cages (POCs), porous-organic frameworks (POFs), porous alumina, and combinations thereof.

In some embodiments, the packing material may be made of and/or include an adsorbent that is capable of adsorbing an inorganic compound. An inorganic compound may be a compound that does not have at least one carbon-hydrogen bond and can be in the gas phase, vapor phase, liquid phase, or any combination thereof. Examples of inorganic compounds that adsorbents can adsorb include carbon dioxide; carbon monoxide; nitrogen oxides; sulfur oxides; hydrogen sulfide; siloxanes; water; perfluorocarbons such as tetrafluoromethane and hexafluoroethane; sulfur hexafluoride; ozone; and combinations thereof. Examples of adsorbents capable of adsorbing one or more inorganic compounds include activated carbon, graphite, porous alumina, zeolites (e.g., zeolite X, zeolite A, zeolite Y, zeolite B, and zeolite ZsM-5), silicates, metal-organic frameworks (MOFs), mesoporous transition metal oxides, porous organic cages (POCs), porous-organic frameworks (POFs), and combinations thereof.

In some embodiments, the packing material may be made of and/or include an adsorbent that is capable of adsorbing an acidic compound. An acidic compound may be compound that when mixed with water at a pH of 7, acidifies the water such that the pH of the resultant solution is below 7. The acid compound may be in the gas phase, vapor phase, liquid phase, or any combination thereof. Acidic compounds may be inorganic compounds or organic compounds. Examples of acidic compounds that adsorbents can adsorb include sulfur oxides, nitrogen oxides, hydrogen sulfide, and combinations thereof. Examples of adsorbents capable of adsorbing an acidic compound include chemisorbents that include a group I metal (Li, Na, K, Rb, Cs, Fr) carbonate; a metal oxide; a group I metal (Li, Na, K, Rb, Cs, Fr) hydroxide; a group II metal (Be, Mg, Ca, Sr, Ba, Ra) hydroxide; a group II metal (Be, Mg, Ca, Sr, Ba, Ra) oxide; an N-containing compound such as an amine (e.g., tetraethylenepentamine, ethylenediamine and 3-aminopropyltriethoxysilane), an imine (e.g., polyethyleneimine), an amino acid such as β-alanine or glycine, and an ammonium salt (e.g., ammonium persulfate); and any combinations thereof. In some embodiments, the selected chemisorbent may be grafted onto a physisorbent, or impregnated within a physisorbent such as activated carbon; a zeolite; a silicate; or combinations thereof.

In some embodiments, the packing material may be made of and/or include an adsorbent that is capable of adsorbing a basic compound. A basic compound may be a compound that when mixed with water at a pH of 7, basifies the water such that the pH of the resultant solution is above 7. The basic compound may be in the liquid state, gas state, vapor state, or any combination thereof. Basic compounds may be inorganic compounds or organic compounds. Examples of basic compounds that adsorbents can adsorb include ammonia and nitrogen trifluoride. Examples of adsorbents capable of adsorbing a basic compound include physisorbents such as activated carbon, zeolites, silicates, metal-organic frameworks (MOFs), graphite, porous alumina, porous organic cages (POCs), porous organic frameworks (POFs), and combinations thereof. Additional examples of adsorbents capable of adsorbing a basic compounds include chemisorbents that have a carboxylic acid (COOH) functional group. Examples of chemisorbent compounds that have a carboxylic acid functional group include citric acid, terephthalic acid, trimesic acid, tartaric acid, maleic acid, benzoic acid, oxalic acid, and combinations thereof. Chemisorbents capable of adsorbing a basic compounds include inorganic acids such as boric acid, nitric acid, sulfuric acid, hydrochloric acid, hydrogen chloride, hydrogen fluoride, hydrogen bromide, phosphoric acid, perchloric acid, periodic acid, and any combination thereof. Such chemisorbents may be grafted onto or impregnated within a physisorbent such as activated carbon, a zeolite, a silicate, or any combinations thereof.

In some embodiments, the packing material includes and/or is made of a catalyst. A catalyst is a chemical species that alters the rate of one or more reactions without being consumed. The packing material may include any suitable catalyst, or a combination of catalysts, for facilitating any desired reaction. In some embodiments, desirable reactions may include nitrobenzene reduction, nitrogen oxide reduction (NOₓ reduction), hydrogenation, and any combination thereof. Catalysts that are able to remove, prevent, and/or reduce contaminants in a fuel cell feedstock from entering a fuel cell may be of particular interest. For example, the packing material may include a catalyst capable of reducing and/or converting one or more nitrogen oxide compounds (e.g., nitric oxide, nitrogen dioxide, dinitrogen trioxide, and/or nitrate) into diatomic nitrogen. Catalysts may also include materials which can reduce and/or convert one or more sulfurous compounds (e.g., sulfur monoxide, sulfur dioxide, dihydrogen sulfide) into a sulfur salt, such as potassium iodide. Catalysts may also include materials capable of photocatalytically degrading volatile organic compounds into carbon dioxide. Examples of catalysts capable of photocatlyticaclly degrading organic compounds include titanium metal and titanium dioxide. Titanium metal and titanium dioxide can be used to remove formaldehyde from a fluid (e.g., gas). The catalysts may be grafted onto a support such as an adsorbent (described elsewhere herein).

In some embodiments, the packing material is made of and/or includes a catalyst capable of destroying ozone (O₃); that is, the catalyst is able to convert ozone (O₃) to oxygen (O₂) by way of bond rearrangement. Some fuel cells use oxygen (O₂) as a reagent. As such, increasing the amount of O₂ entering the system in place of ozone may be beneficial. Examples of catalysts capable of ozone destruction include silicates such as iron silicates, iron manganese silicates, zinc iron silicates, and any combinations thereof; transition metal oxides such as zinc oxide, manganese oxide, copper oxide, cerium dioxide, and any combinations thereof; reduced metals (i.e., zero-valent metals) that include titanium, lead, iron, copper, zinc, chromium, cobalt, nickel, manganese, gold, silver, platinum, palladium, rhodium, tungsten, molybdenum, vanadium, zirconium, silicon, ruthenium, and any combinations thereof; carbonates such as barium carbonate, magnesium carbonate, calcium carbonate, strontium carbonate, and any combinations thereof; zeolites; and combinations thereof.

In some embodiments, the catalyst is capable of performing hydrogenation and/or cross-coupling reactions. Such chemical transformations may be useful for small molecule synthesis. Examples of catalysts capable of initiating such reactions include platinum, palladium, rhodium, iridium, palladium (II) chloride, iron, iron oxide, gold, silver, copper, copper oxide, compounds containing the same, and any combination thereof.

In some embodiments, the packing material is made of and/or includes a catalyst capable of ozone destruction that includes manganese oxide (e.g., amorphous manganese oxide), copper oxide, or both. Amorphous materials have little to no crystallinity, which is in contrast to polymorphic materials. An example of an ozone destroying catalyst that includes amorphous manganese oxide is available from Carus LLC (La Salle, IL) under the tradename CARULITE 400. In some embodiments, the packing material is made of and/or includes catalyst capable of ozone destruction that includes cerium dioxide. In some embodiments, the packing material is made of and/or includes a catalyst capable of ozone destruction that includes manganese oxide, copper oxide, cerium dioxide, or any combination thereof.

The packing material may include or may form a porous substrate such as a foam. Porous substrates include one or more major surfaces. A major surface is a surface of the substrate that forms an interface with the surrounding environment. Pores may be connected to (e.g., in fluid communication with) the major surface of a substrate. Pores connected to a major surface are pores that are accessible to fluid (i.e., liquid or gas) or solids (e.g., solid particulates) through the external surface. Pores connected to the major surface are not considered a part of the major surface because the volume of the pore extends into the interior of the substrate. For example, the major surfaces of a porous substrate that is a cube are the facets of the cube. The major surface can have topography that is constant or that varies in the x, y, and/or z directions. For example, each one of the major surfaces of a porous substrate can be smooth or rough. The porous substrate may have a single continuous major surface, such as, for example, a spherical or ovoid substrate. The porous substrate may have multiple major surfaces such as, for example, a polyhedron.

Porous substrates have a plurality of pores. A pore is defined as a void space within the interior of a substrate. The void space of the pore is defined by a pore surface. The total amount of void space is the pore volume. Pores may be a through pore, an open pore, or a blind pore. A through pore is a pore that is connected to (e.g., accessible from) a major surface by two or more pore openings. An open pore is a pore that is connected to (e.g., is accessible from) a single pore opening on one major surface. A blind pore is a pore that is no connected to a pore opening on a major surface. Pores may have a variety of morphologies.

Porous substrates may include a plurality of macro pores. Macro pores are pores that exist between solid portions of the material that make up the porous substrate. Generally, macro pores have a pore opening size of 1 mm or greater, some of which can be seen with the naked eye. Material, such as active particles, may impregnate at least a portion of the macro pores of the porous substrate. Macro pores may be through pores, open pores, or blind pores.

A porous substrate may include a plurality of micro pores. Micro pores are pores that exist between solid portions of the material that make up the porous substrate. Micro pores have a pore opening size of less than 1 mm. In some cases, a micro pore may exist within the wall of a macro pore. Micro pores may be collapsible pores as described herein or may not be collapsible pores.

In some embodiments, porous substrates made of a wettable polymeric material may include a plurality of collapsible pores. Collapsible pores are formed by the interstitial space between polymer chains within the solid portion of the substrate in which material such as the active particles and/or polymer, may become embedded (as discussed elsewhere herein). Collapsible pores are in a collapsed state and are not accessible to a fluid or a solid prior to wetting the wettable material. Wetting the wettable material expands the collapsible pores allow such pores to be accessible to a fluid or solid. Drying of the wettable material may cause the collapsible pore to collapse thereby trapping some or none or the material within the pore at the time of collapse in the interstitial space between polymer chains. A wettable substrate may be a substrate made of a material that is capable of absorbing some quantity of liquid to expose micro pores. Polyurethane foams, cellulose foams, and melamine foams are an example of a wettable substrate.

In some embodiments, the porous substrate is a foam. The foam may be made of an active material such as the active materials described herein. In some embodiments, the foam may be made of an adsorbent.

The foam may be a reticulated foam. The term reticulated foam is typically used to refer to open-cell foams that form a net or a mesh shape (as opposed to closed-cell foams that form bubble or cell shapes). The majority of pores in a reticulated foam may be open pores and/or through pores. Reticulated foams typically are very porous and have a low density. For example, reticulated foams may have a porosity of 60% or greater, 90% or greater or 95% or greater as measured by three-dimensional topographical scans. Reticulated foams may be polymer-based; metal-, metal oxide-, or metal carbide-based; carbon-based; or any combination thereof. Reticulated foams may be made of more than one material even though only one material is stated. Examples of polymer-based reticulated foams include reticulated polyester, reticulated polyether, reticulated polyurethane, reticulated polyurethane without heat treatment, reticulated cellulose, and reticulated melamine. Examples of carbon-based reticulated foams include reticulated activated carbon, reticulated vitreous carbon, and reticulated graphene. Examples of metal-based reticulated foams include reticulated foams made from reduced metals (i.e., zero-valent metals) such as titanium, lead, iron, copper, zinc, chromium, cobalt, nickel, manganese, gold, silver, platinum, palladium, rhodium, tungsten, molybdenum, vanadium, zirconium, silicon, ruthenium, and any combination thereof. Examples of metal oxide-based reticulated foams include reticulated silicon oxide. Examples of metal carbide-based reticulated foams include reticulated silicon carbide. Examples of alumina-based reticulated foams include reticulated foams made of aluminum oxide.

The reticulated foam may have any suitable number of pores per inch (PPI) defined using three-dimensional scans of the surface coupled with assessment of the average pore size via scanning electron microscopy. For example, the reticulated foam May 3 PPI or greater, 10 PPI or greater, 20 PPI or greater, 30 PPI or greater, 40 PPI or greater, 50 PPI or greater, 60 PPI or greater, 70 PPI or greater, 80 PPI or greater, 90 PPI or greater or 100 PPI or less, 90 PPI or less, 80 PPI or less, 70 PPI or less, 60 PPI or less, 50 PPI or less, 40 PPI or less, 30 PPI or less, 20 PPI or less, or 10 PPI or less.

In some embodiments, the packing material further includes active particles, a polymer, or both. The packing material may include foam (e.g., reticulated foam) and active particles, a polymer, or both active particles and polymer. The active material of the active particles may be any active material described herein. In some embodiments, the active particles are made of and/or include a catalyst, an absorbent, an adsorbent, or any combination thereof. The active particles may be made of the same material as the foam or made of a different material than the foam. In some embodiments, the polymer is a fine fiber. In some embodiments, the polymer is a binder polymer. A binder polymer may be configured to secure active particles to the foam. The binder polymer may be a homopolymer, copolymer, or a blend of two or more polymers. Examples of binder polymers include nylon (e.g., nylon 6; nylon 66; and nylon 6-10), polybenzimidazole, polypropylene, polyethylene, polyester, polyethylene oxide, polyacrylonitrile, polyvinylidene chloride; polyvinylidene fluoride; polystyrene; and polyvinyl alcohol, aromatic polyamide, aliphatic polyamide, polyurethane, poly (ethylene terephthalate), polyvinyl pyrrolidone, styrene butadiene rubber, polysulfone, polymethylmethacrylate, polysiloxane, and any combination thereof.

Each active particle of the active particles has a particle size. The particle size is defined as the greatest distance across a particle. The average particle size of the active particles may vary based on the identity of the active particles and/or the intended use of the packed bed filter. Active particle size and average active particle size may be measured using microscopy techniques including scanning electron microscopy. The active particles may have an average particle size (geometric average diameter) of 0.001 micrometers (μm) or greater, 0.01 μm or greater, 0.1 μm or greater, 1 μm or greater, 5 μm or greater, 10 μm or greater, or 100 μm or greater. The active particles may have an average particle size of 500 μm or less, 100 μm or less, 10 μm or less, 1 μm or less, 0.1 μm or less, or 0.01 μm or less.

In some embodiments, the foam is at least partially coated with active particles; a polymer, or both. Coating a foam with a material includes disposing the material on a surface of the foam, impregnating the foam with the material, embedding the material within the foam, or a combination of two or more thereof. As such, in some embodiments, active particles, a polymer, or both is disposed on a surface of the foam; the foam is impregnated with active particles, a polymer or both; the foam has active particles, a polymer, or both embedded within; or any combination thereof.

A material that is embedded within a foam may be intercalated (e.g., inserted into) a collapsible pore of the foam, and upon partial collapse or full collapse of the some cases, a collapsible may exist within a macro pore; that is, the total pore volume of said pore is the sum of the pore volume of the macro pore and the micropore, the material that is embedded within the foam may transfer/move to and remain in the solid portion of the foam at or proximate to the location of the collapsible pore. Collapsible pores in foam may be formed when a wettable foam absorbs a wetting liquid and expands to expose interstitial spaces in which material may intercalate. Upon removal of a sufficient amount of the wetting liquid, the foam contracts and any material that was intercalated in the collapsible pores at the time of contraction becomes embedded within the solid portion of the foam.

A material that impregnates a foam is disposed on at least a portion of a pore surface.

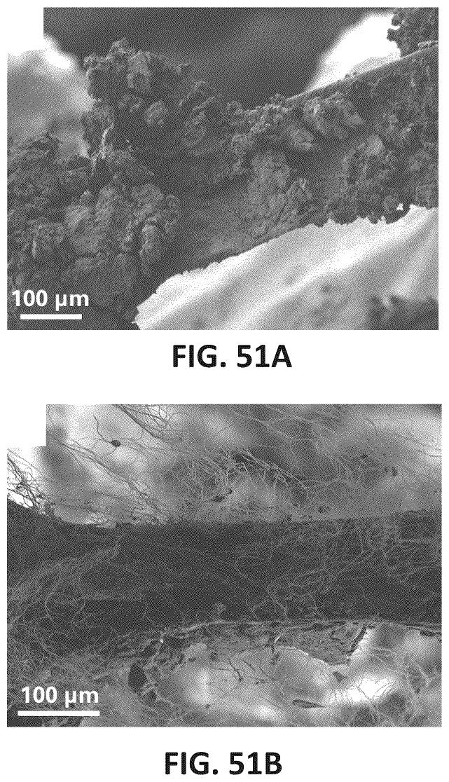

FIG. 51A shows an example of the surface of reticulated foam having active particles and a polymer disposed thereon.

A foam (e.g., a reticulated foam) may be coated with active particles, a binder polymer, or both via dip coating, spray coating, or the like. For example, a foam may be contacted with a coating mixture that includes a liquid carrier and the binder polymer, at least a portion of a solid particulate that forms the active particles, or both. The liquid carrier may include water, one or more organic solvents (e.g., ethyl acetate, ethanol, methanol, isopropanol, tetrahydrofuran, butanol, dichloromethane, toluene, acetonitrile, acetone, diethyl ether, amyl alcohol, or the like); or both. The mixture may include an emulsion of the binder polymer. The solid particulate may be dissolved in the liquid carrier (e.g., dissociated at the ionic level) or suspended (e.g., not ionically dissociated) in the liquid carrier. The coating mixture may further include a surfactant.

In some embodiments when the foam is a wettable porous substrate, the foam may be contacted with a wetting mixture prior to and/or after contacting the substrate with the coating mixture. The wetting mixture may expose collapsible pores in which the active particles and/or the polymer may become embedded. The wetting mixture includes any liquid capable of wetting the substrate; that is, swelling the substrate to expose collapsible pores in the solid portion of the substrate. Depending on the foam, the wetting liquid may be an organic solvent such as ethanol, methanol, acetone, or acetonitrile. In some embodiments, the wetting mixture includes at least a portion of the solid particulate that makes up the active particles. In some such embodiments, the wetting liquid may be chosen such that at least one component of the solid particulate is not soluble therein. In other embodiments, the wetting liquid may be chosen such that at least one component of the solid particulate is soluble (and dissolves) in the wetting liquid. In other embodiments, the liquid carrier of the coating mixture is a wetting liquid. In some embodiments, the foam may be exposed to two wetting mixtures. The two wetting mixture may include a first wetting mixture lacking a solid particulate and a second wetting mixture containing a solid particulate.

After exposure to the coating mixture and/or the wetting mixture, the foam may be dried to remove at least a portion of the liquid carrier, surfactant (if present), wetting liquid (if present), or any combination thereof. Drying may be accomplished, for example, by air drying, vacuum drying, contacting the foam with an absorbent material (e.g., cotton; cellulose; a sponge including polyester, polyurethane, vegetal cellulose, melamine, or combinations thereof; anhydrous calcium chloride; anhydrous magnesium sulfate; and sodium polyacrylate), exposing the foam to an elevated temperature (e.g., 30° C. to 400° C.), or any combination thereof.

In some embodiments, the packing material includes fine fibers. A fine fiber is a fiber having a diameter of 10 micrometers (μm) of less, such as 5 μm or less, 1 μm or less, 0.5 μm or less, 0.1 μm or less, 0.05 μm or less, 0.01 μm or less, or 0.001 μm or less. The diameter of a fine fiber may be measured using microscopy techniques including scanning electron microscopy. The fine fiber may be made of any suitable material. In some embodiments, the fine fiber is a polymer. The polymer may be an electrospun polymer. The polymer may be a homopolymer, copolymer, or a blend of two or more polymers. Examples of polymers include nylon (e.g., nylon 6; nylon 66; and nylon 6-10), polyethylene, polypropylene, polybenzimidazole, polytetrafluoroethylene, polyester, polyethylene oxide, polyacrylonitrile, polyvinylidene chloride; polyvinylidene fluoride; polystyrene; and polyvinyl alcohol, aromatic polyamide, aliphatic polyamide, polyurethane, poly (ethylene terephthalate), polyvinyl pyrrolidone, styrene butadiene rubber, polysulfone, polyethersulfone, polymethylmethacrylate, and any combination thereof.

The fine fibers may be disposed on one or more surfaces of the foam, span one or more pore openings, or both. For example, the fine fibers may be disposed on one or more major surfaces of the foam. In some embodiments, each fine fiber may span one more pore opening on the foam. One or more fine fibers may form a web or net-like structure spanning one or more pore openings on the foam. In embodiments where the packing material includes active particles, the fine fibers may prevent the active particles from shedding and/or being removed from the foam.

The fine fibers may be electrospun from an electrospun mixture onto one or more surfaces of the foam, for example, on one or more major surfaces of the foam. The electrospinning mixture may include a liquid carrier and the polymer that makes up the fine fibers. In some embodiments where the packing material includes active particles, the electrospinning mixture further includes a solid particulate that makes up at least a portion of the active particles.

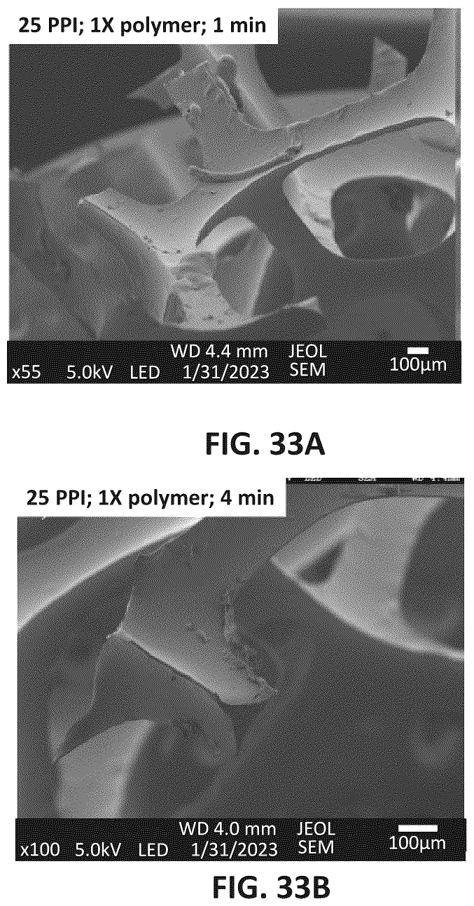

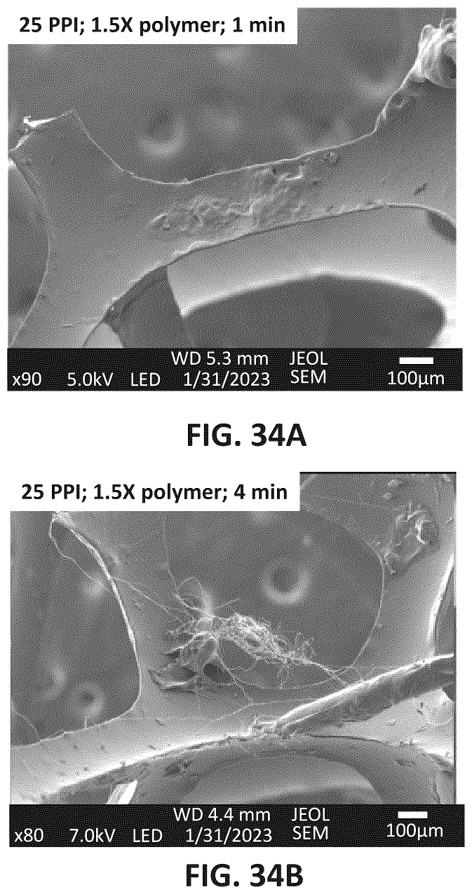

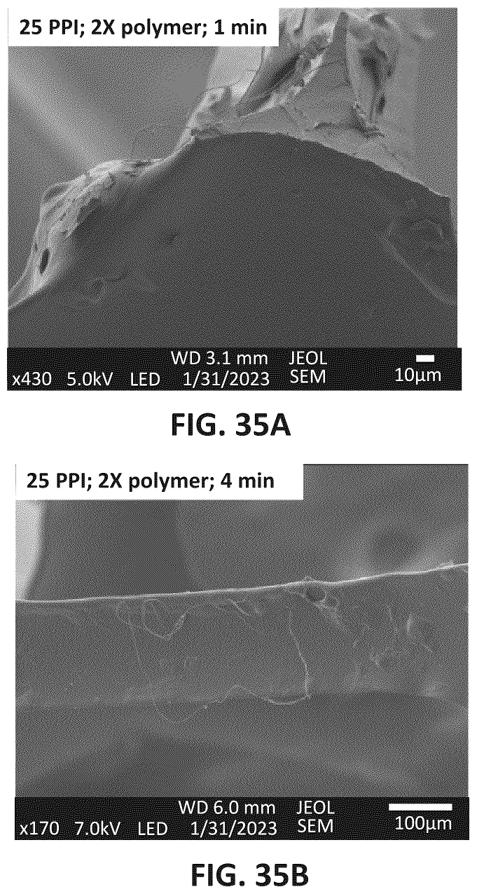

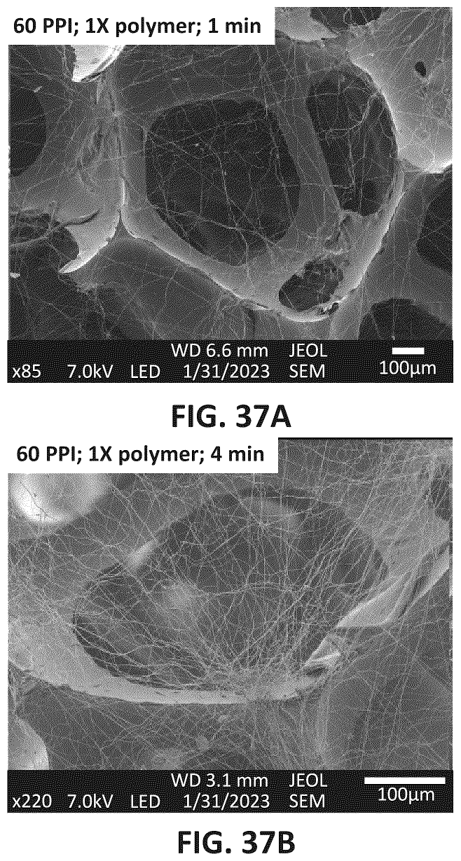

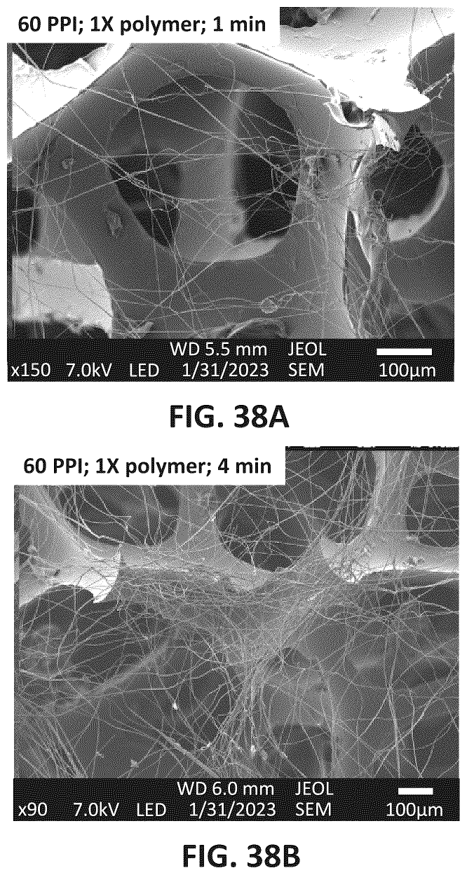

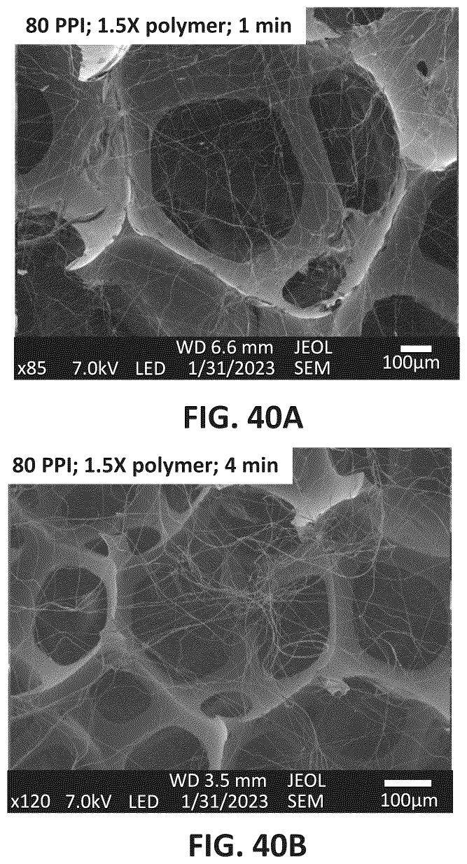

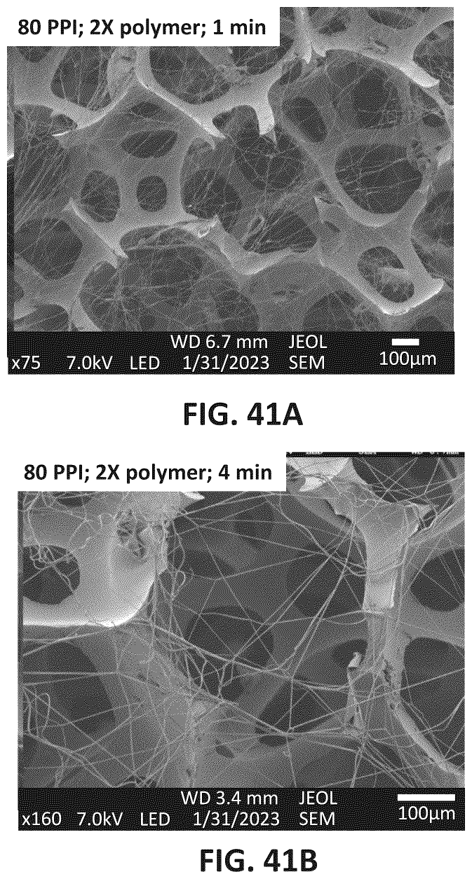

FIGS. 33A-41B show scanning electron micrographs of reticulated foams having various pores per inch (PPI) after electrospinning mixtures having various concentrations of polymer were electrospun onto the foam. The fine fibers span the pore openings creating a web-like structure or net structure.

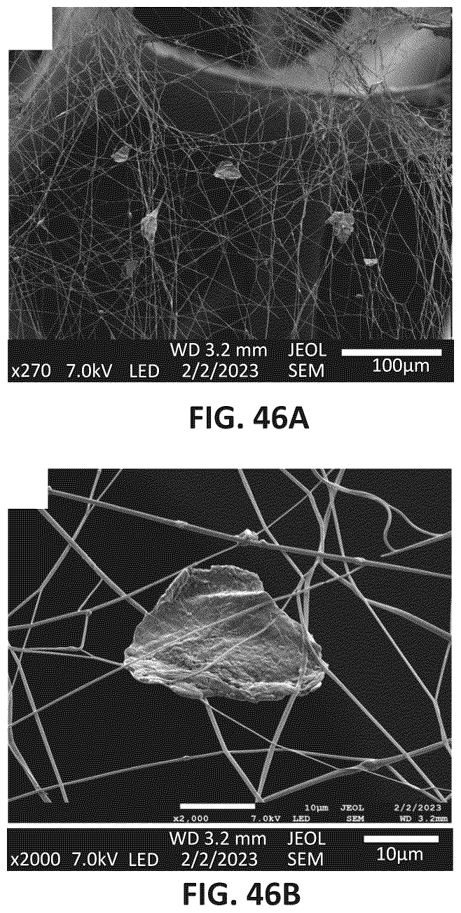

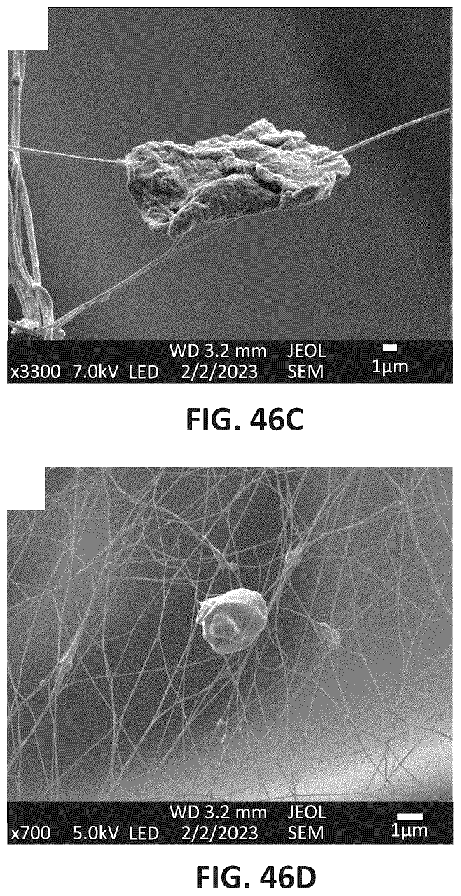

FIGS. 46A-46D, 48, 49, and 50 show scanning electron micrographs of reticulated foams after electrospinning mixtures having various polymers and solid particulate were electrospun onto the foam. Active particles can be observed suspended in the fine fiber web-like structure that spans the pores of the foam.

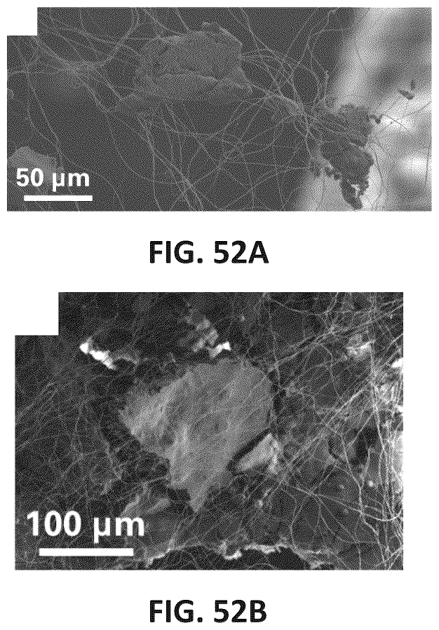

FIGS. 51B, 52A, and 52B show scanning electron micrographs of a reticulated foam coated in active particles and a binder polymer with a fine fiber network. The fine fiber network functions to capture the active particles that have become unbound from the foam surface so that the active particles cannot be shed from the foam (FIG. 52A). The fine fiber network also functions to hold active particles in contact with the foam surface (FIG. 52B).

In some embodiments, the packing material includes a foam (e.g., a reticulated foam) and active particles. In some embodiments, the packing material includes a foam (e.g., a reticulated foam) and a polymer. In some embodiments, the packing material includes a foam (e.g., a reticulated foam) and fine fibers. In some embodiments, the packing material includes a foam (e.g., a reticulated foam), active particles, and a polymer. In some embodiments, the packing material includes a foam (e.g., a reticulated foam), active particles, and fine fibers. In some embodiments, the packing material includes a foam (e.g., a reticulated foam), active particles, a polymer, and fine fibers.

In some embodiments, the volumetric filter media includes two or more packing materials. The different packing materials may be configured to filter and/or remove different contaminants from a fluid. For example, a volumetric filter media may include a first packing material configured to filter and/or remove acidic compounds and a second packing material configured to filter and/or remove basic compounds. As such, the packing materials may include one or more different components. For example, the packing material may differ in foam material, active particle material (if present), polymer material (if present), fine fiber material (if present), or any combination thereof. Two or more different packing materials may be in physical contact. Two or more different packing materials may not be in physical contact. For example, in embodiments where two or more adjacent packing materials are not compatible (e.g., would react with each other) it may be beneficial to prevent contact between the packing materials. Two or more different packing materials may be separated by one or more spacers.

### Spacers and Spacer Arrays

The volumetric filter media includes at least one spacer. The packing material may be disposed around a spacer. The spacer may or may not be in contact with the packing material. Spacers may provide structure to the packing material in a packed bed filter, which may advantageously allow for higher fluid flow rates through the packed filter without harming the packing material. Spacers may also provide increased filtration efficiency if the spacer itself is constructed of or with filtration material. Spacers may also be used to guide gas flow to induce a more desirable gas flow pattern (e.g., turbulent gas flow), resulting in increased filtration efficiency as the gas impinges upon a larger surface area of packaging material.

The volumetric filter media may include a plurality of spacers. The shape and distribution of spacers within the packing material may be varied in order to provide efficient and effective filtration through the packed bed without increasing restriction of fluid flow or pressure drop through the packed bed filter. Spacers can provide efficient and effective filtration without unduly increasing restriction of gas flow.

In some embodiments, the volumetric filter media includes a spacer that is shaped to be aerodynamic. An aerodynamic shape is one that reduces drag from fluid moving past the shape, compared to a shape that is otherwise similar but is not aerodynamic. Aerodynamic spacers thus reduce drag from gas moving past, along, and/or around the spacers. Aerodynamic spacers may advantageously provide structure to a volumetric filter media, and may further advantageously increase filtration efficiency. Aerodynamic spacers may further advantageously induce a more desirable gas flow along/around the spacer and through the volumetric filter media, and may further advantageously resist increasing restriction of gas flow along/around the spacer and through the packed bed filter. The spacers may be grouped together to form a spacer array. As such, in some embodiments, a volumetric filter media includes a spacer array.

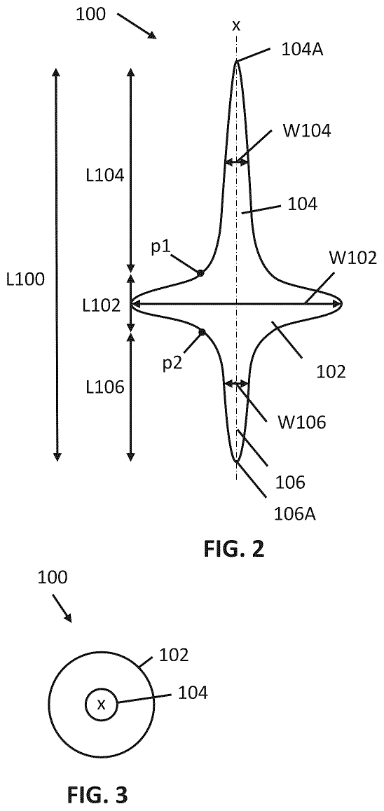

FIGS. 2 and 3 illustrate an example spacer that may be used in a volumetric filter media of the present disclosure. The spacer may have any suitable shape, structure, and size, and may be constructed of any suitable material, as discussed herein. In some embodiments, there may be a plurality of spacers that together form a spacer array that may be used in a volumetric media of the present disclosure. FIG. 2 is a schematic cross-sectional side view diagram illustrating a spacer 100. FIG. 3 is a schematic top view diagram illustrating the spacer 100. As illustrated in FIG. 2, the spacer 100 defines a longitudinal axis, x, extending along a centerline of the spacer 100. The longitudinal axis, x, may or may not be aligned with a longitudinal axis of a packed bed, a filter, a filter array, or a longitudinal axis of a foam. That is, the spacer 100 may be longitudinally aligned with other objects, or may be misaligned from other objects, as discussed further herein.

The spacer 100 includes a main body 102. The main body 102 has a cross-sectional dimension W102. The main body cross-sectional dimension W102 may be any cross-sectional measurement of the main body 102 as measured in a plane perpendicular to the longitudinal axis x. The main body cross-sectional dimension W102 may vary along a main body length L102. The main body length L102 may be defined as the maximum dimension of the main body 102. The main body length L102 may be measured along the longitudinal axis x. The main body 102 may be substantially lentil-shaped. That is, the main body 102 may resemble a lentil, or a disc or lens. Such shapes may advantageously create an aerodynamic main body 102. Fluid flow along and/or around the main body 102 may have lower restriction or resistance due to the lentil-shape, at least because fluid flow will not encounter any sharp corners (e.g., vertices or edges) or blockages. An outer surface of the spacer 100 may define a curved surface contour. The outer surface of the spacer 100 may be free of edges and vertices. Spacers 100 with curved surfaces and/or surfaces free of edges and vertices may advantageously reduce fluid flow restriction or resistance, allowing greater and/or faster fluid flow along and/or around the spacer 100.

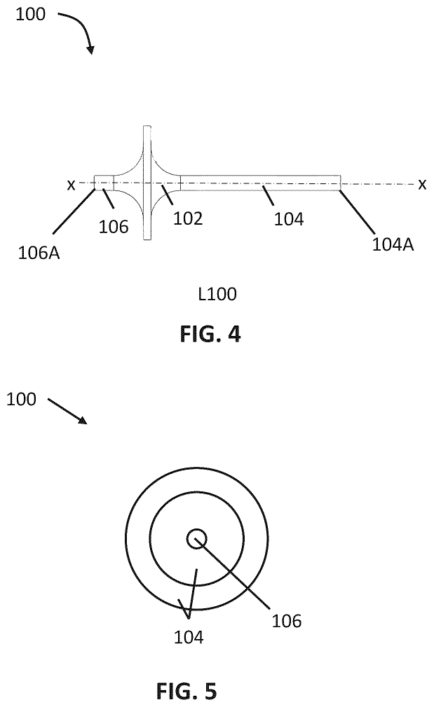

The main body of the spacer may have any suitable length L102. The main body length L102 may be, for example, 2.0 centimeters (cm) or less, 1.5 cm or less, 1.25 cm or less, 1.0 cm or less, or 0.5 cm or less. The main body length L102 may be 0.2 cm or more, 0.5 cm or more, 0.8 cm or more, 1.2 cm or more, 1.8 cm or more, or 2.4 cm or more. The main body length L102 may range from 1.0 cm to 3.0 cm or from 0.5 cm to 2.5 cm. The main body cross-sectional dimension W102 may be, for example, 4.0 cm or less, 3.0 cm or less, 2.0 cm or less, 1.5 cm or less, 1.25 cm or less, 1.0 cm or less, or 0.5 cm or less. The main body cross-sectional dimension W102 may be 0.2 cm or more, 0.8 cm or more, 1.2 cm or more, 1.8 cm or more, 2.4 cm or more, 3.4 cm or more, or 4.4 cm or more. The main body cross-sectional dimension W102 may range from 0.2 cm to 1.0 cm, from 0.5 cm to 2.0 cm, or from 0.5 cm to 3.5 cm. In one embodiment, the main body length L102 may be about 1.5 cm and the main body cross-sectional dimension W102 may be 2.15 cm, as illustrated in FIGS. 4-5.

The spacer 100 may include a leading pin 104. The leading pin 104 may extend from the main body 102 in a longitudinal direction away from the main body 102. The leading pin 104 is considered to be bounded by the main body 102 at a point p1 where a tangent of the surface of the spacer 100, measured in a vertical cross-sectional plane (e.g., as in FIG. 2), crosses 45 degrees relative to the longitudinal axis x. When the spacer 100 is positioned in a fluid flow, the leading pin 104 may be upstream of the main body 102. Thus, airflow along and/or around the spacer 100 will encounter the leading pin 104 before encountering the main body 102. The leading pin 104 defines a leading pin cross-sectional dimension, W104. The leading pin cross-sectional dimension W104 may be any cross-sectional measurement of the leading pin 104 as measured in a plane perpendicular to the longitudinal axis x. The leading pin cross-sectional dimension W104 may vary along a leading pin length, L104. The leading pin length L104 may be defined as the maximum dimension of the leading pin 104 measured along the longitudinal axis x.

A leading pin distal end 104A may come to a point (FIG. 2) or may have a rounded tip or a blunt tip (e.g., as in FIG. 4). A pointed tip may advantageously reduce resistance to fluid flow in the downstream direction. A blunt tip may advantageously provide turbulent or tortuous flow, which may increase the surface area of the spacer 100 that the fluid contacts and may increase the surface area of any surrounding foam that the fluid contacts. Such increased contact(s) may increase the filter efficiency, as more fluid contacts more of the filter material. Additionally, filter efficiency may increase as more fluid contacts the (that may be constructed of or with filter material).

The leading pin length L104 may be, for example, 4.0 cm or less, 2.5 cm or less, 2.0 cm or less, 1.5 cm or less, 1.25 cm or less, 1 cm or less, or 0.5 cm or less. The leading pin length L104 may be 0.2 cm or more, 0.5 cm or more, 0.8 cm or more, 1.2 cm or more, 1.8 cm or more, 2.4 cm or more, or 3.4 cm or more. The leading pin length L104 may range from 1.0 cm to 3 cm, or from 0.5 cm to 2.5 cm. The leading pin cross-sectional dimension W104 may be, for example, 2.0 cm or less, 1.5 cm or less, 1.25 cm or less, 1.0 cm or less, 0.5 cm or less. The leading pin cross-sectional dimension W104 may be 0.2 cm or more, 0.8 cm or more, 1.2 cm or more, 1.8 cm or more, or 2.4 cm or more. The leading pin cross-sectional dimension W104 may range from 0.2 cm to 1.0 cm, or from 0.5 cm to 2.0 cm. In one embodiment, the leading pin length L104 may be about 3.0 cm and the leading pin cross-sectional dimension W104 may be 0.15 cm at a leading pin distal end 104A, as illustrated in FIGS. 4-5.

The spacer 100 may Include a trailing pin 106. The trailing pin 106 may extend from the main body 102 in a longitudinal direction away from the main body 102. The trailing pin 106 is considered to be bounded by the main body 102 at a point p2 where a tangent of the surface of the spacer 100, measured in a vertical cross-sectional plane (e.g., as in FIG. 2), crosses 45 degrees. When the spacer 100 is positioned in a fluid flow, the trailing pin 106 may be downstream of the main body 102. Thus, airflow along and/or around the spacer 100 will encounter the main body 102 before encountering the trailing pin 106. The trailing pin 106 defines a trailing pin cross-sectional dimension, W106. The trailing pin cross-sectional dimension W106 may be any cross-sectional measurement of the trailing pin 106 as measured in a plane perpendicular to the longitudinal axis x. The trailing pin cross-sectional dimension W106 may vary along a trailing pin length L106. The trailing pin length L106 may be defined as the maximum dimension of the trailing pin 106 measured along the longitudinal axis x.

A trailing pin distal end 106A may come to a point (FIG. 2) or may have a blunt tip (e.g., as in FIG. 4). A pointed tip may advantageously reduce resistance to fluid flow in the downstream direction. A blunt tip may advantageously provide turbulent or tortuous flow, which may increase the surface area of the spacer 100 that the fluid contacts and may increase the surface area of any surrounding packing material that the fluid contacts. Such increased contact(s) may increase the filter efficiency, as more fluid contacts more of the packing material within the packed bed filter itself.

The trailing pin length L106 may be, for example, 3.5 cm or less, 2.5 cm or less, 2.0 cm or less, 1.5 cm or less, 1.25 cm or less, 1 cm or less, or 0.5 cm or less. The trailing pin length L106 may be 0.2 cm or more, 0.8 cm or more, 1.2 cm or more, 1.8 cm or more, 2.4 cm or more, or 3.4 cm or more. The trailing pin length L106 may range from 1 cm to 3 cm or from 0.5 cm to 2.5 cm. The trailing pin cross-sectional dimension W106 may be, for example, 2.5 cm or less, 2.0 cm or less, 1.5 cm or less, 1.25 cm or less, 1.0 cm or less, or 0.5 cm or less. The trailing pin cross-sectional dimension W106 may be 0.2 cm or more, 0.8 cm or more, 1.2 cm or more, 1.8 cm or more, or 2.4 cm or more. The trailing pin cross-sectional dimension W106 may range from 0.2 cm to 1.0 cm or from 0.5 cm to 2.0 cm. In one embodiment, the trailing pin length L106 may be about 0.5 cm and the trailing pin cross-sectional dimension W106 may be 0.15 cm at a trailing pin distal end 106A, as illustrated in FIGS. 4-5.

The spacer 100 defines a spacer length L100, measured along the longitudinal axis x. The spacer length L100 is equal to the total length of the spacer as defined by the addition of the leading pin length L104, the main body length L102 and the trailing pin length L106 all together (FIG. 2). The spacer length L100 may be, for example, 5.0 cm or less, 2.5 cm or less, 2.0 cm or less, 1.5 cm or less, 1.25 cm or less, 1 cm or less, or 0.5 cm or less. The spacer length L100 may be 0.2 cm or more, 0.8 cm or more, 1.2 cm or more, 1.8 cm or more, 2.4 cm or more, 3.4 cm or more, or 4.4 cm or more. The spacer length L100 may range from 1 cm to 3 cm or from 0.5 cm to 2.5 cm. In one embodiment, the spacer length L100 may be about 5.0 cm, as illustrated in FIG. 4.

The leading pin length L104 may be greater than the trailing pin length L106. A longer leading pin 104 may advantageously provide less resistance or restriction to the fluid flow, as the leading pin 104 can more gradually increase the leading pin cross-sectional dimension W104. A more gradual increase in the leading pin cross-sectional dimension W104 provides less resistance or restriction than a faster increase in the leading pin cross-sectional dimension W104, as the fluid flow moves downstream and encounters the increasing leading pin cross-sectional dimension W104. On the downstream side of the main body 102, the fluid flow moves from a higher resistance area created by the main body 102 to a lower resistance area created by the trailing pin 106. Thus, it may be less important for the trailing pin 106 to provide a decreasing trailing pin cross-sectional dimension W106 that decreases as gradually as the gradual increase in the leading pin cross-sectional dimension W104, because the fluid flow is encountering less resistance/restriction along the length of the trailing pin 106. In some alternative embodiments, the trailing pin is very short or the spacer 100 may not include a trailing pin at all, which may advantageously save material required for the spacer 100. However, in embodiments with the trailing pin 106, the trailing pin 106 may advantageously re-direct fluid flow in the downstream direction. A ratio of the leading pin length L104 to the trailing pin length L106 may be 1.25 parts or greater to 1 part, 1.01 parts or greater to 1 part, 1.5 parts or greater to 1 part, or 2 parts or greater to 1 part. The ratio of L104 to L106 may be 10 parts or less to 1 part, 5 parts or less to 1 part, or 3 parts or less to 1 part.

As illustrated in FIG. 3, from a top view along the longitudinal axis x of the spacer 100, the leading pin 104 and the main body 102 are visible. As illustrated in FIGS. 2-3, the main body cross-sectional dimension W102 is greater than the leading pin cross-sectional dimension W104. The main body cross-sectional dimension W102 is greater than the trailing pin cross-sectional dimension W106. These relative cross-sectional dimensions may advantageously allow for fluid flow (e.g., air flow) to encounter the leading pin 104 prior to encountering the main body 102. The smaller cross-sectional dimension of the leading pin 104 is less resistive or restrictive to the airflow. Thus, the spacer 100 is more aerodynamic. The fluid flow will encounter the most resistance or restriction at the main body 102. Then, the fluid flow will flow around the main body 102 and along the trailing pin 106. The relative cross-sectional dimensions may advantageously allow for fluid flow to encounter the main body 102 prior to encountering the trailing pin 106. The smaller cross-sectional dimension of the trailing pin 106 is less resistive or restrictive to the fluid flow. Thus, the fluid flow will be directed along the trailing pin 106 to continue through the packed bed with minimal resistance or restriction.

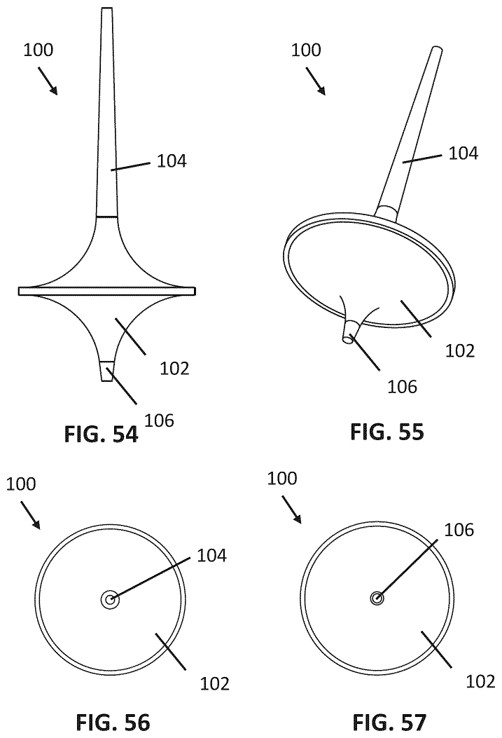

FIGS. 54-57 provide further illustrations of the spacer 100. FIGS. 54-55 illustrate the spacer 100, including the main body 102, the leading pin 104, and the trailing pin 106 as described herein. FIG. 56 illustrates a top-down view of the spacer 100, and thus only the leading pin 104 and the main body 102 are visible. FIG. 57 illustrates a bottom-up view of the spacer 100, and thus only the trailing pin 106 and the main body 102 are visible.

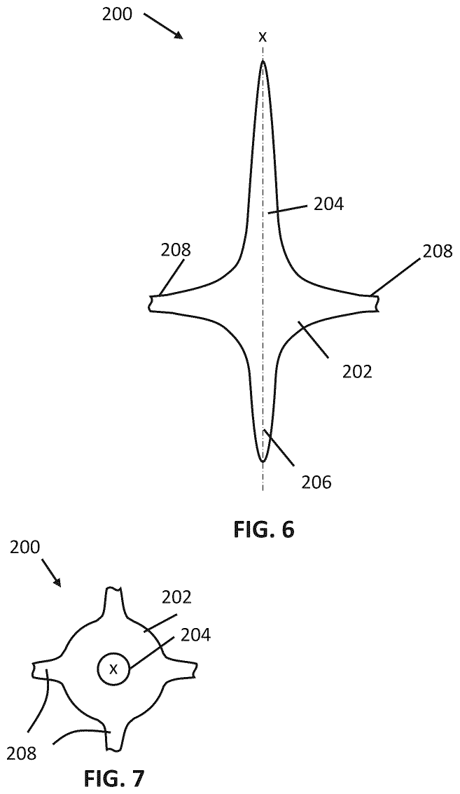

FIGS. 6-7 illustrate a cut-away view of a connected spacer 200 that may be used in a volumetric media of the present disclosure. The spacer 200 may have any suitable shape, structure, and size, and may be constructed of any suitable material, as further discussed herein. In some embodiments, there may be a plurality of connected spacers 200 that together form a spacer array that may be used in a packed bed filter of the present disclosure. FIG. 6 is a schematic side view diagram illustrating the spacer 200. FIG. 7 is a schematic top view diagram illustrating the spacer 200. The spacer 200 may be similar to the spacer 100 unless otherwise noted herein. For example, the spacer 200 includes a main body 202, a leading pin 204, and a trailing pin 206 as described above with respect to the spacer 100. Additionally, the spacer 200 includes at least one connector 208. The connector(s) 208 may be integral with the main body 202, and may extend from the main body 202 in an axial direction, or perpendicular to the longitudinal axis x, or may extend from the main body 202 in a direction transverse to the longitudinal axis x. As illustrated in FIG. 7, the connector(s) 208 may extend from the main body 202 in various directions, and may advantageously be used to connect, or couple, the spacer 200 to another object (e.g., another identical spacer 200 with its own connector(s) 208). Thus, the connector(s) may be used to connect a plurality of spacers 200 to one another.

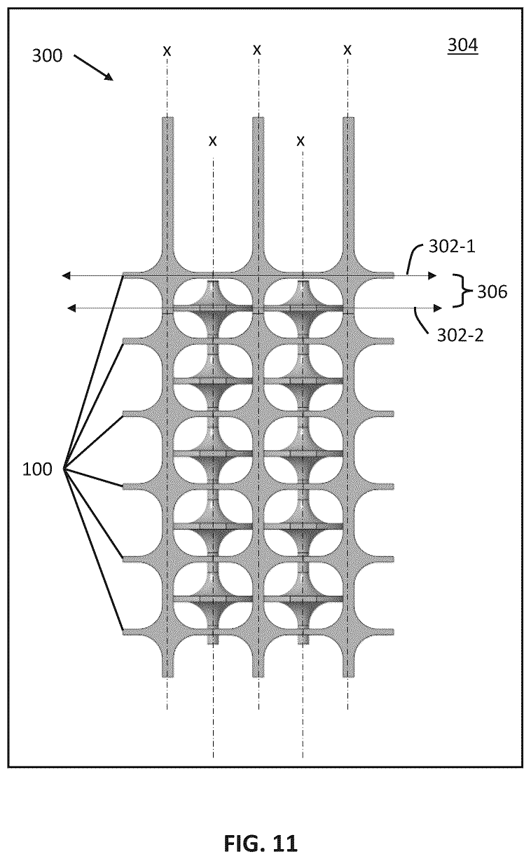

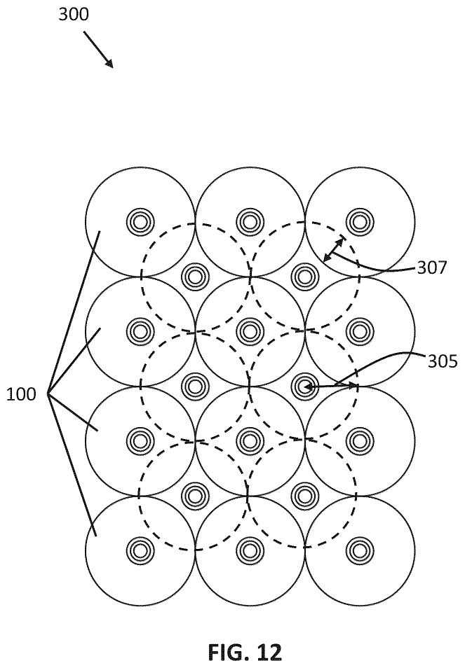

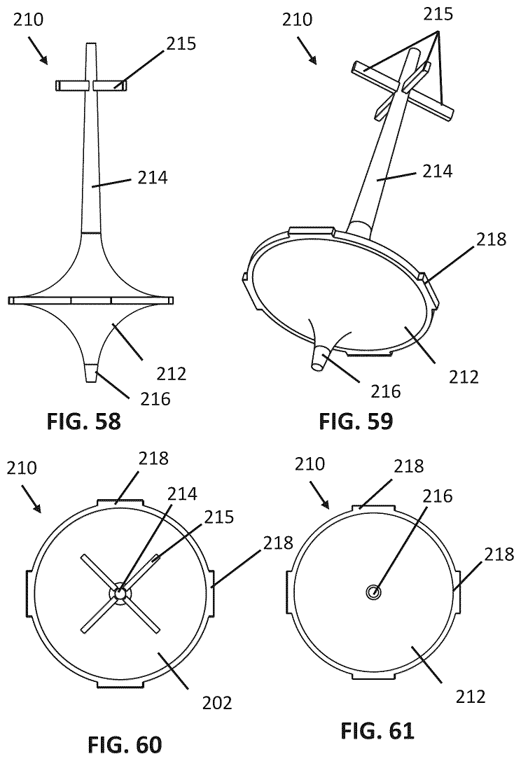

FIGS. 58-61 illustrate another embodiment of a connected spacer 210. The spacer 210 may be similar to the spacers 100, 200 unless otherwise noted herein. For example, the spacer 210 includes a main body 212, a leading pin 214, and a trailing pin 216 as described above with respect to the spacers 100, 200. Additionally, the spacer 210 includes at least one connector 218 as described above with respect to connector(s) 208. Additionally, the spacer 210 includes at least one connector 215. The connector(s) 215 may be integral with the main body 212, and may extend from the main body 212 in an axial direction, or perpendicular to the longitudinal axis x, or may extend from the main body 212 in a direction transverse to the longitudinal axis x. As illustrated in FIGS. 11-12, the connector(s) 215 may extend from the main body 212 in various directions, and may advantageously be used to connect, or couple, the spacer 210 to another object (e.g., another identical spacer 210 with its own connector(s) 215). Thus, the connector(s) may be used to connect a plurality of spacers 210 to one another.

FIGS. 58-59 illustrate the spacer 210, including the main body 212, the leading pin 214, the trailing pin 216, the connector(s) 218, and the connector(s) 215 as described herein. FIG. 60 illustrates a top-down view of the spacer 210, and thus only the leading pin 214, the main body 212, and the connector(s) 215, 218 are visible. FIG. 61 illustrates a bottom-up view of the spacer 210, and thus only the trailing pin 216, the main body 212, and the connector(s) 218 are visible.

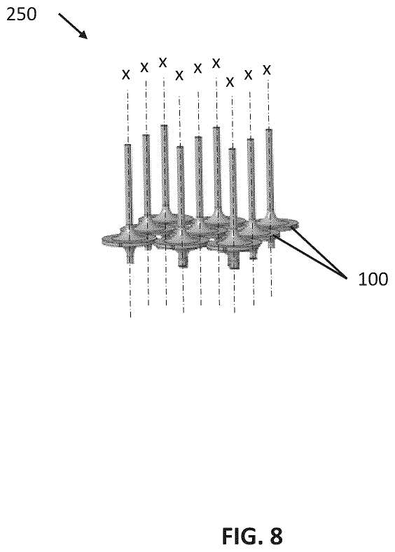

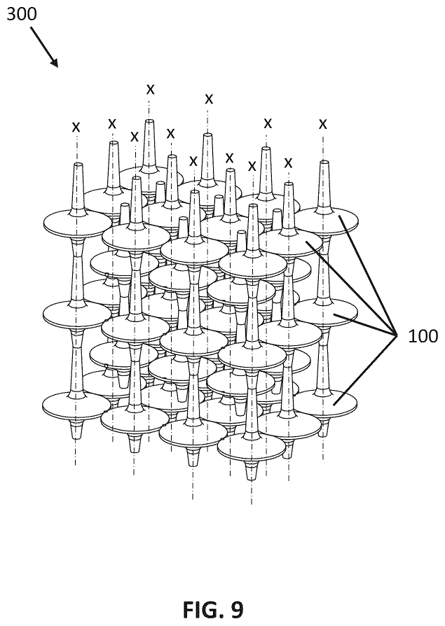

Adjacent spacers 200 may be connected to one another via the connector(s) 208 to form a spacer array. A plurality of spacers 200 may be connected in a plane (e.g., transverse plane 302), forming a grid 250 as illustrated in FIG. 8. Multiple grids 250 of spacers 200 may be arranged in a stack, forming the spacer array 300 as further discussed below in regard to FIGS. 9-12.

As illustrated in FIG. 8, the grid 250 includes a plurality of spacers 100. In alternative embodiments, the grid 250 may include a plurality of connected spacers 200, or a combination of spacers 100, 200.

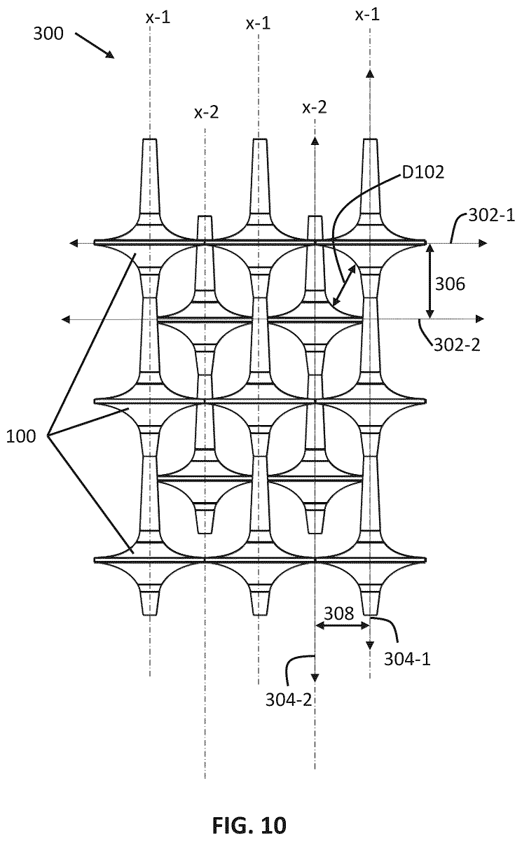

FIGS. 9-12 illustrate an example of a spacer array 300. FIG. 9 is a perspective view of the spacer array 300. FIG. 10 is a side view of the spacer array 300. FIG. 11 is a cross-sectional view of the spacer array 300. FIG. 12 is a top view of the spacer array 300. Multiple grids may be stacked to form the spacer array 300. As illustrated, the plurality of spacers 100 may advantageously form a tortuous flow path through the spacer array 300. A tortuous flow path may advantageously allow fluid flow through the spacer array 300 to have a turbulent flow that contacts a larger surface area of packing material within the packed bed filter than embodiments with less turbulent fluid flow, or that contacts a larger surface area of each of the plurality of spacers 100 than embodiments with less turbulent fluid flow. Increased contact between the fluid and the packing material results in more efficient filtering of the fluid.

The plurality of spacers 100, 200, as illustrated, are arranged in at least one transverse plane 302 (FIGS. 10-11, e.g., 302-1, 302-2). Each of the at least one transverse planes 302 may be perpendicular relative to the longitudinal axes, x, of the spacers 100, 200 in that same transverse plane 302. The spacer array 300 may include 100 or fewer transverse planes 302, or may include 50 or fewer, 25 or fewer, 10 or fewer, 5 or fewer transverse planes 302, etc. Each transverse plane 302 may include a plurality of spacers 100, 200. Each of the plurality of spacers 100, 200 may be operably coupled to at least one other of the plurality of spacers 100, 200 (e.g., via the connector(s) 208 as described herein). Each of the longitudinal axes x of the plurality of spacers 100 may be parallel to one another in the transverse plane 302. Parallel longitudinal axis x may advantageously minimize resistance to fluid flow through the spacer array 300. As illustrated in FIGS. 9-12, the plurality of spacers may form a grid disposed in the at least one transverse plane 302.

As illustrated in FIGS. 10-11, the plurality of spacers 100 may be arranged in a plurality of transverse planes 302 (e.g., 302-1, 302-2). Each of the plurality of transverse planes 302 may be perpendicular relative to the longitudinal axes x of the spacers 100 in that same transverse plane 302, as described above. Each of the plurality of transverse planes 302 may be parallel to one another. Further, any two adjacent transverse planes 302 may have a plane space 306 therebetween, as measured in a direction parallel to the longitudinal axes x (FIG. 10). The plane space 306 may advantageously reduce restriction or resistance to fluid flow through the spacer array 300. The plane space 306 between adjacent transverse planes 302 may be 0.5 cm or greater, 0.75 cm or greater, 1.0 cm or greater, 1.25 cm or greater, or 1.5 cm or greater. The plane space 306 may be 6.0 cm or less, 5.0 cm or less, 4.5 cm or less, 4.0 cm or less, 3.5 cm or less, or 3.0 cm or less.

Additionally, any two main bodies 102 in adjacent transverse planes 302 may have a layer gap D102 therebetween, as measured in any direction (FIG. 10). The layer gap D102 may be a gap between the main bodies 102 of the spacers 100 in adjacent transverse planes 302 such that the main bodies 102 in adjacent transverse planes 302 are not in contact with one another. The layer gap D102 may advantageously reduce restriction or resistance to fluid flow through the spacer array 300. The layer gap D102 between main bodies 102 in adjacent transverse planes 302 may be 0.5 cm or greater, 0.75 cm or greater, 1.0 cm or greater, 1.25 cm or greater, or 1.5 cm or greater. The layer gap D102 may be 6.0 cm or less, 5.0 cm or less, 4.5 cm or less, 4.0 cm or less, 3.5 cm or less, or 3.0 cm or less.

In some alternative embodiments, each of the plurality of transverse planes 302 may not be parallel to one another and may instead be offset from one another at an angle. In such alternative embodiments, the plane space 306 may be variable along the transverse planes 302. Such alternative embodiments may provide an advantageous fluid flow (e.g., turbulent fluid flow) through the packed bed filter as desired.

The plurality of spacers 100 may further be arranged in at least one longitudinal plane 304 (FIGS. 10-11, e.g., 304-1, 304-2). Each of the at least one longitudinal planes 304 may be parallel to the longitudinal axes, x, of the spacers 100 in that same longitudinal plane 304. FIG. 10 illustrates a cross-sectional view of the spacer array 300 taken along a longitudinal plane 304. Further, any two adjacent longitudinal planes 304 may have a longitudinal plane space 308 therebetween, as measured in a direction perpendicular to the longitudinal axes x (FIG. 10). The longitudinal plane space 308 may be a gap between the axes x of the spacers 100 in adjacent longitudinal planes 304 such that the axes x in adjacent longitudinal planes 304 are not in contact with one another. The longitudinal plane space 308 may advantageously reduce restriction or resistance to fluid flow through the spacer array 300. The longitudinal plane space 308 may be 0.5 cm or greater, 0.75 cm or greater, 1.0 cm or greater, 1.25 cm or greater, 1.5 cm or greater. The longitudinal plane space 308 may be 6.0 cm or less, 5.0 cm or less, 4.5 cm or less, 4.0 cm or less, 3.5 cm or less, 3.0 cm or less, etc.

In some alternative embodiments, each of the plurality of longitudinal planes 304 may not be parallel to one another and may instead be offset from one another at an angle. In such alternative embodiments, the longitudinal plane space 308 may be variable along the longitudinal planes 304. Such alternative embodiments may provide an advantageous fluid flow (e.g., turbulent fluid flow) through the packed bed filter as desired.

Additionally, as illustrated in FIGS. 9-12, each of the main bodies 102 in one transverse plane 302 may partially overlap with at least one of the main bodies 102 in an adjacent transverse plane 302 when viewed in a direction parallel to the longitudinal axis x. Such partial overlap of the main bodies may advantageously increase the surface area of spacer(s) 100 upon which fluid may impinge or contact, increasing filtration efficiency and efficacy. Such partial overlap of the main bodies may further advantageously increase the surface area of spacer(s) 100 upon which fluid may impinge or contact, increasing catalytic efficiency and efficacy. Such partial overlap 307 (FIG. 12) may be 50% or less of the main body cross-sectional dimension W102 in one transverse plane 302, or may be 25% or less, 20% or less, 15% or less, 10% or less, 5% or less. Such partial overlap may include more than or equal to 1%, 7%, 12%, 15%, 20%, 30%, 40%, 50% of the main body cross-sectional dimension W102 in one transverse plane 302.

Further, as illustrated in FIGS. 9-12, the spacers 100 in a first transverse plane 302-1 may define a first plurality of longitudinal axis x-1, and the spacers 100 in a second transverse plane 302-2 define a second plurality of longitudinal axis x-2. The first and second transverse planes 302-1, 302-2 may be adjacent to one another. The second plurality of longitudinal axes x-2 may be transversely offset from the first plurality of longitudinal axes x-2 by an axis offset distance 305 as measured in a direction perpendicular to the longitudinal axes (FIG. 11). The axis offset distance 305 may be about 0.5 cm, 1.0 cm, 2.0 cm, or 3.0 cm. A longitudinal axis x-1 located within a first longitudinal plane 304-1 may be transversely offset from a longitudinal axis x-2 located within a second longitudinal plane 304-2 by about 0.5 cm, 1.0 cm, 2.0 cm, or 3.0 cm.

The plurality of spacers 100, 200, 400, 500 may be oriented within the housing such that the leading pins are oriented toward the upstream end and the trailing pins are oriented toward the downstream end. The longitudinal axes x of the plurality of spacers 100, 200, 400, 500 may be parallel with the housing axis A (FIG. 1A and FIG. 1B).

The spacer(s) and spacer array(s) as described herein may be formed using a variety of methods, including injection molding, 3D printing, and machining. Various methods for forming spacers and spacer arrays are described below.

In one embodiment, each of the plurality of spacers may be 3D printed. Any suitable material for 3D printing may be used. For example, the spacers may be 3D printed using a plastic, polymer, ceramic, metal-organic framework (MOF), biomaterial, or metal material, or any combination thereof. A MOF is a porous crystalline material made of metal ions or metal clusters interconnected by organic linkers. In one embodiment, each of the plurality of spacers may be injection molded using a plastic, metal, ceramic, metal-organic framework, biomaterial, or any combination thereof.

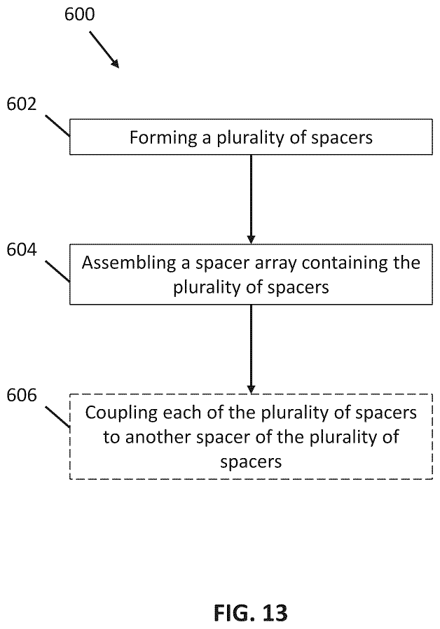

As illustrated in FIG. 13, a method 600 of making a spacer array (the spacer array as described herein) may include forming (e.g., molding or printing) a plurality of spacers 602 (the plurality of spacers are as described above). Molding the plurality of spacers may include injection molding the plurality of spacers individually. Molding the plurality of spacers may include injection molding the plurality of spacers integrally (e.g., as a single unit, or as multiple units). Printing the plurality of spacers may include 3D printing the plurality of spacers individually. Printing the plurality of spacers may include 3D printing the plurality of spacers integrally (e.g., as a single unit, or as multiple units). The method 600 may further include assembling the spacer array containing the plurality of spacers 604. As illustrated in dashed line, assembling the spacer array may optionally include coupling each of the plurality of spacers to another spacer of the plurality of spacers 606. Coupling each of the plurality of spacers to another spacer of the plurality of spacers may include coupling the main bodies of each of the spacers together. Coupling each of the plurality of spacers to another spacer of the plurality of spacers may include coupling the connectors (e.g., connector(s) 208 as described herein) of each of the spacers together.

The spacer may be made of any suitable material. In some embodiment, the spacer is made of a solid material. The spacer may be constructed of a metal, a plastic, a ceramic, carbon, metal-organic framework, biomaterial, or any combination thereof. In some embodiments, the spacer is constructed of and/or may be at least partially coated with an active material such as any active material described herein. In some embodiments where the spacer is constructed of and/or is at least partially coated with an active material, the spacer may advantageously increase the filtration of the packed bed overall because the spacer itself participates in filtering and/or removing one or more compounds of the gas that flows along and/or around the spacer.

Filters and Reactors that Include Volumetric Media

The present disclosure describes filters and/or reactor that include the volumetric media. The term filter/reactor is understood to mean filter and/or reactor. As diagrammatically illustrated in FIG. 1B, a filter/reactor 501 includes volumetric media 502 disposed within a housing 504. The filter/reactor 501 includes at least one spacer 500. The filter/reactor 501 includes a packing material 502 disposed between and/or around the at least one spacer 500. The volumetric media may include more than one spacer, for example, an array of spacers. The volumetric media has an upstream end 30 and a downstream end 40. The packing material 502 may include a foam, active particles, polymers, fine fibers, or any combination thereof such as described herein. The filter/reactor 501 may include a housing 504.

The housing 504 may define any shape or structure. The filter/reactor 501 may define 504 may define any shape or structure. The housing may define a housing axis A. In some embodiments, the housing axis A and the volumetric media axis 10A are the same. In some embodiments, the housing axis A and the volumetric media axis 10A are parallel. The housing may define an inner housing diameter 501D. The housing may define an inner housing height 501H. In some embodiments, the inner housing diameter 501D is the same or slightly larger than the volumetric media diameter. In some embodiments, the inner housing height 501D is the same or slightly larger than the volumetric media height.

The filter/reactor has an upstream end 510 and a downstream end 520. The upstream end is the region of the filter that the fluid enters the filter/reactor. The downstream end is the region of the filters/reactor that the fluid exits the filters and/or reactor. When in use, the fluid flows from the upstream end to the downstream end.

In some embodiments, the housing 504 may have an inlet 505 and/or an outlet 507. In some such embodiments, the inlet 505 defines an upstream end of the filter and/or reactor 501 and the outlet 507 defines a downstream end of the filter and/or reactor 501. During use, a fluid flows from the upstream end of the filter/reactor 501 to the downstream end of the filter/reactor 501. The upstream end of the filter/501 is the upstream end 30 of the volumetric media. The downstream end of the filter/reactor 501 is the downstream end 40 of the volumetric media.

The inlet 505 may be operably coupled to a fuel cell reagent feedstock. The outlet 507 may be operably coupled to a fuel cell, for example, a reagent intake location of a fuel cell. The inlet 505 and/or outlet 507 may be configured such that the filter/reactor is in line with a continuous reaction apparatus.

The fluid path though the filter/reactor may not be parallel to the housing axis A and/or the volumetric media axis 10A. For example, when the inlet and outlet are offset from each other on one or more axis, the fluid may not follow a path the is parallel to the housing axis and/or volumetric media axis. The shortest distance between the inlet and the outlet defines a minimum fluid path length. In some embodiments, the minimum fluid pathlength is 1 cm or greater, 5 cm or greater, 10 cm or greater, 20 cm or greater, 30 cm or greater, 40 cm or greater, 50 cm or greater, or 75 cm or greater. In some embodiments, the minimum fluid pathlength is 5 m or less, 4 m or less, 3 m or less, 2 m or less, 1 m or less, 75 cm or less, 50 cm or less, 40 cm or less, 30 cm or less, 20 cm or less, 10 cm or less, or 5 cm or less.

### Methods of Using a Volumetric Media and Filters/Reactors Containing the Same

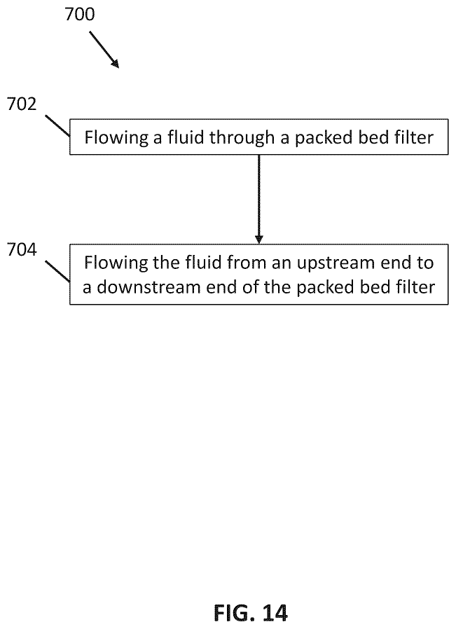

The disclosure provides a method of using volumetric media of the present disclosure and/or filters/reactors containing the same. As illustrated in FIG. 14, a method 700 of using a volumetric media and/or a filter/reactor containing the same, may include flowing a fluid (i.e., a gas, liquid, or both) through volumetric media (step 702). In some embodiments where the volumetric media is contained within a filter/reactor, the fluid may be directed through the volumetric media from an inlet to an outlet. The fluid may flow from an upstream end of the volumetric media or filter/reactor (step 704). The fluid may flow from an upstream end of a spacer array to a downstream end of the spacer array. The fluid may flow around the packing material. For example, the fluid may flow through the foam. The fluid may flow along a spacer. (e.g., the fluid may flow along the leading pin to the main body, around the main body, and towards the downstream end). The fluid may be, for example, a gas, such as air, oxygen, nitrogen, hydrogen, or the like, or a liquid. Depending on the packing material used, impurities present in the fluid may be adsorbed or absorbed by, or may chemically react with, the packing material. The impurities may be selectively removed from the fluid or may be changed to a different chemical form.

In embodiments where the volumetric media or filter/reactor containing the same is used in conjunction with a fuel cell, the method may further include flowing the fluid from the volumetric media or filter/reactor containing the same to a fuel cell. The fluid may exit the volumetric media or filter/reactor containing the same the outlet that is operably coupled to a fuel cell.

### Illustrative Embodiments

The technology described herein is defined in the claims. However, below is provided a non-exhaustive listing of non-limiting embodiments. Any one or more of the features of these embodiments may be combined with any one or more features of another example, embodiment, or aspect described herein.

Embodiment 1 is volumetric media having an upstream end and a downstream end. The volumetric media includes a spacer; and a packing material around the spacer. The packing material comprising a reticulated foam.

Embodiment 2 is a volumetric media having an upstream end and a downstream end. The volumetric media includes a spacer; and a packing material around the spacer. The packing material includes a foam and fine fibers disposed on at least a portion of the foam.

Embodiment 3 is the volumetric media of embodiment 1 or 2, wherein the fine fibers have an average diameter of 1 um or less.

Embodiment 4 is the volumetric media of embodiment 2 or 3, the fine fibers include a homopolymer, copolymer, or a blend of two or more polymers of aromatic polyamide, aliphatic polyamide, polypropylene, polyurethane, poly (ethylene terephthalate), polyvinyl pyrrolidone, styrene butadiene rubber, polysulfone, polyethersulfone, polymethylmethacrylate, polyacrylonitrile, polybenzimidazole, polytetrafluoroethylene, polyester, polyethylene oxide, polyacrylonitrile, polyvinylidene chloride, polyvinylidene fluoride, polystyrene, polyvinyl alcohol, or any combination thereof.

Embodiment 5 is the volumetric media any embodiment 1 to 4, wherein the reticulated foam includes a polymer-based reticulated foam, a carbon-based reticulated foam, a metal-based reticulated foam, a metal oxide-based reticulated foam, a metal carbide reticulated foam, or any combination thereof.

Embodiment 6 is the volumetric media of any embodiments 1 to 5, wherein the reticulated foam includes: polyester, reticulated polyether, reticulated polyurethane, reticulated polyurethane without heat treatment, reticulated cellulose, reticulated melamine, reticulated activated carbon, reticulated vitreous carbon, reticulated graphene, reticulated silicon oxide, reticulated silicon carbide, a reduced metal reticulated foam, or any combination thereof.

Embodiment 7 is the volumetric media of any embodiments 1 to 6, wherein the foam includes an adsorbent.

Embodiment 8 is the volumetric media of any embodiments 1 to 7, wherein the packing material further includes active particles and the active particles include an adsorbent, a catalyst, or both.

Embodiment 9 is the volumetric media of embodiment 8, wherein at least a portion of the reticulated foam is coated with the active particles.

Embodiment 10 is the volumetric media of any embodiments 8 to 9, wherein the adsorbent is a physisorbent, a chemisorbent, a physisorbent-chemisorbent hybrid, or any combination thereof.

Embodiment 11 is the volumetric media of any embodiments 8 to 10, wherein the adsorbent is capable of adsorbing a gaseous organic compound, a gaseous acidic compound, a gaseous basic compound, a gaseous inorganic compound, or any combination thereof.

Embodiment 12 is the volumetric media of embodiment 11, wherein the adsorbent is capable of adsorbing hydrogen sulfide, one or more nitrogen oxides, one or more sulfur oxides, ammonia, nitrogen trifluoride, carbon dioxide, carbon monoxide, siloxanes, water, perfluorocarbons such as tetrafluoromethane and hexafluoroethane, sulfur hexafluoride, nitrogen, oxygen, aromatic hydrocarbons such as benzene, toluene, and xylene, naphthalene, acenaphthylene, acenaphthene, fluorene, phenanthrene, anthracene, fluoranthene, pyrene, benz(a)anthracene, chrysene, benzo(b)fluoranthene, benzo(k)fluoranthene, benzo(a)fluoranthene, dibenz(a,h)anthracene, benzo(ghi)perylene, and indeno(1,2,3-cd)pyrene), n-alkanes such as methane, ethane, n-propane, n-butane, n-pentane, and n-hexane, n-alkenes such as methylene, ethylene, propylene; various alcohols, aldehydes such as formaldehyde, siloxanes, n-alkynes such as methyne, ethyne, n-propyne, n-butyne, n-pentyne, and n-hexyne, ketones such as acetone, or any combination thereof.

Embodiment 13 is the volumetric media of any of embodiments 10 to 12, wherein the adsorbent comprises carbon, a zeolite, a silicate, a metal organic framework, a porous organic framework, a porous organic cage, porous alumina, or any combination thereof.

Embodiment 14 is the volumetric media of any of embodiments 10 to 13, wherein the adsorbent includes a group 1 metal carbonate, a group I metal hydroxide, a group II metal oxide, or any combination thereof.

Embodiment 15 is the volumetric media of any of embodiments 10 to 14, wherein the adsorbent includes an amine, an imine, an ammonium salt, or any combination thereof.

Embodiment 16 is the volumetric media of any of embodiments 10 to 15, wherein the adsorbent includes a compound having a carboxylic acid group, an inorganic acid, or both.

Embodiment 17 is the volumetric media of embodiment 8, wherein the catalyst includes a silicate, a transition metal oxide, a reduced metal, a carbonate, a zeolite, or any combination thereof.

Embodiment 18 is the volumetric media of any of embodiment 8 to 17, wherein the average active particle size is 10 um or less.

Embodiment 19 is the volumetric media of any of embodiments 1 to 18, wherein the packing material further comprises a binder polymer.

Embodiment 20 is the volumetric media of embodiment 19, wherein at least a portion of the reticulated foam is coated with the binder polymer.

Embodiment 21 is the volumetric media of embodiments 19 or 20, wherein the binder polymer includes polyvinylpyrrolidone aromatic polyamide, aliphatic polyamide, polypropylene, polyurethane, poly (ethylene terephthalate), styrene butadiene rubber, polysulfone, polybenzimidazole, polytetrafluoroethylene, polyester, polyethylene oxide, polyvinylidene chloride, polyvinylidene fluoride, polystyrene, polyvinyl alcohol, polysiloxane, or any combination thereof.

Embodiment 22 is the volumetric media of any embodiments 1 to 21, wherein the reticulated foam includes 20 pores per inch or greater.

Embodiment 23 is the volumetric media of any embodiments 1 to 22, wherein the volumetric media has a volumetric media height and the volumetric media height is 5 cm or greater.

Embodiment 24 is the volumetric media of any embodiments 1 to 23, wherein the spacer includes an adsorbent, a catalyst, or both.

Embodiment 25 is the volumetric media of embodiment 24, wherein the adsorbent includes carbon.

Embodiment 26 is the volumetric media of any embodiments 1 to 25, further including an array of spacers comprising a plurality of spacers.

Embodiment 27 is the volumetric media of any embodiments 1 to 25, wherein the spacer or each spacer of a plurality of spacers defines a longitudinal axis and the includes a main body having a main body cross-sectional dimension; a leading pin extending from the main body and upstream of the main body, the leading pin having a leading pin cross-sectional dimension; and a trailing pin extending from the main body and downstream of the main body. The trailing pin having a trailing pin cross-sectional dimension. The main body cross-sectional dimension being greater than the leading pin cross-sectional dimension and the trailing pin cross-sectional dimension.

Embodiment 28 is the volumetric media of embodiment 27, wherein the plurality of spacers are arranged in at least one transverse plane, and wherein the at least one transverse plane is transverse relative to the longitudinal axes of the spacers in the transverse plane.

Embodiment 29 is the volumetric media of embodiment 27 or 28, wherein the plurality of spacers are arranged in at least one longitudinal plane, and wherein the at least one longitudinal plane is parallel to the longitudinal axes of the spacers in the longitudinal plane.

Embodiment 30 is the volumetric media of any of embodiments 27 to 29, wherein the spacer array includes 100 or fewer transverse planes where each transverse plane includes a plurality of spacers.

Embodiment 31 is the volumetric media of any of embodiments 27 to 30, wherein each of the plurality of spacers is operably coupled to at least one other of the plurality of spacers.

Embodiment 32 is the volumetric media of any of embodiments 27 to 31, wherein a fluid is configured to flow in a downstream direction along the plurality of spacers.

Embodiment 33 is the volumetric media of any of embodiments 27 to 32, wherein the leading pin and the trailing pin extend along the longitudinal axis.

Embodiment 34 is the volumetric media of any of embodiments 27 to 33, wherein the main body cross-sectional dimension, the leading pin cross-sectional dimension, and the trailing pin cross-sectional dimension are each measured perpendicular to the longitudinal axis.

Embodiment 35 is the volumetric media of any of embodiments 27 to 34, wherein each of the longitudinal axes of the plurality of spacers are parallel to one another.

Embodiment 36 is the volumetric media of any of embodiments 27 to 34, wherein the main body is substantially lentil-shaped.

Embodiment 37 is the volumetric media of any of embodiments 27 to 36, wherein an outer surface of each of the plurality of spacers comprises a curved surface.

Embodiment 38 is the volumetric media of any of embodiments 27 to 37, wherein an outer surface of each of the plurality of spacers is free of edges and vertices.

Embodiment 39 is the volumetric media of any of embodiments 27 to 38, wherein each of the plurality of spacers has a length measured along the longitudinal axis, and wherein the length is 2.5 cm or less, 2.0 cm or less, 1.5 cm or less, 1.25 cm or less, or 1 cm or less.

Embodiment 40 is the volumetric media of any of embodiments 27 to 39, wherein each of the leading pins has a length and each of the trailing pins has a length, and wherein the length of the leading pins is greater than the length of the trailing pins.

Embodiment 41 is the volumetric media of any of embodiments 27 to 40, wherein each of the leading pins has a length and each of the trailing pins has a length, and wherein a ratio of the length of the leading pins to the length of the trailing pins is greater than or equal to 1.25:1.00.

Embodiment 42 is the volumetric media of any of embodiments 27 to 41, wherein the plurality of spacers are arranged in a plurality of transverse planes, wherein each of the plurality of transverse planes is transverse relative to the longitudinal axes of the spacers in the transverse plane, and wherein any two adjacent transverse planes have a layer gap therebetween.

Embodiment 43 is the volumetric media of embodiment 42, wherein the layer gap is 0.5 cm or greater, 0.75 cm or greater, 1.0 cm or greater, 1.25 cm or greater, or 1.5 cm or greater, and 6 cm or less, 5 cm or less, 4.5 cm or less, 4 cm or less, 3.5 cm or less, or 3 cm or less.

Embodiment 44 is the volumetric media of any of embodiments 27 to 43, wherein each of the main body cross-sectional dimensions in one transverse plane partially overlaps with at least one of the main body cross-sectional dimensions in an adjacent transverse plane when viewed in a direction parallel to the longitudinal axis, and wherein such partial overlap includes less than or equal to 50% of the main body cross-sectional dimension in one transverse plane.

Embodiment 45 is the volumetric media of any of embodiments 27 to 44, wherein the spacers in a first transverse plane define a first plurality of longitudinal axis and the spacers in a second transverse plane define a second plurality of longitudinal axis, and wherein the second plurality of longitudinal axis are transversely offset from the first plurality of longitudinal axis.

Embodiment 46 is the volumetric media of any of embodiments 27 to 45, wherein the plurality of spacers define a tortuous flow path through the array.

Embodiment 47 is the volumetric media of any of embodiments 27 to 46, wherein the plurality of spacers form a ring disposed in a transverse plane.

Embodiment 48 is the volumetric media of any of embodiments 27 to 47, wherein the plurality of spacers form a plurality of concentric rings disposed in the transverse plane.

Embodiment 49 is the volumetric media of any of embodiments 27 to 47, wherein the plurality of spacers form a grid disposed in a transverse plane.

Embodiment 50 is the volumetric media of any of embodiments 27 to 49, wherein the spacer array further includes at least one connector, wherein each of the plurality of spacers is operably coupled to at least one other of the plurality of spacers via the at least one connector.

Embodiment 51 is the volumetric media of any of embodiments 27 to 50, wherein the spacers in a transverse plane are coupled to each other via one or more connectors.

Embodiment 52 is a filter having an upstream end and a down stream end, the filter including a housing an the volumetric media of any one of embodiments 1 to 51 disposed within the housing.

Embodiment 53 is a reactor having an upstream end and a down stream end, the filter including a housing an the volumetric media of any one of embodiments 1 to 51 disposed within the housing.

Embodiment 54 is the filter of embodiment 52 or the reactor of embodiment 53, wherein the housing further includes an inlet, and outlet, or both.

Embodiment 55 is a method for flowing a fluid through a volumetric media, the method including flowing a fluid from the upstream end to the downstream end of the volumetric media of any one of embodiments 1 to 51.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight. The following abbreviations may be used in the following examples: Mn=number average molecular weight; ppm=parts per million; ppb=parts per billion; mL=milliliter; L=liter; LPM=liters per minute; m=meter, mm=millimeter, min=minutes; s=seconds; cm=centimeter, um=micrometer, kg=kilogram, g=gram, min=minute, s=second, h=hour, ° C.=degrees Celsius, ° F.=degrees Fahrenheit; wt-%=weight percent; M=molar; and DI water=deionized water.

### Example 1: Spacer Configurations

The spacers may be configured in any suitable way and may include different spacer geometries, different spacer array geometries, one or multiple transverse planes, one or multiple longitudinal planes, etc. While many possible configurations and shapes may be used, the goal of lower resistance or restriction to fluid flow while also increasing flow rate and maintaining filter efficiency remains unchanged. Thus, the variables described herein may be modified, in order to reach the stated goal, and such modifications are considered to be described herein.

Various aspects of the spacers and their arrangement in an array or filter were simulated to study the effects of shape, size, and relative position of spacers.

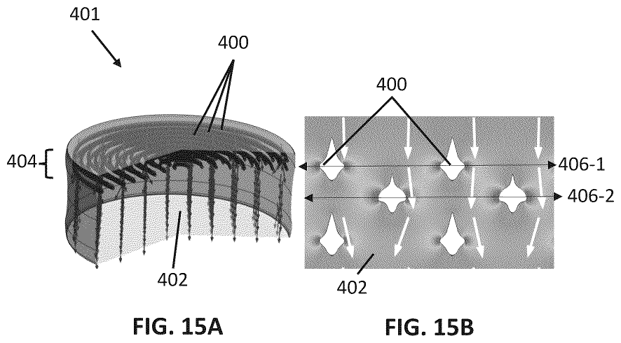

FIGS. 15A and 15B illustrate an example filter 401 and fluid velocity therethrough, which may include a filter material 402 and at least one spacer 400 making up a spacer array 404. Certain aspects of the spacers 400 and spacer array 404 may be similar to those discussed above with regard to spacers 100, 200 and spacer array 300. However, as illustrated in FIG. 15A, each of the plurality of spacers 400 may form a ring disposed in the at least one transverse plane 406 (e.g., 406-1, 406-2 as illustrated in FIG. 15B, the at least one transverse plane also as described herein using reference 302). In other words, the main body, the leading pin, and the trailing pin each form a ring. In some embodiments, the plurality of spacers 400 may each be disposed in the at least one transverse plane 406. In some embodiments, the plurality of spacers 400 may form concentric rings. The plurality of concentric rings may form a single layer in one transverse plane 406. Multiple layers, each formed by a plurality of concentric rings in different transverse planes 406, may be arranged in a stack. FIG. 15B illustrates the cross-sectional spacer shapes of various spacers 400.

FIG. 15A illustrates uniform flow with very little fluid flow fluctuation relative to horizontal position, if any. FIG. 15B illustrates the same in an enlarged view. Additionally, the “recirculation zones” noted in FIG. 15B are located at the axial ends of each cross-sectional spacer shape, and indicate higher velocity of fluid in those zones. Higher velocity is normally associated with less efficient filtration, as the fluid spends less time in contact with any filter material. In this case if the spacers themselves are constructed using filter material in addition to the present filter material, for example, a higher velocity may not be associated with less efficient filtration since the fluid will contact filter material even at a higher velocity.

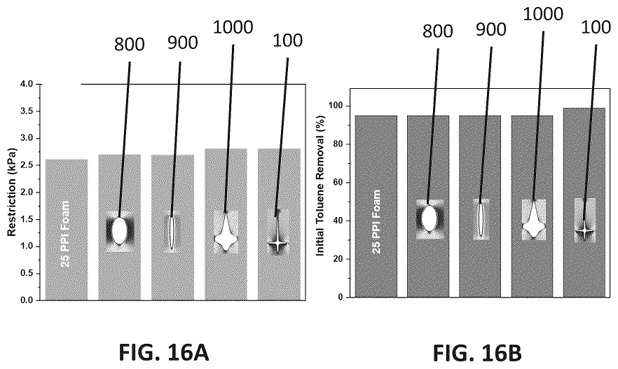

Various simulated cross-sectional spacer shapes are illustrated in FIG. 16A. The restriction of fluid flow (in kilopascals, kPa) resulting from the different spacer shapes is shown in the y-axis. All other simulation conditions remained constant for each different spacer shape (volumetric flowrate, air viscosity, air density, spacer height, foam porosity, number of spacer rows, spacer orientation, distance between spacers, filter pack diameter, inlet contaminant concentration, etc.). At the far left, a filter only including foam (25 pore per inch, PPI) without any spacers results in the lowest restriction. Moving from left to right, each consecutive cross-sectional spacer shape (e.g., ovular spacer 800, thin ovular spacer 900, bulging spacer 1000, and spacer 100) results in a higher restriction. Higher restriction is less desirable but may be offset by increasing the amount of surface area that fluid flow may contact within the foam and/or spacer, which increases filtration efficiency. FIG. 16B illustrates simulated initial toluene (an example contaminant) removal from air, and the same cross-sectional spacer shapes are shown in the x-axis of FIG. 16B. As illustrated, the spacer 100 results in the most efficient contaminant removal.

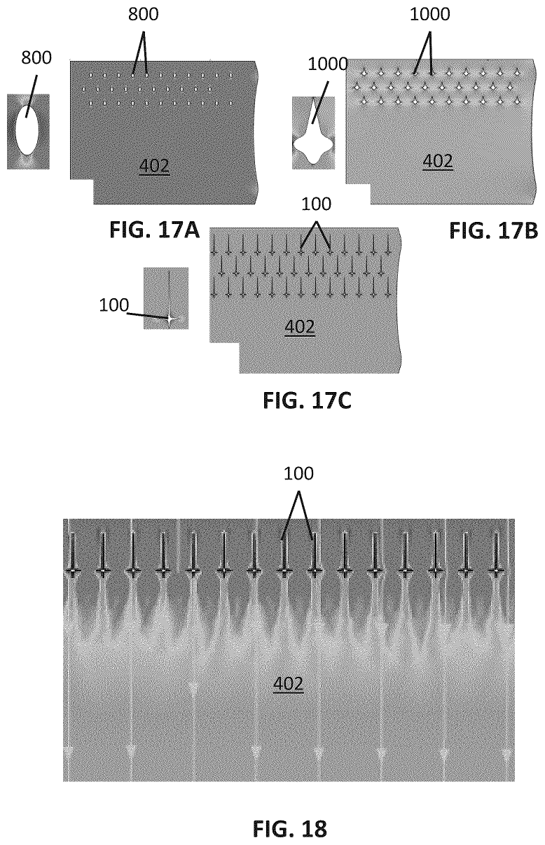

FIGS. 17A, 17B, and 17C illustrate simulated velocity fields of different cross-sectional spacer shapes. The simulations each contained three rows of spacers. It is understood that more or fewer rows could be used to optimize a filtration application, depending on a user's needs. FIG. 17A illustrates the ovular spacer 800 dispersed in the filter material 402. The velocity at the spacer face is about 8 meters per second. FIG. 17B illustrates the bulging spacer 900 dispersed in the filter material 402. The velocity at the spacer face is about 4 meters per second (m/s). FIG. 17C illustrates the spacer 100 as described herein (e.g., lentil-shaped with leading and trailing pins) dispersed in the filter material 402, and the velocity at the spacer face is about 2 m/s. Thus, the spacer 100 as described herein results in a lower velocity of fluid flow around the spacer. Lower velocity of fluid flow around the spacer lengthens the time the fluid is dispersed within the filter material 402 and along the spacer 100, likely resulting in more efficient filtration. Simultaneously, this increased efficiency only resulted in slightly higher restriction (kPa, FIG. 16A). The lentil-and-pin spacer shape thus was found to effectively mitigate about 60% of the residual contaminants which would have bypassed the ovular/other spacers or spacer-free foam.

FIG. 18 illustrates a simulated concentration profile of toluene (in moles of toluene per cubic meter of the adsorbent spacer-coated foam material) through a single layer of lentil-and-pin adsorbent spacers suspended in adsorbent-coated foam (a filter material). The darker areas indicate the presence of higher concentrations of toluene, and lighter areas indicate where zero toluene concentration is observed. Compared to a filter bed without any spacers, the filter bed with spacers simulated a faster filtration of toluene than the simulated filter bed without spacers (e.g., the toluene was simulated to be removed at a shallower depth when spacers were present, by about 0.5 cm shallower when all other variables were held constant). Further, the darker areas immediately below the spacers 100 indicates that there is a simulated flow throttle that occurs in between spacers 100. Such a flow throttle may advantageously convene contaminate particles for filtration of the same. In applications with dilute feedstocks (e.g., air filtration), having contaminant levels around 10-100 parts per billion, such a throttle may advantageously increase filtration efficiency as the dilute feedstock is convened.

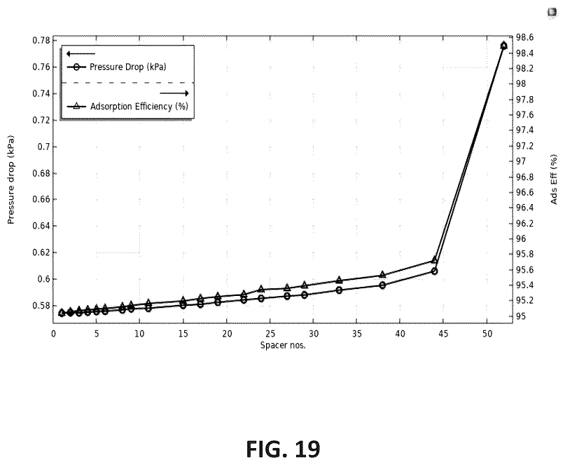

FIG. 19 illustrates simulated pressure drop and simulated adsorption efficiency on opposing y-axes, with number of spacers on the x-axis. As the number of spacers increases, so does pressure drop (e.g., resistance) and adsorption efficiency. However, increasing the number of spacers enhances the adsorption efficiency at a faster rate than the simulated pressure drop. For less efficient spacer designs (e.g., ovular spacers 800, bulging spacers 1000), the adsorption efficiency may not increase at a faster rate than the simulated pressure drop as spacer number increases.

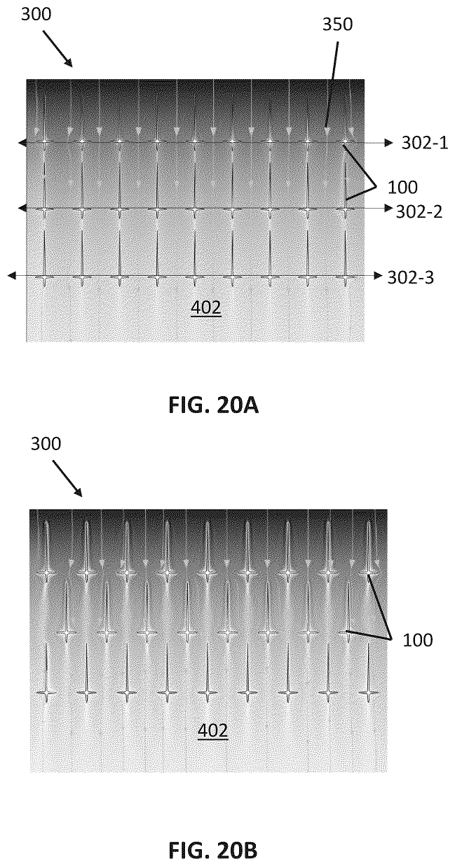

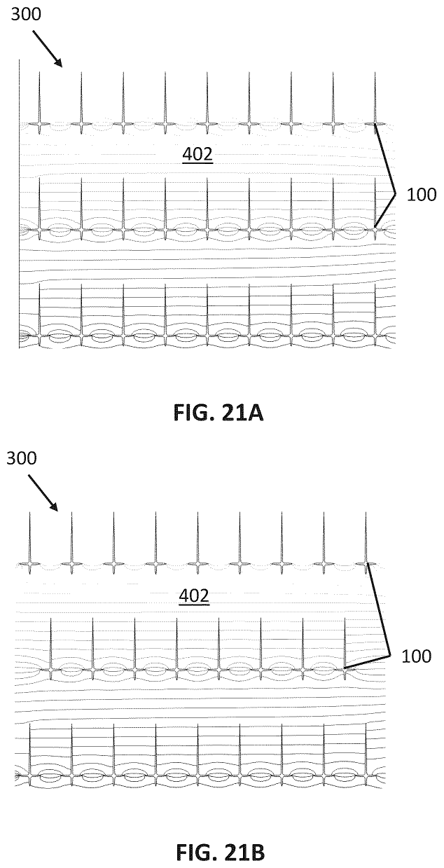

FIGS. 20A and 20B illustrate simulated concentration profiles using the lentil-and-pin spacers 100 as described herein. FIGS. 20A and 20B illustrate a spacer array 300 as described herein (unless otherwise noted), with three rows of spacers 100. Each row of spacers 100 is located in a separate transverse plane 302 (e.g., 302-1, 302-2, 302-3). The simulation included an approximately 10 cm long packed filter bed (as measured vertically in FIGS. 20A and 20B), and fluid flow was in a downstream direction indicated by the transparent arrows 350. All other simulation conditions remained constant as described with respect to FIGS. 16A and 16B (volumetric flowrate, air viscosity, air density, spacer height, foam porosity, number of spacer rows, spacer orientation, distance between spacers, filter pack diameter, inlet contaminant concentration, etc.). FIG. 20A illustrates a spacer array 300 with in-line spacer axes. That is, the spacers 100 are stacked so that a downstream spacer 100 is directly below an upstream spacer 100 along the same longitudinal axis. FIG. 20B illustrates offset spacer axes. As described above, and as illustrated in FIG. 20B, such offset/partial overlap may include up to 50% of the main body cross-sectional dimension in one transverse plane. As shown in FIG. 20A, about 20% of the contaminant level may remain at the end of the 10 cm long bed, whereas the contaminant may be removed within 7 cm of the length of the bed as shown in FIG. 20B. FIGS. 21A and 21B illustrate simulated pressure fields throughout the bed of FIGS. 20A and 20B, respectively. FIGS. 21A and 21B illustrate mixing zones around the edges of the spacers 400, and pressure losses were about constant in either configuration. Constant pressure loss indicates a more efficient spacer shape.

### Example 2: Assessment of Packed Bed Filter With Foam Packing Material

The present Example explores the use of various foam and spacer geometries for use in packed bed filters. Various experiments are present as sub-examples (e.g., Example 2A, 2B, and so on).

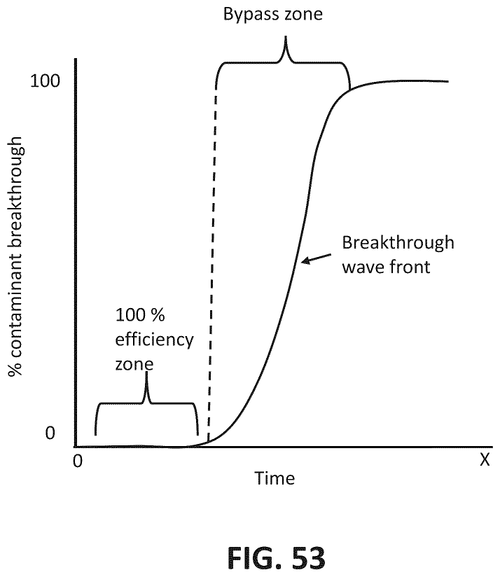

The performance of a filter over time may be understood by plotting the percent contaminant breakthrough as a function of filter life (time). Such a plot shows the 100% efficiency zone (or lack thereof), the bypass zone, and the contaminant breakthrough wavefront (see, for example, FIG. 53). Percent contaminant breakthrough is the amount of contaminant that exits (breaks through) the filter at any given time in the lifetime of the filter. The 100% efficiency zone is the period of time in the lifetime of the filter when no contaminant breakthrough is observed. When a steady state of containment breakthrough is reached, all contaminates are breaking through the filter. The bypass zone is the period of time in the lifetime of a filter where the filter is between the 100% efficiency zone and a steady state of contaminant breakthrough. The breakthrough wavefront is the percent contamination that bypasses the filter at any given time during the lifetime of the filter. The shape of the breakthrough wavefront impacts the bypass zone. For example, a sharper breakthrough wavefront indicates a shorter bypass zone.

Adsorption mass transfer can be simplified as a sum of convective and diffusive forces as shown in Equation 1 where kₒᵥₑᵣₐₗₗ is the transference rate constant and kᵢ is the rate constant of force i.

$$\frac{1}{{k}_{overall}} = {\sum }_{i}^{∞} \frac{1}{{k}_{i}} \qquad Equation 1$$

These forces ultimately differ across materials and macroscopic geometries, so they cannot be simplified to a handful of equations. However, the effects of the overall mass transfer rate can be generalized with regard to adsorptive removal efficiency, in that heightened rate coefficients lead to sharper contaminant breakthrough wavefronts. Such sharpening i) lengthens the 100% efficiency zone (the time at which full contaminant removal is achieved) and ii) shortens the bypass zone (the time at which some fraction of contaminant circumvents the adsorbent material and exits the filter).

A filter may be used after entering the bypass zone; however, this may be inadvisable for fuel cell air intake systems because even small contaminant quantities may irreversibly corrode the cathode metal of the fuel cell. These damages can be explained by the cathode chemistry. Fuel cell cathodes are generally made of metallic nickel-phosphorus (Ni⁰-P) which has been reduced from nickel (II) (Ni²⁺) ore at high temperature (˜650° C.). The zero-nickel state is readily oxidized by acidic (sulfur oxides, nitrogen oxides, hydrogen sulfide) or basic (ammonia) contaminants to form nickel (II) salts (for example nickel sulfate (NiSO₄) and nickel nitrate (Ni(NO₃)₂) which are incapable of O²-splitting. Literature indicates that such performance losses are irreversible, even after re-reduction of the metal constituent. For example, it has been reported that complete Ni⁰-P fuel cell stack failure (i.e., 100% loss in current density) occurs after 2 ppm hydrogen sulfide (70° C., 0.1 L/min) exposure for only 14 hours (Sethuraman, V. A.; Weidner, J. W. Analysis of Sulfur Poisoning on a PEM Fuel Cell Electrode. Electrochim Acta 2010, 55 (20), 5683-5694. doi.org/10.1016/j.electacta.2010.05.004). Attempts to re-reduce the Ni² into Ni⁰ did reform the metal; however, its particle structure remained deformed. Resultantly, the regenerated cathode failed after exposure to hydrogen sulfide from one hour, whereas a third regeneration led to immediate failure.

Lengthening the 100% efficiency zone, and by extension maximizing the overall rate of mass transfer, may be aided by understanding the convective and diffusive forces in the summation of Equation 1. Such an approach is mathematically complex to describe and cannot be narrowed to singular equations, as defining characteristics differ across i) macroscopic geometries of the adsorbent, ii) contaminant concentration level, and iii) wall porosity/adsorbent structure. Nevertheless, these driving mechanisms, although variable, can be qualitatively generalized as a sum of forces, primarily being reported by the three rate-limiting steps in Equation 2 where kₒᵥₑᵣₐₗₗ is the overall rate constant, k_{f} is film rate, k_{Knudsen} is the Knudsen diffusion constant, and kₚ is molecular diffusion rate constant.

$$\frac{1}{{k}_{overall}} = \frac{1}{{k}_{f}} + \frac{1}{{k}_{Knudsen}} + \frac{1}{{k}_{p}} \qquad Equation 2$$

These forces can be thought of as a two-step mechanism, with the first two terms occurring in the initial step and the third term occurring thereafter. In this way, the overall rate of transference can be somewhat considered a piecewise mechanism. It should be noted here that all three steps are considered as occurring in-tandem since the transition from step one towards step two occurs almost instantaneously, but the mechanism can qualitatively be considered as Equation 3 for the sake of understanding.

$$\frac{1}{{k}_{overall}} = {( \frac{1}{{k}_{f}} + \frac{1}{{k}_{Knudsen}} )}_{1} + {( \frac{1}{{k}_{p}} )}_{2} \qquad Equation 3$$

The first driving step, whereby the contaminants migrate from the fluid stream towards the adsorbing surface, is largely contingent on the macroscopic geometry and orientation of the adsorbent form factor. The first factor (k_{f}) is well-understood, in that increasing the adsorbent surface area enhances active site accessibility relative to the fluid throughput, so overall mass transfer rates may be simply increased by heightening the geometric surface area of the adsorbent. The second factor (k_{Knudsen}) is less thoroughly understood. The driving equations which dictate the interplay between geometric orientation of the adsorbent and adsorption transference are derived from momentum and energy balances, which differ across adsorbent geometric structures and contaminant dilution levels. However, they may be qualitatively generalized based on three primary flow behaviors regarding adsorbent face orientation relative to the direction of fluid velocity: i) flow-by; ii) flow-through; and iii) flow-around solutions.

Common geometries of adsorbent filters are configured such that a fluid flows by the adsorbent (flow-by filter) or flows through the adsorbent (flow-through filter). In configurations where the fluid flows by the adsorbent, the adsorbent face is oriented in parallel with the direction of fluid flow. In configurations where the fluid through the adsorbent, the adsorbent face is oriented perpendicular to the fluid flow. Generally, without optimization, flow-by filters may have suitable restriction (pressure drop) but may not have a high enough contaminant removal efficiency and flow-through filters may have a suitable contaminant removal efficiency but may have too high of restriction.

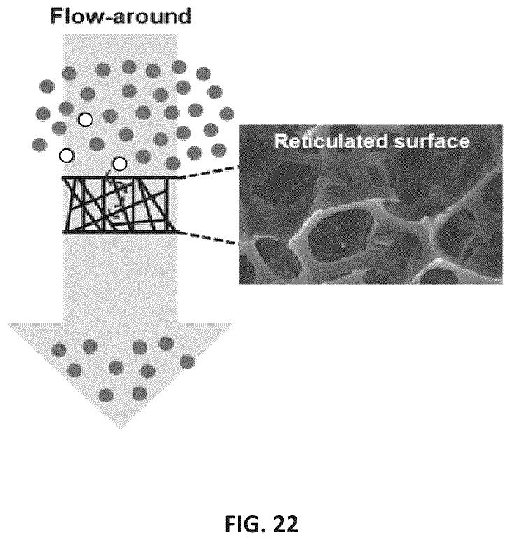

This example explores a flow-around filter that combines at least some of the characteristics of a flow-by filter and a flow-through filter. FIG. 22 is a schematic illustrating a flow-around filter where the adsorbent substrate is a reticulated foam. Reticulated foams have surfaces that are in parallel with the fluid flow, surfaces that are perpendicular to the fluid flow, and surfaces that are in between being parallel and perpendicular to fluid flow. For example, the ligaments (surfaces such as the major surfaces and pore surfaces) of the reticulated foam promote radially mixing around the surface while the foam porosity ensures that restriction is low along the fluid flow-path (FIG. 22). This configuration hybridizes the forced contact of the fluid with the adsorbent of flow-through solutions with the lessened restriction of flow-by solutions. These properties may lengthen the 100% efficiency zones of contaminant breakthrough.

### Example 2A

In Example 2A, a coated reticulated foam was tested for its ability to filter a contaminant.

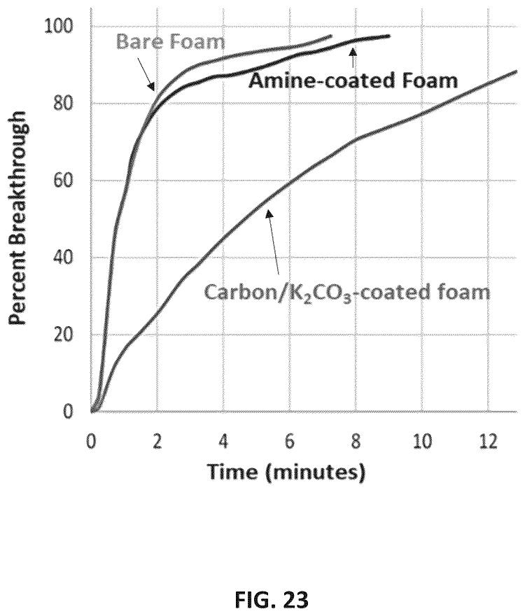

A reticulated vitreous carbon foam with 25 pores per inch was spray coated with polyethyleneamine and cross-linked or carbon/potassium carbonate active particles and bentonite clay. The foams were exposed to 100 ppm sulfur dioxide at a flow rate of 8 m³/min. Both coated foams showed immediate bypass (increase in % breakthrough of sulfur dioxide; FIG. 23). The observed bypass was less than a flow-by filter tested (data not shown). The results imply that adsorption transference on coated foams may be more limited by the second transference step from Equation 3, as the foam surface area, orientation, and porosity are generally considered ample to overcome film- and Knudsen-rate limitations. However, it is likely that the foams were incapable of retaining sufficient quantities of adsorbent material to match the life (time) expectancy of flow-by geometries.

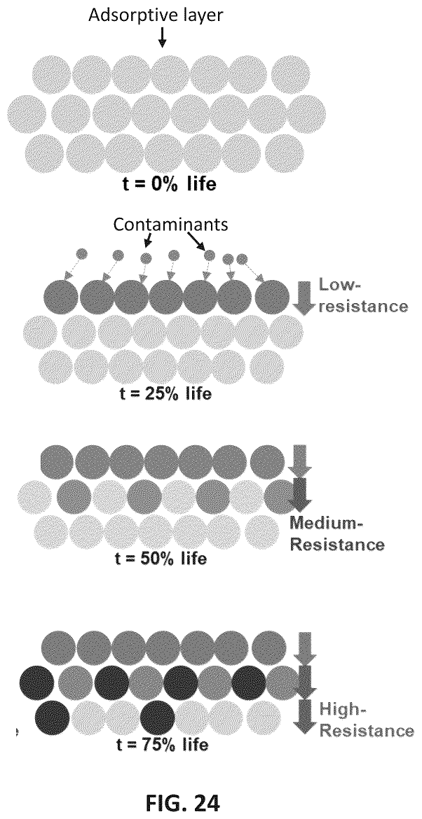

The secondary step (molecular diffusion (kₚ)) relates to the resistances incurred once the contaminant permeates the adsorbent layer. As shown in FIG. 24, such resistances relate to the accessibility of the individual active sites within the adsorbent pores as well as the porosity between individual adsorbent particles. Often, these forces are discounted when considering rates of adsorption as they incur too many degrees of freedom to accurately predict by modeling, hence they must be back calculated from breakthrough data. Nonetheless, they are present and generally impact the length of the 100% efficiency zone. Specifically, molecular diffusion initially occurs instantly, however, subsequent contaminant loading throughout the pack life must occur deeper to reach unspent active sites, thereby exponentially compounding the resistances to diffusion (FIG. 24). Thus, if the adsorbent layer is too thick or lacks porosity, molecular diffusion is slow.

Foam geometries can display fluid uniformity throughout their reticulated structure. For example, reticulated foams, even those which are imperfect, can generate exceptional macroscopic uniformity with regards to their velocity field (Rambabu, S.; Kartik Sriram, K.; Chamarthy, S.; Parthasarathy, P.; Ratna Kishore, V. A Proposal for a Correlation to Calculate Pressure Drop in Reticulated Porous Media with the Help of Numerical Investigation of Pressure Drop in Ideal & Randomized Reticulated Structures. Chem Eng Sci 2021, 237. doi.org/10.1016/j.ces.2021.116518). Should only the first step of adsorptive transport be relevant, one would then reasonably anticipate exceptionally sharp breakthrough fronts with minimal bypass would be presented by adsorbent coated foams. However, such behavior was clearly not observed in FIG. 23, where the ceramic/adsorbent-coated foam showed immediate transition into the bypass zone. It is expected that the adsorption rate of transference was likely limited by the molecular diffusion step. The microscopic velocity field for reticulated foams likely includes both hot zones as well as cold zones of transport. As such, some fraction of contaminant may immediately bypass the adsorbent by flowing through the cold zones. This behavior is precisely what was observed in FIG. 23 where some fraction of sulfur dioxide immediately circumvented the foam structure.

Addressing the bypass may be done by i) increasing the foam pores per inch, ii) increasing the pack length, and/or iii) increasing the cross-sectional diameter. However, the first approach may be challenging due to restriction targets and approaches two and three may be challenging due to packed bed filter size specifications. Another approach is to leverage the foam into a different form factor which decouples pressure drop and filtration efficiency.

### Example 2B

Packed beds having spacers arranged in a z-configuration were explored for their ability filter contaminants.

From Example 2A, the foam body displayed the desired surface area and macroscopic uniformity to overcome the first step of adsorption transport but was ultimately rate-limited by its cold-zones of fluid velocity within the ligament structure. Obstructions in the form of spacers were introduced to increase fluid/foam surface contact and mean path length.

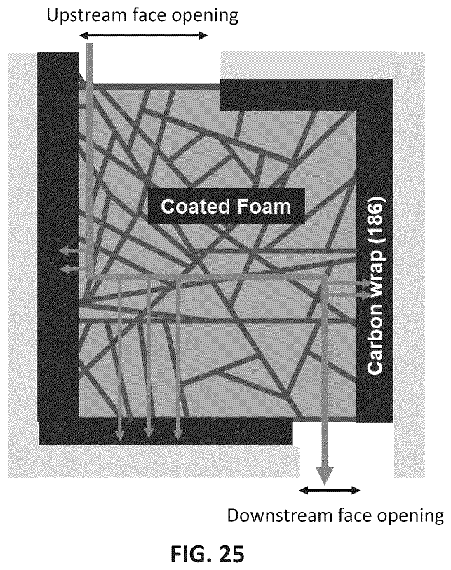

Initially, the spacer/obstruction concept was demonstrated in a z-configuration. In the z-configuration, a 25 PPI polyurethane coated foam (coconut shell activated carbon, 10 g potassium carbonate, PTFE and emulsified PTFE; coating was accomplished according to the methods described in PCT Application No. PCT/US23/82162) was disposed between two carbon wrapped L-shaped spacers (FIG. 25). The two L-shaped spacers were arranged such that a portion of each L-shaped spacer was parallel with the upstream side of the packed bed. The other portion of each L-shaped spacer was arranged perpendicular to the upstream side of the packed bed. The perpendicular portions of the L-shaped spacers partially blocked the fluid flow from the upstream end of the filter to the downstream end of the filter. The distance between the parallel portion of one spacer and the perpendicular portion of the other spacer on the upstream end of the z-configuration defined an upstream entrance. The distance between the parallel portion of one spacer and the perpendicular portion of the other spacer on the downstream end of the z-configuration defined a downstream exit. It was thought that the z-configuration would force adsorption to occur at the 90° turns of the L-shaped spacers, with contaminant capture also occurring within the coated foam.

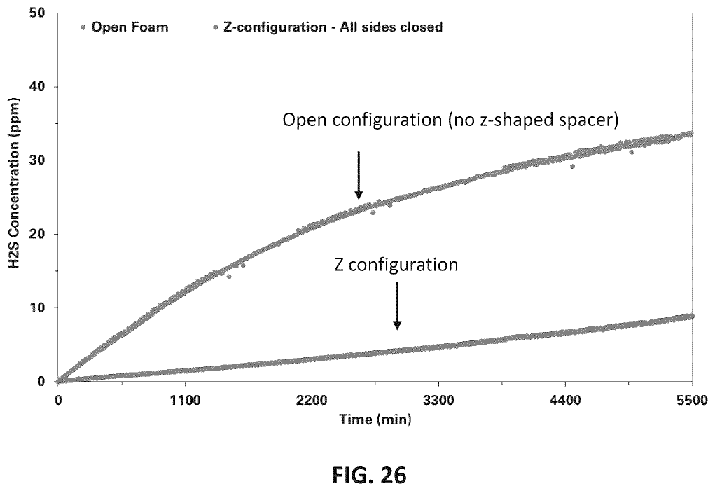

The z-configuration was tested for breakthrough by exposing the packed bed to 50 ppm of hydrogen sulfide at a 30 mL/min flow rate. The z-configuration displayed a significantly reduced slope compared to the coated foam without the carbon spacer elements (FIG. 26). While this modification did not generate 100% efficiency, likely due to the crude small-scale element and its poor ability to be laminated, it still served as a promising proof-of-concept. Specifically, the result shown in FIG. 26 indicated that foam bodies of smaller height can be used to generate exceptional adsorption efficiency by way of introducing an obstructive spacer, especially if the spacer includes an adsorbent material.

Packed beds (inner diameter (ID)=27 cm, bed height=5 cm) were assembled with 3D-printed L-shaped spacers arranged the z-configuration with a 40% upstream face opening (40% of the total possible bed volume (573 cm²) was removed for the spacers; bed volume was 229 cm²) and filled with polyurethane foams of varying porosity (25, 40, and 80 PPI). These packs with different foam porosities underwent restriction analysis, where even the most open foam (i.e., 25 PPI) was destroyed at the lowest flowrate used (3 m³/min). These results indicated that spacers arranged in the z-configuration may have too much restriction.

### Example 2C

Packed beds having o-ring shaped were explored for their ability filter contaminants.

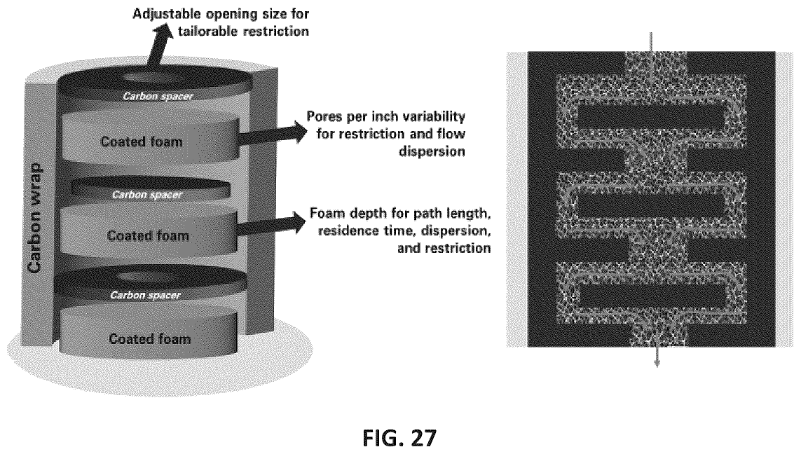

Packed bed filters having alternating foam and flat o-ring shaped spacers were explored (FIG. 27). An o-ring spacer included an outer diameter and an inner diameter. The inner diameter defined a face opening where fluid may pass through the spacer. The greater the difference in the outer diameter and the inner diameter, the small the face opening. Unlike the z-configuration, the flat o-ring spacer design was expected to more gently and uniformly divert the fluid flow. It was expected that the flat o-ring spacers would allow equivalent change in fluid direction across the radial surface of the spacer.

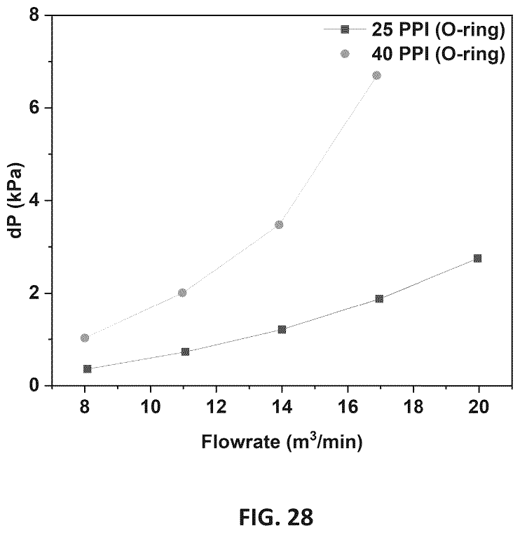

Packed bed filters (ID=27, packed bed height=5 cm) were assembled with single 3D printed o-ring spacer having a 40% face opening (40% of the total possible bed volume (573 cm²) was removed for the spacers; bed volume was 229 cm²) and packed with 25-80 PPI polyurethane foams without any coating. The restriction profiles of the packed bed filters were assessed. The restrictions of the packed bed containing the 25 PPI foam configuration were tested from 8-20 m³/min and the restrictions for the packed bed containing the 40 PPI foam were tested from 8-17 m³/min. The restriction for the packed bed containing the 80 PPI foam configuration could not be determined as the foam was ripped apart at the lowest flowrate. Of these, the packed bed with the 40 PPI foam gave rise to a restriction profile more consistent with a pellet-packed bed configuration (data not shown) and the packed bed with the 25 PPI foam showed a restriction growth with more linearity (FIG. 28). The exponential growth of the former indicated that the higher PPI value generates more obstruction; however, the impact of the housing was not considered.

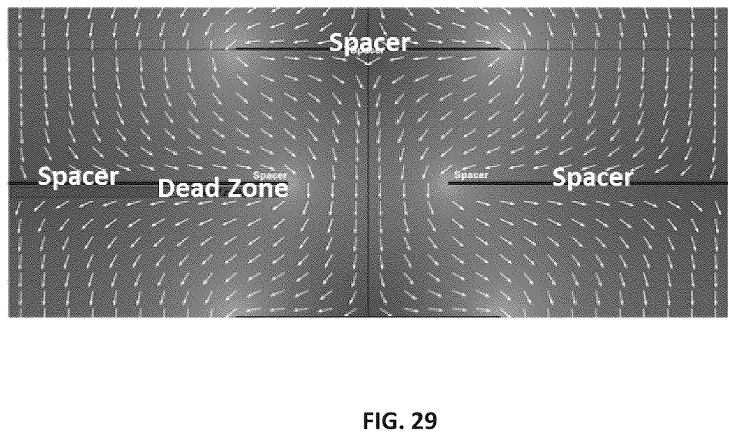

Next, a computational fluid dynamic (CFD) simulation was run to determine the impact of the o-ring spacer diameter on the velocity field. Specifically, a packed bed filter (ID=27, packed bed height=5 cm) assembled with an o-ring spacer having a face opening of 40% (40% of the total possible bed volume (573 cm²) was removed for the spacers; bed volume was 229 cm²) and packed with a 40 PPI foam was simulated at 11 m³/min velocity. As shown in FIG. 29, the simulated spacer elements are predicted to deflect the fluid flow as intended; however, dead zones are formed beneath the spacer surface. These dead zones are areas that will experience near zero fluid flow and may be unavoidable if the spacer elements are impermeable. It may be desirable for the spacer elements to be impermeable to redirect the flow velocity vector, so these dead zones may not be easily addressed by substituting an impermeable material with a permeable material. In this regard, the inclusion of an o-ring spacer, although improving in uniformity compared to a bare foam, may exhibit premature contaminant bypass. It is thought that fluid flow is most favorable along the center of the velocity field, which was unblocked at the pack inlet, thus causing less flow to run along the pack radial edges. The adsorbent media may be expected to saturate in the areas which undergo the greatest flow. A such, low-flow zones may adsorb at a slower rate than the centerline of the velocity field. Therefore premature contaminant breakthrough is expected due to inequivalent throughput of air across the entirety of the pack volume.

### Example 2D

The spacers of Example 2B and Example 2C were flat. In this example, packed beds having a 3D double ellipsoid geometry were explored.

Spacers having 3D configurations were explored after examining the velocity field shown in FIG. 29 of the flat o-ring shaped spacers. It was thought that increasing the spacer thickness and appropriately tapering its edges may enable better fluid aerodynamics in and around the spacer surface. Furthermore, this approach might be expected to yield lower pressure drop, given that the energetic losses for a bend are less than those of an abrupt 90° turn.

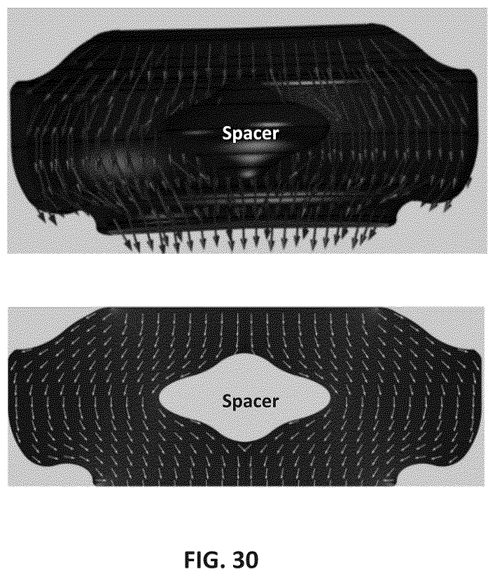

The double ellipsoid 3D spacer geometry was developed (FIG. 30) and tested. The predicted restriction for this spacer geometry was virtually zero, whereas that of the o-ring configuration (Example 2C) was 28 kPa. While the actual measured restriction for the o-ring geometry was far lower than that of the model, the magnitude of difference between the spacer geometries can be taken to mean that the double ellipsoid shows lower anticipated pressure loss. The double ellipsoid spacer configuration does not have a restriction less than zero, but it can be concluded as significantly less restrictive than the o-ring spacer design. The double ellipsoid geometry was also shown to exhibit exceptional fluid uniformity around its surface showing little to no dead zones.

### Example 2E

Packed beds having an array of teardrop shaped 3D spacers of were explored.

The geometry of the double ellipsoid spacer was quite large. As such, the carbon deep in the spacer structure may be inaccessible by molecular diffusion. Additionally, aerodynamic uniformity was only present around the spacer shape itself. Contaminant bypass issues may still occur.

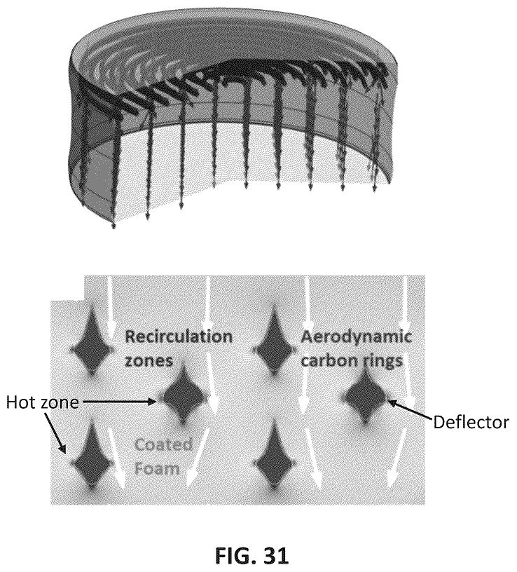

In this example, the shape of the 3D spacer was a teardrop shape (FIG. 31). It was thought that this shape could allow the spacer to slice through the air better than the double ellipsoid spacer of Example 2C. Packed beds having an array of the teardrop spacers were assembled. The spacing of the spacers may be varied to achieve the desired restriction and the spacer size can be varied to maximize adsorbent loading within the spacer at a given restriction level. CFD simulations of a packed bed (ID=27.2 cm, and pack height=5 cm) having a 25 PPI foam and the array of the teardrop shaped spacers was conducted with a flow velocity of 11 m³/min. The results as shown in FIG. 31, indicated that flow around the spacers is exceptionally uniform both i) across the pack cross-section (FIG. 31 top) as well as ii) within the individual microchannels (FIG. 31 bottom). Additionally, it is noted that the miniaturized spacers are shown to generate microscopic hot zones of velocity across their deflectors. With these spacers being made of an adsorbent material and the surrounding area including an adsorbent coated foam it is expected that these zones may overcome limitations of bypass within the foam body while also encouraging molecular diffusion to occur on the spacer surface.

### Example 2F

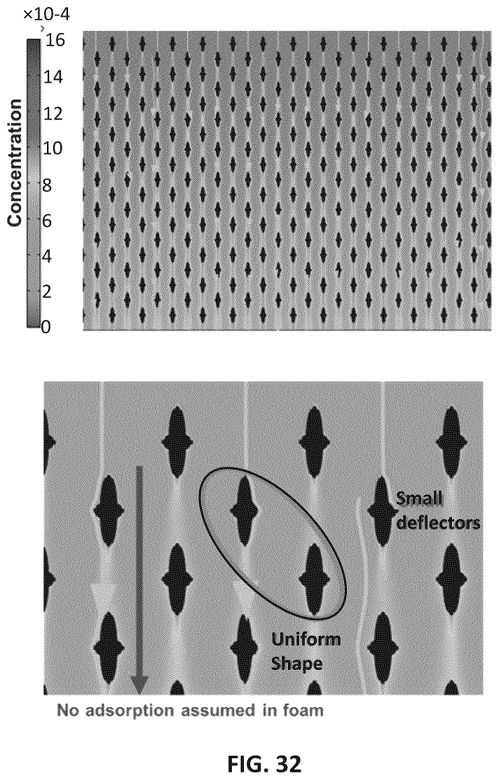

A CFD simulation of toluene removal from a fluid containing 100 ppm toluene by a packed bed (ID=27.2 cm, bed height=5 cm) assembled with an array of the double ellipsoid shaped spacer of Example 2D and packed with 25 PPI foam was conducted with a flow velocity of 11 m³/min. For the simulation, the foam was assumed to have zero adsorption. The macroscopic flow indicates the pack bed displayed exceptional uniformity of the predicted concentration profile with lower concentrations being present underneath the spacer elements (FIG. 32 top). At first glance, it could be argued that such reduced concentrations under the spacers indicate poor uniformity; however, it should be noted that this simulation did not consider recirculation from the interspacing foam component. When considering that the foam ligaments promote rotational mixing, one would anticipate the concentration profile to further conform in the parallel direction. In this context, the proposed configuration in FIG. 32 macroscopically satisfies the criteria for rapid step one transport phenomena. Specifically, the adsorbent has a high surface area due to the spacer design and foam as well as is oriented in the perpendicular direction to flow. It should be emphasized that the spacer distancing coupled with the high foam permeability enable such benefits without incurring significant restriction.

This preliminary simulation macroscopically suggests that a bed height of 5 cm bed can achieve 60% of contaminant removal. Such a removal efficiency is promising when the microscopic flow behavior and the various limitations of the simulation are considered. The reason being that, as previously noted, the simulation assumed zero influence from the foam material either for mixing or for adsorption. With the foam containing a thin layer of adsorbent, making it an active surface which is not rate-limited by molecular diffusion and incurring benefits of rotational mixing, the actual removal efficiency for a single pack packed bed is anticipated to increase far beyond 60%. It should further be noted that this model only tested uniform spacer shapes with small deflectors (double ellipsoid geometry), which differed from the teardrop geometry of FIG. 31. The double ellipsoid geometry deflector sizes and orientations were engineered to enhance path length along the spacer surface, hence their simplification will reduce anticipated removal efficiency. Yet, the predicted model still anticipated 60% removal efficiency across a short packed bed height. Extending the packed bed height and/or minimum fluid path length may allow for greater contaminant removal efficiency with sharp breakthrough fronts.

### Example 3: Assessment of foams with fine fiber networks

The present Example explores foams coated with electrospun fine fibers. Various experiments are present as sub-examples (e.g., Example 3A, 3B, and so on).

### Example 3A

Example 3A explores electrospinning of fine fibers from an electrospinning mixture that includes various amounts of electrospinning polymer onto various foams.

In Example 3A, fine fibers were electrospun using a single needle pendant drop apparatus using various polymer concentrations onto polyurethane foams of different pores per inch (PPI) values. Uncoated polyurethane foams (US Plastics, Lima, OH) with 25 PPI (0.5 in (1.27 cm) thick), 60 PPI 0.25 in (0.635 cm) thick), and 80 PPI (0.5 in (1.27 cm) thick) PPI were leveraged as spinning substrates for an initial effort. The spinning time was varied between 1 and 4 minutes and the polymer, a 6,66,136 polyamide co-polymer (BASF SE, Ludwigshafen, Germany), concentration was varied between 10 wt-% (1×), 15 wt-% (1.5×), and 20 wt-% (2×) in ethanol. The permeability of the foams was tested before and after fine fiber deposition. The fiber/foam hybrids were characterized via scanning electron microscopy (SEM) to assess fiber thickness and configuration.

As shown in FIGS. 33A, 33B, 34A, 34B, 35A, and 35B, the 25 PPI foam was not successfully coated under any condition. Even at the locations where fibers were observed, the fibers were not taught; instead the fibers were tangled structures without any discernable porosity. Without wishing to be bound by theory, the inability to coat the low porosity foam is believed to be caused by the airgaps in the large pores and low solidity. The surface was too open to generate charge to draw the fibers and, also, did not have sufficient geometric area to provide sites which could trap any fibers which may have inadvertently touched the surface.

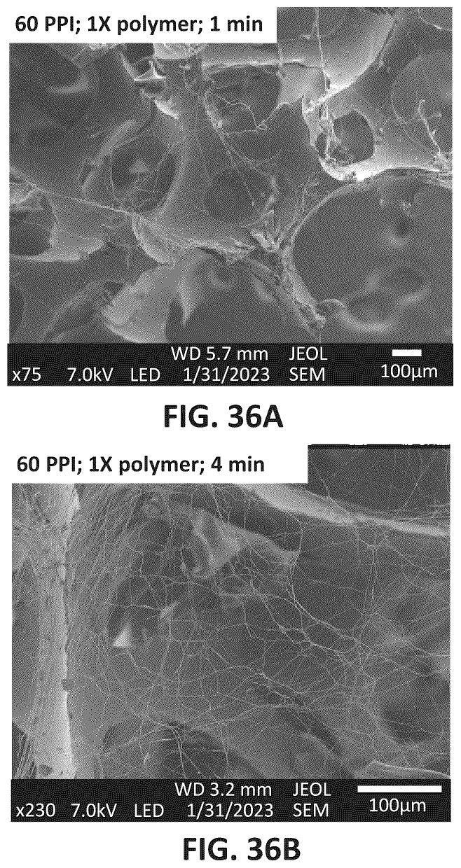

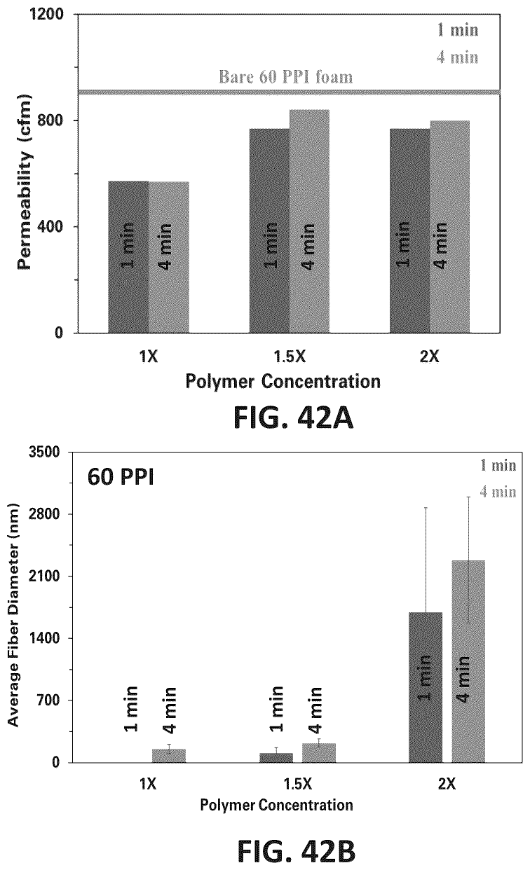

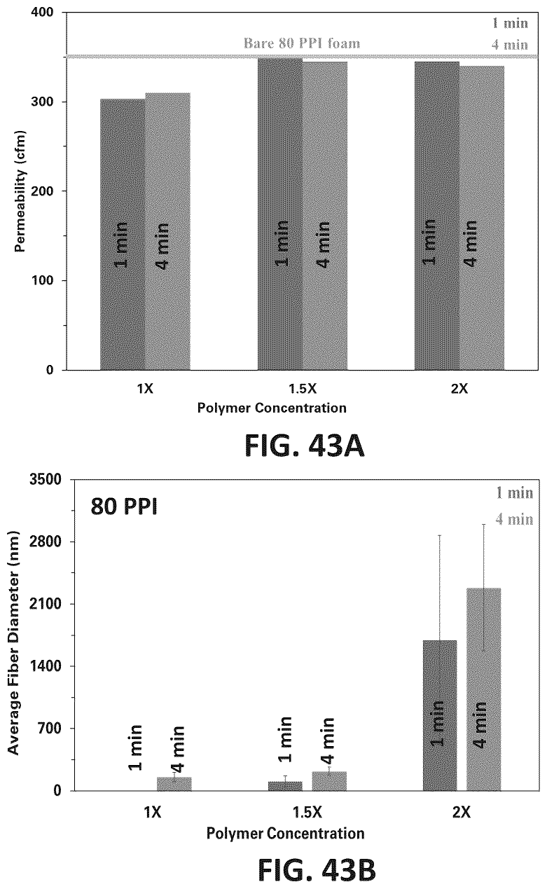

Fine fibers were successfully electrospun on the 60 PPI and 90 PPI foams (FIGS. 36A, 36B, 37A, 37B, 38A, 38B, 39A, 39B, 40A, 40B, 41A, and 41B). It was noted that the fiber diameter observed in the 60 PPI foams was consistently 75% less than that observed in the 80 PPI foams, which was attributed to the lower thickness of the former (FIGS. 42B and FIG. 43B). Without wishing to be bound by theory, electrostatic charging is a function of the material resistivity, meaning that a thicker high resistivity material with similar solid infill would be less charged, thus decreasing the electric field strength and limiting the ability for fibers to stretch produces larger fiber diameters. The 60 PPI material had nanofibers which had smaller cross-sections. However, the diameter may be modified by varying the polymer concentration, with the fiber diameter thickening at higher concentrations (FIG. 42B and FIG. 43B). Differences in fine fiber networking was observed for different spinning times. For the 60 PPI foams (FIGS. 36A-38B), there was a clear difference between the 1 minute and 4 minute spinning times, with the latter having a much denser layer of fibers.

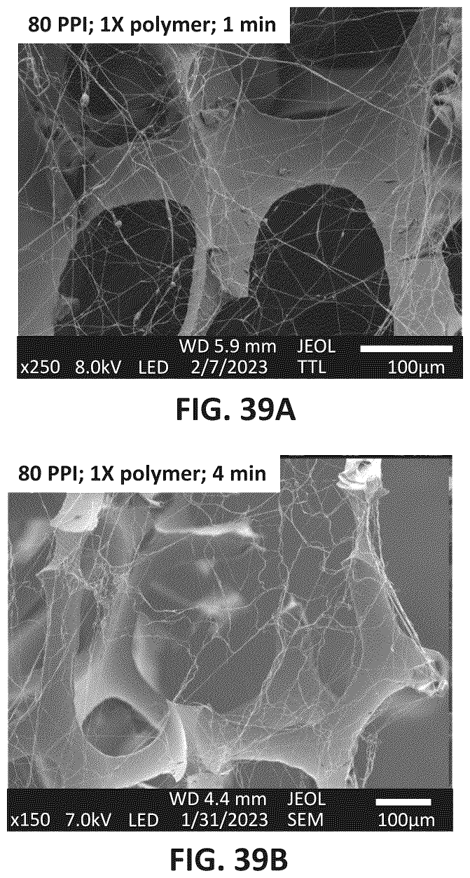

Regarding the 80 PPI foams (FIGS. 39A-41B), it was observed that all spinning conditions yielded fiber deposition on the surface, indicating that all three polymer concentrations may be applicable for spinning on higher PPI foams. It was noted that the 80 PPI foams had lower fiber density compared to the 60 PPI foams. This may have been caused by sample bias or by differences in charging during spinning. In any case, such differences implied that the spinning conditions may be varied to achieve different densities.

The porosity of the fine fiber coated foams were determined (FIG. 42A and FIG. 43A). Regarding the permeability of the 80 PPI foams relative to their uncoated analogue (horizontal line on FIG. 43A), they were found to retain their low pressure drop in the 1.5× and 2.0× samples, but permeability decreased by ˜10% in the 1× sample. It is difficult to determine with certainty why these differences arose at the current state, but they could have possibly been caused by sampling bias, differences in surface charging, or some other unknown factor. Whatever the case may be, it should be emphasized that the most significant reduction in permeability for the 80 PPI foams (i.e., 1× concentration) was quite low.

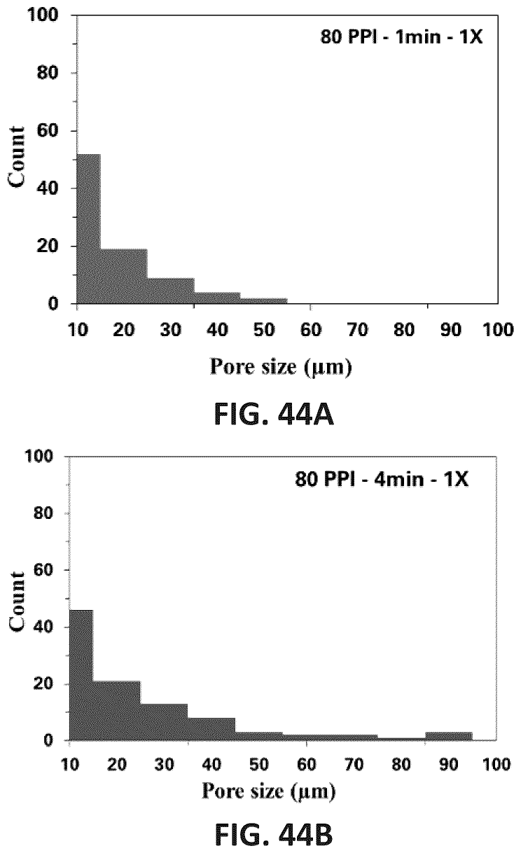

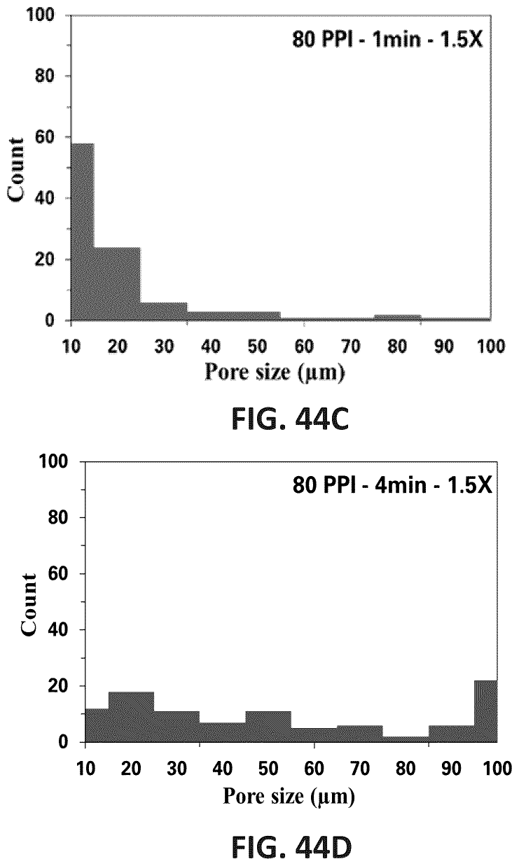

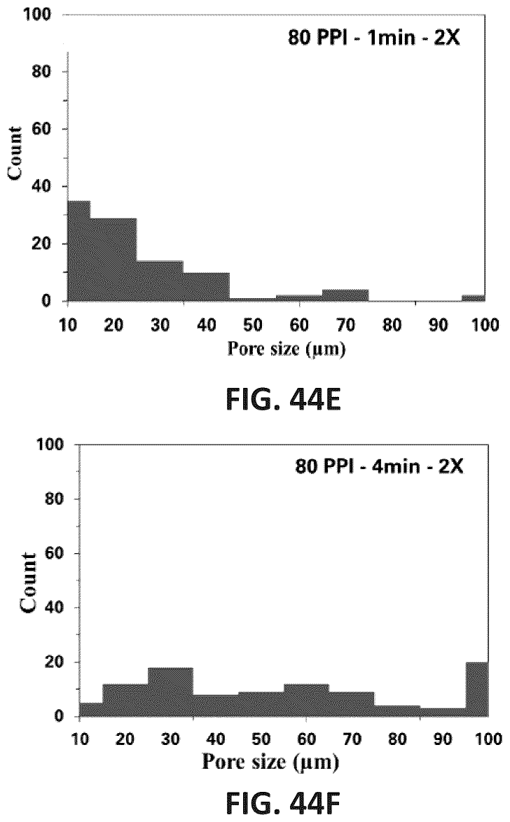

The pore size distributions of the 80 PPI foams are summarized in FIGS. 44A, 44B, 44C, 44D, 44E, and 44F. Notably, the 1 min samples showed narrower pore size distributions than the samples spun for 4 min. The exact reason for this behavior is not known, but it could have been caused by sample bias. It is also possible that the longer spinning time merely deposited more fine fiber across the pores of the foam whereas the fiber deposition across 1 min occurred more on the ligaments thus the fibers in the latter case were stretched into a taught state. By this stretching, the fibers could then span the pore window of the foam, thereby generating the larger pores.

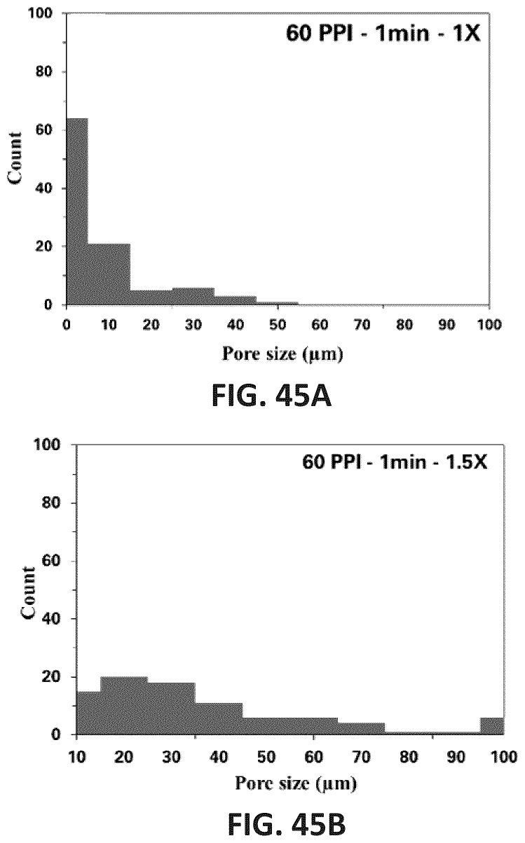

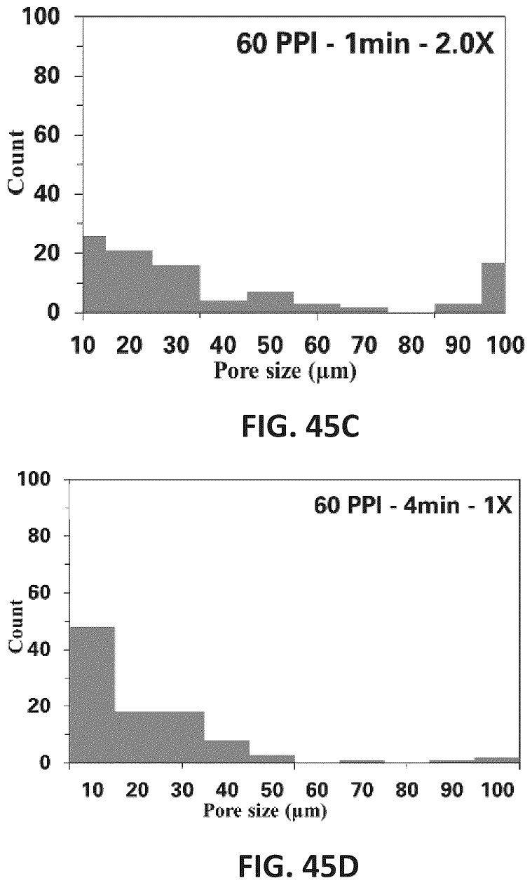

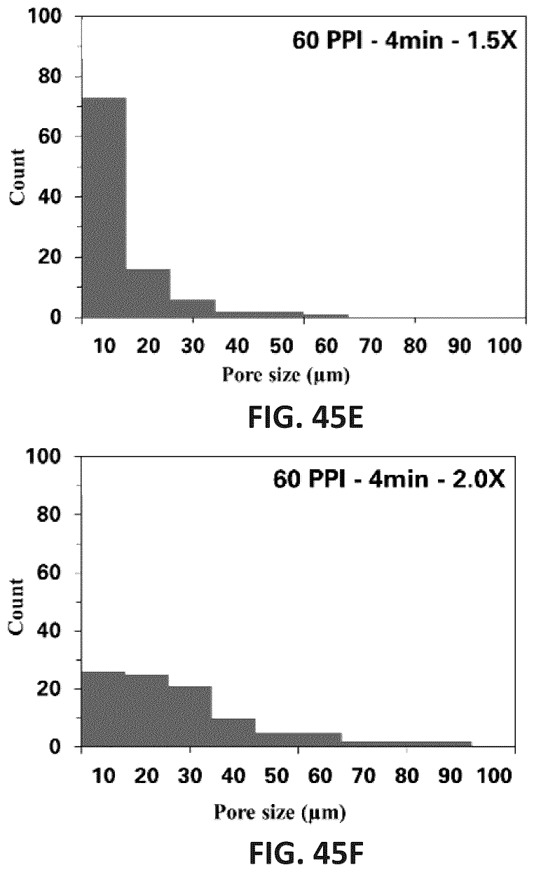

The pore size distributions of the 60 PPI foams are summarized in FIGS. 45A, 45B, 45C, 45D, 45E, and 45F. Pores were observed in a range of diameters in the nanoscale up to ˜700 μm. Regarding the effects of polymer concentration on the range of pore diameters, it should be noted that the pore distributions were relatively independent of the polymer concentration. However, the spinning time had a more significant impact. Increasing the spinning time from 1 min to 4 min led to pore narrowing. Such narrowing is likely due to more fiber having been deposited onto the surface thereby filling more of the empty space leading to a narrower range in pore diameter.

### Example 3B

Example 3B explores electrospinning of fine fibers from an electrospinning mixture that includes a polymer and active particles onto a foam.

In Example 3B, coconut carbon particles were added to the 1.5× polymer electrospinning mixture of and spun onto the surface of the 60 PPI foam for 4 minutes. This foam and set of conditions was selected based on the results from the Example 3A, which indicated that electrospinning an electrospinning mixture containing a1.5× polymer concentration onto 60 PPI foam generates a balance of permeability coupled with narrow pore sizes. Carbon particles were added to the electrospinning mixtures using 25% and 65% by weight relative to the polymer phase; however, only the 25 wt-% carbon sample was found to generate fibers. The 65 wt-% sample sprayed droplets on the surface but failed to generate a fiber layer.

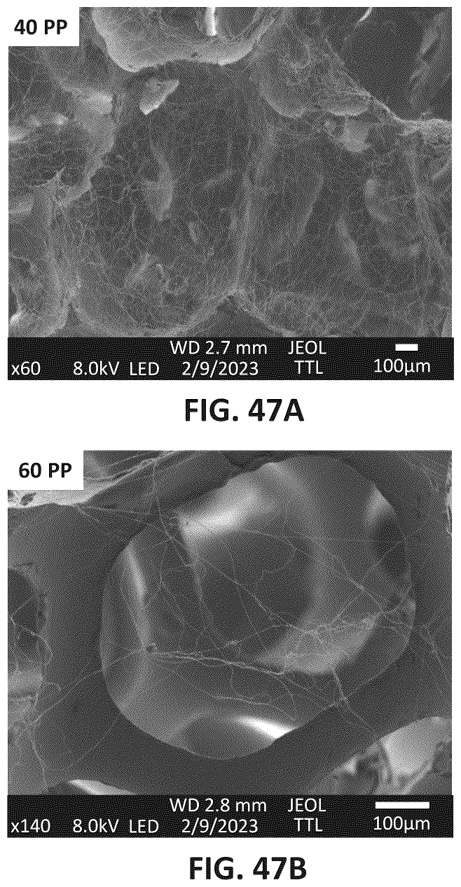

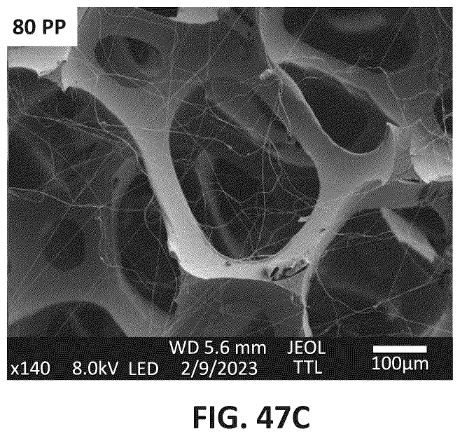

As shown in FIGS. 47A-47C, particles were clearly observed in the weblike structure of the fiber coating. From FIGS. 47A-47C, it was observed that the particles were immobilized by two mechanisms: i) By wrapping the particles into the fiber web via overlaying of the fibers (FIG. 47B) and ii) by the fibers solidifying through the macropores of the carbon particulate (FIG. 47C). These mechanisms of immobilization are anticipated to be quite strong and should prevent attrition of the particles. Specifically, the mechanical rigidity of the fiber layer and catenation of the fiber through the particle should allow the two components of the composite to move in tandem, thus preventing powder shedding. It was also noted that some of the particles were not filmed over with polymer, indicating that this approach can generate adsorptive sites which retain their accessible pore space. However, it was also observed that some of the particles were filmed over and entrapped within the fiber (FIG. 46D).

### Example 3C

Example 3C explores electrospinning of fine fibers from an electrospinning mixture that includes polyvinylpyrrolidone and either active particles or no active particles onto various foams.

In Example 3C experiment, polyvinylpyrrolidone (PVP) was electrospun onto 40 PPI, 60 PPI, and 80 PPI foams both with and without 25 wt-% carbon being present in the electrospinning mixture. The electrospinning mixture included methanol and contained 10 wt-% PVP. Electrospinning was done onto the foam surface for four minutes.

For the foams lacking the carbon, pore-spanning fiber structures were observed at all three foam densities (FIGS. 47A, 47B, and 47C). The PVP appeared to be the most heavily loaded on the 40 PPI foam (FIG. 47A) while the 60 (FIG. 47B) and 80 PPI (FIG. 47C) foams exhibited fiber layers which were more openly porous. It is possible that such effects were a byproduct of sampling bias, but the differences in the higher solidity foams were significant compared to the 40 PPI sample. The presence of the fibers on all three foam structures indicates that this technique can be used to generate highly porous foam/fiber bodies.

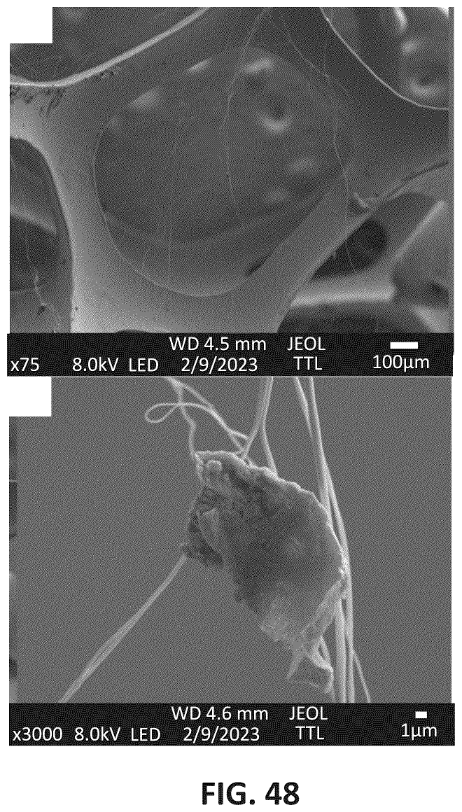

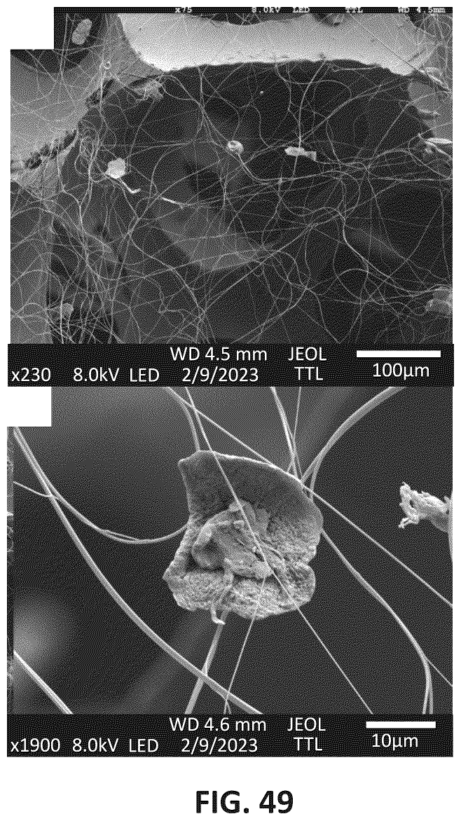

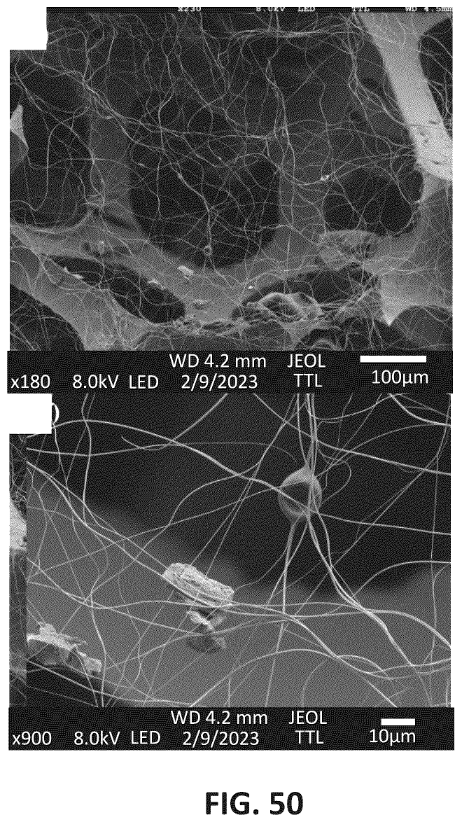

As previously noted, PVP electrospinning mixtures containing 25 wt-% carbon were also spun onto the 40 PPI, 60 PPI, and 80 PPI foams, as shown in FIGS. 48, 59, and 50. Unlike the carbon free electrospinning mixtures, it was observed that the 40 PPI (FIG. 48) foam had less fine fiber loading compared to the 60 PPI (FIGS. 49) and 80 PPI (FIG. 50) foams. This observation was in line with the first polymer electrospinning experiment of the present Example. Such alignment reasonably indicated some sample bias was present in FIGS. 47A-47C. However, while the foam may have some influence on fiber diameter, fiber layer porosity, and fiber loading, it did not seem to affect the degree of carbon filming. Instead, the degree of filming seems to be more dependent on which polymer is used, and the carbon size as most of the carbon particles observed were not covered in polymer. This retention of open particle surface differed from the samples in FIGS. 46A-46D, where filming of particles was observed at higher particle diameter. For example, FIG. 46D clearly shows a 30 μm particle covered in polymer. Given the inherent bias of imaging by SEM which is intrinsic to the technique the lack of polymer coating observed for the PVP-carbon samples may be sample bias.

### Example 3D

Example 3D explores electrospinning of fine fibers onto a foam pre-coated with an active polymer/binder polymer mixture.

In Example 3D, PVP fine fibers were electrospun onto dip-coated 40 PPI foams. The foam (weight=0.0456 g) was dip-coated using the following process.
1) The sample was submerged into 200 mL of ethanol for 30 seconds to wet its surface (wetting mixture).
2) The sample was submerged in 200 mL solution of ethanol followed by submergence into a solution containing 200 mL of 60 wt-% polytetrafluoroethylene emulsion with 14.4 g of coconut shell carbon for 30 seconds (coating mixture).
3) The sample was submerged into a solution containing 21 g potassium carbonate (K₂CO₃) in 100 mL water for 30 seconds (wetting mixture).
4) The sample was dried at 70° C. for 24 h in ambient air.

The coated foam before and after coating with PVP (spinning solution included no solid particulate) for 4 min is shown in FIG. 51A and FIG. 51B, respectively. The fine fiber layer wrapped itself around the foam ligament, effectively protecting the coating from shedding. Such protection was evident by the particles clearly visible in the fiber layer. The mechanisms of such particle capture were observed being twofold as shown in FIGS. 52A and 52B. To be specific, it was observed from FIG. 52A (a zoomed in image of the pore around the ligament shown in FIG. 51B) that particles shed from the coated foam surface were immobilized by the funnel-like structure of the fine fiber wrap. FIG. 52B indicated a sealing mechanism of the fiber layer, which trapped particles on the ligament surface, as well.

### Example 4: Polymer and Active Particle Coated Foams

A foam coating, such as a reticulated foam coating, generally includes active particles and a binding polymer. The present Example describes 25 PPI polyurethan foams dip coated with activated carbon (Calgon Carbon Corporation, Moon Township, PA) active particles and an ethanol soluble nylon (BASF SE, Ludwigshafen, Germany) binder polymer.

Foams were coated by first preparing a solution of nylon dissolved in ethanol. The desired quantity of nylon was dissolved in a fixed amount of ethanol (5 mL) using constant stirring at 60° C. for 12 h under condensation. Next, the desired amount of carbon was added to the nylon mixture and mechanically mixed until the coating solution became homogeneous. Untreated polyurethane foams of 25 PPI were then submerged into the coating mixture for 30 seconds and hung to dry in a convection oven at 120° C. for 24 h.

Two sets of samples were tested. The first set of samples (S1-S6 in Table 1) varied the weight ratio of carbon to nylon in a fixed volume of ethanol (5 mL) and a fixed mass of total solids (sum of the mass of carbon and the mass of nylon in the coating mixture) of 1 g. In the second set of samples (S7-34; Table 1), both the weight ratio of carbon to nylon in a fixed volume of ethanol (5 mL) was varied and the total solids was varied.

TABLE 1

| Sample | wt-% | wt-% | Total solids in 5 |
|---|---|---|---|
| Number | carbon | nylon | mL Ethanol (g) |
| S1 | 70 | 30 | 1 |
| S2 | 75 | 25 | 1 |
| S3 | 80 | 20 | 1 |
| S4 | 85 | 15 | 1 |
| S5 | 90 | 10 | 1 |
| S6 | 95 | 5 | 1 |
| S7 | 70 | 30 | 1.1 |
| S8 | 70 | 30 | 1.2 |
| S9 | 70 | 30 | 1.3 |
| S10 | 70 | 30 | 1.4 |
| S11 | 70 | 30 | 1.5 |
| S12 | 75 | 25 | 1.1 |
| S13 | 75 | 25 | 1.2 |
| S14 | 75 | 25 | 1.3 |
| S15 | 75 | 25 | 1.4 |
| S16 | 75 | 25 | 1.5 |
| S17 | 80 | 20 | 1.1 |
| S18 | 80 | 20 | 1.2 |
| S19 | 80 | 20 | 1.3 |
| S20 | 80 | 20 | 1.4 |
| S21 | 80 | 20 | 1.5 |
| S22 | 85 | 15 | 1.1 |
| S23 | 85 | 15 | 1.2 |
| S24 | 85 | 15 | 1.3 |
| S25 | 85 | 15 | 1.4 |
| S26 | 85 | 15 | 1.5 |
| S27 | 85 | 15 | 2 |
| S28 | 85 | 15 | 2.5 |
| S29 | 85 | 15 | 3 |
| S30 | 90 | 10 | 1.1 |
| S31 | 90 | 10 | 1.2 |
| S32 | 90 | 10 | 1.3 |
| S33 | 90 | 10 | 1.4 |
| S34 | 90 | 10 | 1.5 |

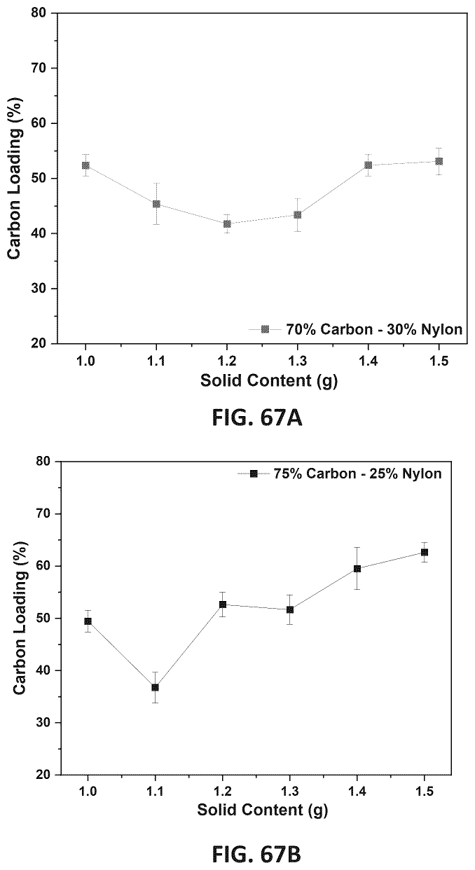

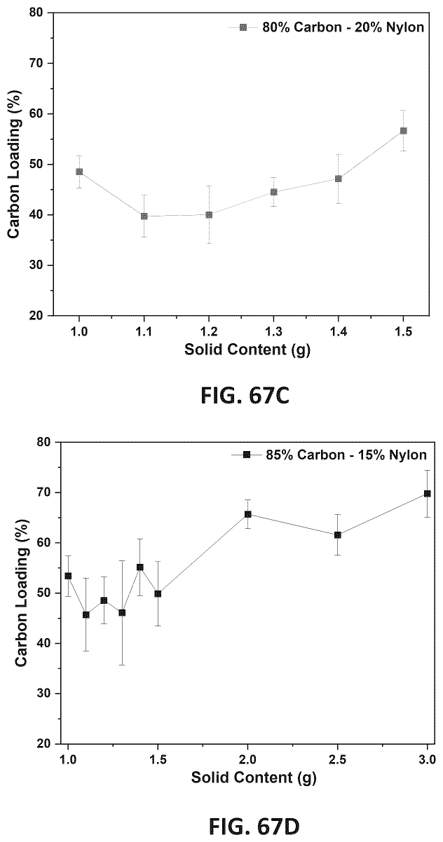

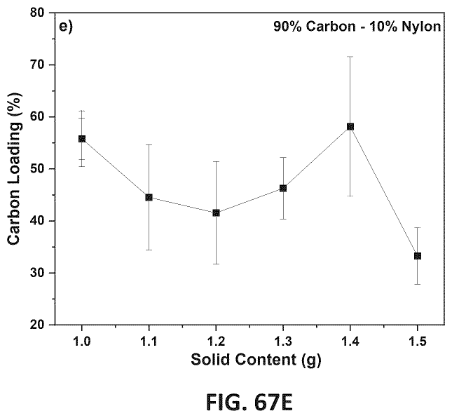

Thermalgravimetric analysis (TGA) was used to determine the quantity of carbon loaded using a Q500 TGA from TA instruments (New Castle, DE). Samples were heated at a rate of 10° C./min to 600° C. in a nitrogen atmosphere followed by a secondary ramp to 650° C. in air at 2° C./min to determine the carbon mass. In FIGS. 67A-67D, the % carbon loading is provided as the wt-% of carbon compared to the total weight of the composition (i.e., the sum of the weight of the carbon, foam, and nylon).

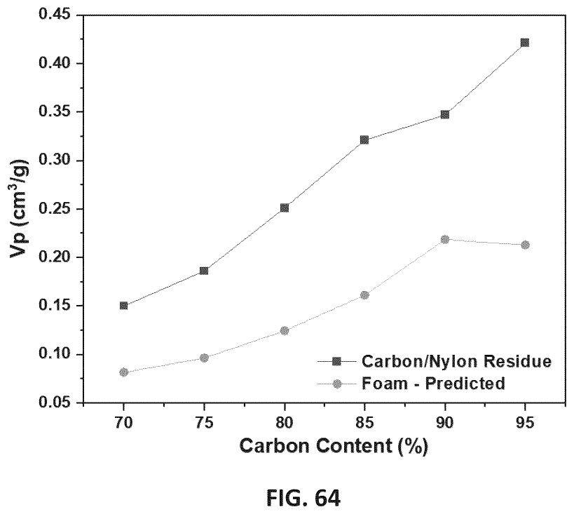

The textural properties (e.g., surface area (SBET in m²/g) and pore volumes (Vp) in (cm³/g)) of the coated foams were approximated using the solid residues leftover from the coatings. The solid residues of the various coating mixtures were collected by evaporating off the ethanol from the dip coating baths at 60°° C. for 24 h under convection, leaving behind only the carbon and nylon. The solids were scraped from the vials and degassed at 120° C. for 4 h under vacuum, whereafter their Branauer-Emmett-Teller (BET) surface areas and micropore volumes were assessed using N₂ physisorption at 77K. The as-measured textural properties were assumed to be the textural properties of the coatings applied to the foams without the foam component. The textural properties were then multiplied by the average carbon masses collected from TGA to predict the textural properties of the carbon/Nylon coated foams (i.e., the foam-predicted samples on FIG. 63 and FIG. 64). Textural properties were approximated in this manner to reduce sampling bias stimming from variance in each piece of coated foam.

The coating mechanical strengths were assessed by air pulse experiments at 1.5 PSI (10.34 kPa) pulse pressure over 1000 cycles. The coated foam weights were collected before and after pulse testing to determine the degree of carbon retention.

The carbon loading as a function of carbon/nylon weight ratio was systematically assessed through triplicate runs on TGA, from which the Branauer-Emmett-Teller (BET) surface area and pore volume were approximated based on the solids residue from the pure carbon/nylon mixtures. The nitrone (N₂) physisorption isotherms and Barret-Joyner-Halenda (BJH) pore distributions, textural properties of carbon residue, and TGA triplicate profiles were obtained.

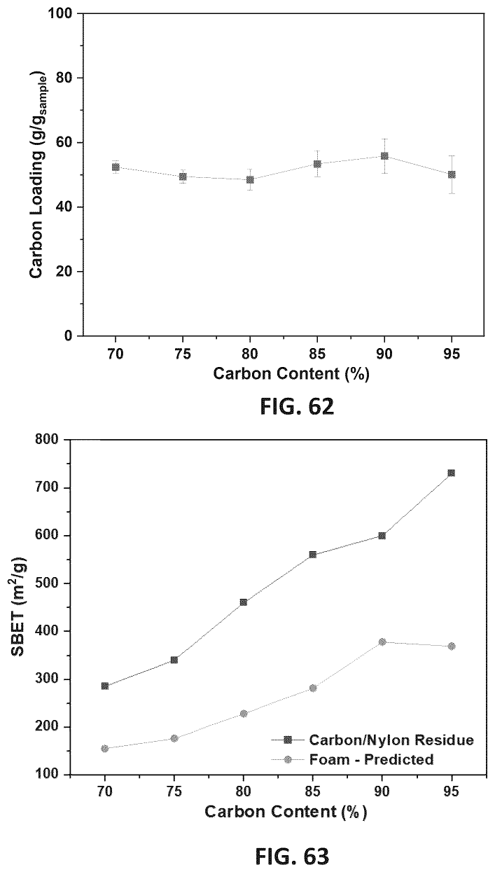

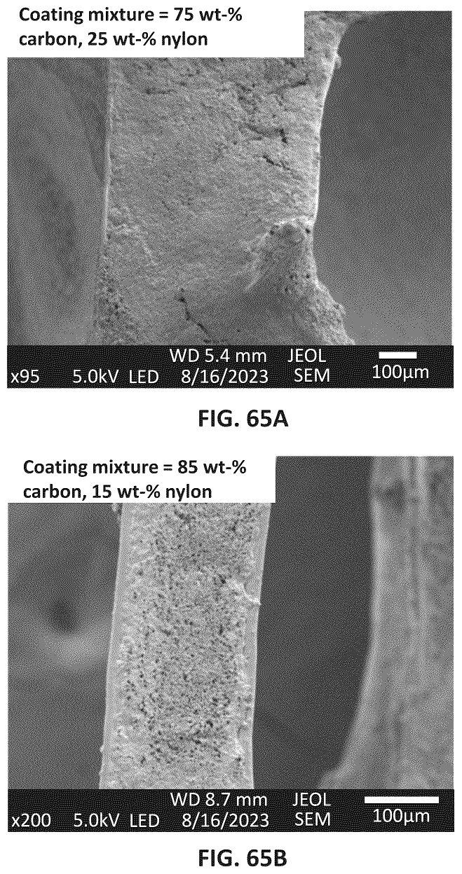

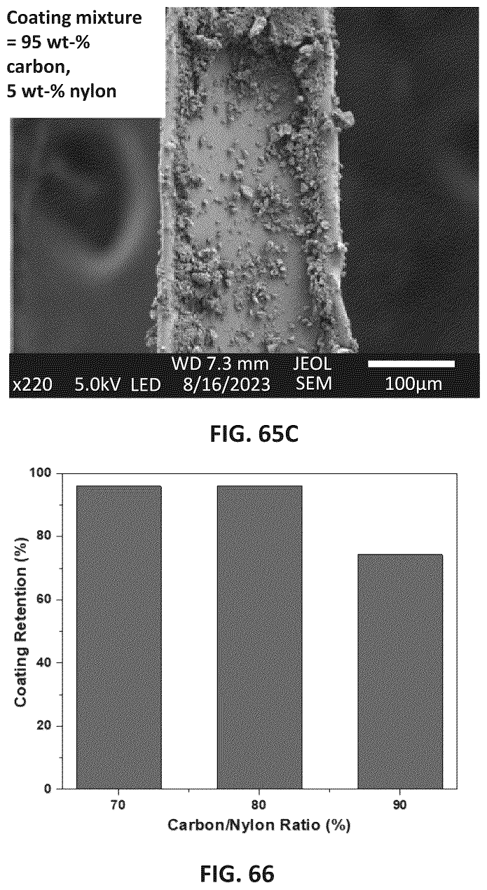

The approximate BET surface areas, pore volumes, and carbon loadings as a function of carbon/nylon weight ratio are displayed in FIGS. 62 and 63. For coating from mixtures having less than 95 wt-% carbon, the amount of carbon deposited onto the foam increased slightly with elevated carbon concentration (FIG. 62). However, the variability of the loading increased in a similar fashion (see error bars in FIG. 62), indicating that the effect of the carbon/nylon ratio was fairly minimal with regards to the amount of carbon deposited. The variability of the loading at elevated carbon concentration likely resulted from less binding strength due to the reduced polymer concentration, thereby rendering the coating less even throughout the surface. For example, the scanning electron micrographs in FIGS. 65A-65B showed that the coating made from a mixture having 85 wt-% carbon had signs of cracking (S4; FIG. 65B) and the coating made from a mixture having 95 wt-% carbon had signs of failure (S6; FIG. 65C). No such cracking or failure was observed with the coating made from a mixture having 75 wt-% carbon (S2; FIG. 65A).

A correlation between the predicted surface area/pore volume and the carbon/nylon ratio was observed. The predicted surface area/pore volume for the coated foams were calculated by plotting the products of the average carbon loadings and surface area (FIG. 63) or pore volume (FIG. 64) revealed a linear growth in textural properties as the nylon concentration was decreased. It was noted that this relationship only applied below 95% carbon, at which point the poor mechanical strength of the loading failed to adhere a sufficient amount of carbon to generate high surface area. This data indicated that a carbon/nylon weight ratio in the coating mixture that has 90 wt-% carbon or less, may be beneficial.

Pulse test experiments were performed on the coatings formed from coating mixtures having 70 wt-%, 80 wt-%, and 90 wt-% carbon (S1, S3, S5 in Table 1) to determine how the mechanical stability of the coating is influenced by the nylon content. As shown in FIG. 66, the coatings were retained above 90% when the coating mixture used to coat the foam had 80 wt-% carbon or lower (20 wt-% nylon or higher). The mechanical stability of the coating decreased upon further reducing the nylon content of the coating mixture to 10 wt-% (i.e., 90 wt-% carbon). This result indicates that coating with a coating mixture having 80 wt-% to 90 wt-% carbon and 20 wt-% to 10 wt-% nylon may be beneficial, especially given the effect on surface area and pore volume shown in FIGS. 63, and 64. Given the initial experiments, a coating mixture that includes 85 wt-% carbon and 15 wt-% nylon may be beneficial for creating a coating having desirable properties.

Samples S7-S34 were prepared and analyzed. It was hypothesized that increasing the total solids may allow for a greater total amount of nylon which may give rise to enhancements in surface coverage at the elevated carbon/nylon ratios. The foam weight used in these experiments was held constant at 5 mg. The foams were coated by first dissolving the nylon and dispersing the carbon in 5 mL of ethanol by sonication at a temperature of 65° C. for 1 h. The foam was placed in the coating mixture and agitated by rolling on a rolling table at ambient temperature for 24 h. The coated foam samples were then dried at 100° C. for 24 h under convection, whereupon TGA was performed to assess the carbon loadings.

Carbon loading as a function of total solids in the coating mixture is shown in FIGS. 67A-67E. The variability in the coatings did not seem to be a function of the solid content, but rather, still remained a function of the carbon: nylon weight ratio (see error bars in FIGS. 67A-67E). In particular, the coatings became far more variable when made form a coating mixture having 90 wt-% carbon and 10 wt-% Nylon (FIG. 67E). Such results indicated that a coating made from a coating mixture that includes at least 15 wt-% nylon may have desirable mechanical stability and/or reproducibility. The most reproducible coatings were present in the samples coated using a coating mixture having 70 wt-% and 75 wt-% carbon (30 wt-% nylon and 25 wt-% nylon, respectively), but some manner of variance may be accepted due to the possible benefit of enhanced surface area retention above 80% carbon loading (the samples made from a coating mixture having 70 wt-% and 75 wt-% had carbon loadings less than 80%).

Regarding the impact of total solids content on carbon loading, a weak correlation between the total solids content and amount of carbon deposited on the sample was observed (FIGS. 67A-67E). This correlation was especially pronounced when the total solids content was increased beyond 1.2 g, which gave rise to nearly linear increases in carbon loading as the total solids content was further elevated. For all samples except those made from a coating mixture that included 90 wt-% carbon, the highest carbon loading during the initial phase of testing was observed at 1.5 g solids per 5 mL of ethanol (FIGS. 67A-67D). With the desire to further drive up the solid content on the foam, the coating mixture that included 85 wt-% carbon mixture was further tested to include 2.0, 2.5, and 3.0 g total solids in 5 mL of ethanol (S27-S29 in Table 1). When the 3.0 g total solid coating mixture was tested (S29) it was observed that the coating mixture viscosity was a glue-like consistency. Additionally, the foam samples coating with a mixture having 2.5 g and 3.0 g total solids (S28 and S29) had considerably more filming over their surface (i.e., blocked pores) as compared to coatings formed from mixtures having 2.0 g total solids or less.

All references and publications cited herein are expressly incorporated by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A volumetric media having an upstream end and a downstream end, the volumetric media comprising:
a spacer; and
a packing material around the spacer, the packing material comprising a reticulated foam.

2. The volumetric media of claim 1, wherein the reticulated foam comprises: polyester, reticulated polyether, reticulated polyurethane, reticulated polyurethane without heat treatment, reticulated cellulose, reticulated melamine, reticulated activated carbon, reticulated vitreous carbon, reticulated graphene, reticulated silicon oxide, reticulated silicon carbide, a reduced metal reticulated foam, or any combination thereof.

3. The volumetric media of claim 1, wherein the foam comprises an adsorbent.

4. The volumetric media of claim 1, wherein the packing material further comprises active particles, the active particles comprising an adsorbent, a catalyst, or both.

5. The volumetric media of claim 4, wherein at least a portion of the reticulated foam is coated with the active particles.

6. The volumetric media of claim 1, wherein each spacer of the plurality of spacers defines a longitudinal axis and comprising:
a main body having a main body cross-sectional dimension;
a leading pin extending from the main body and upstream of the main body, the leading pin having a leading pin cross-sectional dimension; and
a trailing pin extending from the main body and downstream of the main body, the trailing pin having a trailing pin cross-sectional dimension,
the main body cross-sectional dimension being greater than the leading pin cross-sectional dimension and the trailing pin cross-sectional dimension.

7. The volumetric media of claim 6, wherein the plurality of spacers are arranged in at least one transverse plane, and wherein the at least one transverse plane is transverse relative to the longitudinal axes of the spacers in the transverse plane.

8. The volumetric media of claim 6, wherein the plurality of spacers are arranged in at least one longitudinal plane, and wherein the at least one longitudinal plane is parallel to the longitudinal axes of the spacers in the longitudinal plane.

9. The volumetric media of claim 6, wherein each of the plurality of spacers is operably coupled to at least one other of the plurality of spacers.

10. The volumetric media of claim 6, wherein the main body is substantially lentil-shaped.

11. A volumetric media having an upstream end and a downstream end, the volumetric media comprising:
a spacer; and
a packing material around the spacer, the packing material comprising:
a foam; and
fine fibers disposed on at least a portion of the foam.

12. The volumetric media of claim 11, wherein the fine fibers have an average diameter of 1 μm or less.

13. The volumetric media of claim 11, wherein the fine fibers comprises a homopolymer, copolymer, or a blend of two or more polymers of aromatic polyamide, aliphatic polyamide, polypropylene, polyurethane, poly (ethylene terephthalate), polyvinyl pyrrolidone, styrene butadiene rubber, polysulfone, polyethersulfone, polymethylmethacrylate, polyacrylonitrile, polybenzimidazole, polytetrafluoroethylene, polyester, polyethylene oxide, polyacrylonitrile, polyvinylidene chloride, polyvinylidene fluoride, polystyrene, polyvinyl alcohol, or any combination thereof.

14. The volumetric media of claim 11, wherein the foam comprises an adsorbent.

15. The volumetric media of claim 11, wherein the packing material further comprises active particles, the active particles comprising an adsorbent, a catalyst, or both.

16. The volumetric media of claim 11, wherein the packing material further comprises a binder polymer.

17. The volumetric media of claim 11, wherein each spacer of the plurality of spacers definiens a longitudinal axis and comprising:
a main body having a main body cross-sectional dimension;
a leading pin extending from the main body and upstream of the main body, the leading pin having a leading pin cross-sectional dimension; and
a trailing pin extending from the main body and downstream of the main body, the trailing pin having a trailing pin cross-sectional dimension,
the main body cross-sectional dimension being greater than the leading pin cross-sectional dimension and the trailing pin cross-sectional dimension.

18. The volumetric media of claim 17, wherein the plurality of spacers are arranged in at least one transverse plane, and wherein the at least one transverse plane is transverse relative to the longitudinal axes of the spacers in the transverse plane.

19. The volumetric media of claim 17, wherein the plurality of spacers are arranged in at least one longitudinal plane, and wherein the at least one longitudinal plane is parallel to the longitudinal axes of the spacers in the longitudinal plane.

20. The volumetric media of claim 17, wherein the main body is substantially lentil-shaped.
